(19) United States
(12) Patent Application Publication
(10) Pub. No.: US 2026/0209132 A1
(43) Pub. Date: Jul. 23, 2026

(54) CROP NUTRITION AND FORTIFICATION COMPOSITION

(71) Applicant: Komal BHUKHANWALA, Mumbai (IN)

(72) Inventor: Komal BHUKHANWALA, Mumbai (IN)

(21) Appl. No.: 19/141,122

(22) PCT Filed: Dec. 28, 2023
(86) PCT No.: PCT/IN2023/051240

§ 371 Date: Jun. 19, 2025

(30) Foreign Application Priority Data
Dec. 28, 2022 (IN) 202221076406

(51) Int. Cl. C05D 1/00; C05D 3/00; C05D 5/00

(52) U.S. Cl. CPC C05D 1/00; C05D 3/00; C05D 5/00

(57) ABSTRACT

The invention relates to a crop nutrition and fortification composition comprising effective amounts of elemental sulphur; one or more of magnesium salts derivatives or mixtures thereof; one or more of potassium fertilizers or their salts or derivatives or mixtures thereof; one or more of iron salts or derivatives or mixtures thereof; one or more of zinc salts or derivatives or mixtures thereof; and one or more excipients, wherein the composition comprises of particles in the size range of 0.1-50 microns and wherein elemental sulphur content is in the range of 5% to 90% by weight; elemental magnesium content is in the range of 0.1% to 40% by weight; elemental potassium content is in the range of 0.1% to 40% by weight; elemental iron content is in the range of 0.1% to 45% by weight; and elemental zinc content is in the range of 0.1% to 45% by the weight of the total composition.

The invention also relates to a process of preparing the crop nutrition and fortification composition and to a method of treating plants, seeds, crops, plant propagation material, locus, parts thereof or soil with the crop nutrition and fortification composition.

### FIELD OF THE INVENTION

The invention relates to a crop nutrition and fortification composition comprising effective amounts of elemental sulphur; one or more of magnesium salts or derivatives or mixtures thereof; one or more of potassium fertilizers or salts or derivatives or mixtures thereof; one or more of iron salts or derivatives or mixtures thereof; one or more of zinc salts or derivatives or mixtures thereof; and one or more excipients in the range of 0.1% to 60% by the weight of the total composition, wherein the elemental sulphur content in the composition is in the range of 5% to 90% by the weight of the total composition; elemental magnesium content is in the range of 0.1% to 40% by the weight of the total composition; elemental potassium content is in the range 0.1% to 40% by the weight of the total composition, elemental iron content is in the range of 0.1% to 45% by the weight of the total composition; and elemental zinc content is in the range of 0.1% to 45% by the weight of the total composition. Particularly, the crop nutrition and fortification composition comprises of particles in the size range of 0.1-50 microns and the total content of the water soluble salts or derivatives or mixtures in the composition does not exceed 80% by the weight of the total composition.

More particularly, the crop nutrition and fortification composition is in the form of water disintegrable granules, water dispersible granules or liquid suspension.

The invention also relates to a process of preparing the crop nutrition and fortification composition and to a method of treating the plants, seeds, crops, plant propagation material, locus, parts thereof or soil with the crop nutrition and fortification composition, wherein the composition is in the form of water disintegrable granules, water dispersible granules or liquid suspension.

The present invention furthermore relates to a method of treating plants and meeting their nutritional requirement with the crop nutrition and fortification composition by making essential nutrients like sulphur, potassium, magnesium, and micronutrients like iron and zinc available to the plants and also unlocking other micronutrients and trace elements present in the soil which are otherwise, not available because of various factors, primarily being soil degradation or antagonism between the nutrients or on account of excessive use of NPK or ammonium sulphate fertilizers. Further, the composition of the invention reduces the need for the excess application of conventional NPK fertilizers and avoids the drawbacks such as nitrate leaching and nitrous oxide emission that are associated with the excessive use of NPK fertilizers.

### BACKGROUND OF THE INVENTION

In describing the embodiments of the invention, specific terminology is chosen for the sake of clarity. However, it is not intended that the invention be limited to the specific terms so selected and it is to be understood that each specific term includes all technical equivalents that operate in a similar manner to accomplish a similar purpose.

Nutrition is the key element in the growth and development of crops. Poor and inadequate availability of nutrients to the plants results in lack of proper growth and plant physiological development, rendering the plants more susceptible to attack by pests and diseases.

Macronutrients play an important role in plant growth and development. Micronutrients are also agriculturally important, helping plants alleviate environmental stress, improve the nutrition quality of foods, facilitating increased crop yield and improving the quality of crops. It is observed that deficiency in the availability of macronutrients, secondary nutrients and micronutrients all lead to decline in the overall crop growth and health. Furthermore, poor availability of nutrients to the plants also results in a lack of proper growth, resulting in the plants becoming more susceptible to attack by pests.

Potassium (K) is an essential nutrient that affects several biochemical and physiological processes that influence plant growth and metabolism. Potassium plays essential roles in enzyme activation, protein synthesis, photosynthesis, osmoregulation, stomatal movement, energy transfer, phloem transport, cation-anion balance and stress resistance. Potassium deficiency in crops and plants leads to chlorosis; wilting and scorching of older leaves; distorted and small sized leaves; reduced flowering and branching; reduction in carbohydrate, protein and chlorophyll formation as well as exhibit poor quality of fruits and seeds.

Magnesium (Mg) is an essential macronutrient for plant growth and development and plays a significant role in plant photosynthesis, cell division, protein formation and is an essential component for plant respiration. Due to its mobility within the plant, magnesium deficiency symptoms appear first on the lower and older leaves, before the symptoms become visible on the younger leaves. The symptoms show up as yellow leaves with green veins and around the edges (i.e. interveinal chlorosis). Purple, red, or brown spots may also appear on the leaves. Further due to its mobility, Magnesium is lost from the soil. Magnesium levels in the soil are also poor due to its tendency to leach away from the soil and due to intensive crop production. Further, high levels of potassium in soil blocks magnesium, thus making it unavailable to the plants. Absolute magnesium deficiency in the soil dramatically reduces magnesium absorption by crop roots.

The role of sulphur as an essential and a growing nutrient and fertilizer has been long known. Sulphur deficiency has become widespread over the past several decades in most of the agricultural areas of the world, resulting in sulphur being indicated as a limiting factor to high yields and fertilizer efficiency. Sulfur is often applied in the form of elemental sulphur, or as a component of some fertilizers such as superphosphate, ammonium sulfate and potassium sulfate. Some of the other reasons for the deficiency of sulphur is unavailability of sulphur in assimilable form to the plants, loss of sulphur caused by leaching and soil pH, and insolubility of elemental sulphur in water.

Micronutrients are equally important for plant growth as macronutrients. Zinc, a known micronutrient is an important constituent of several enzymes and proteins; is responsible for formation of chlorophyll and some carbohydrates, conversion of starches to sugars and its presence in plant tissue helps the plant to withstand cold temperatures. Zinc is immobile, due to which the deficiency symptoms occur in the new leaves, expressed as some varying pattern of chlorosis of the new leaves (often interveinal) and necrotic spots may form on the margins or leaf tips resulting in formation of leaves which are smaller in size and often cupped upward or distorted. Carbohydrate, protein, and chlorophyll formation is significantly reduced in zinc-deficient plants.

Iron plays a key role in energy transfer, nitrogen reduction, nitrogen fixation, manufacturing process of chlorophyll and a range of enzymes and proteins. Iron is relatively immobile once incorporated into the tissues in the upper parts of the plants, and as a result, the translocation of iron from one plant part to another is restricted, which leads to iron deficiency. Iron deficiency is commonly responsible for chlorosis (yellowing) and poor nodulation of legume crops, leading to reduced size and yield.

It is also known that optimum levels of nutrients are required for the normal functioning, and growth of the plants, and any variance in levels may cause hindrance in the overall crop growth and cause its health to decline due to either a deficiency or toxicity, in turn affecting the nutrients essential for human diet.

Presently available conventional fertilizers or nutrient compositions exist in forms, which either do not solubilize or do not disperse adequately and hence not available for ready uptake by the plant roots, resulting in their deficiency. Macronutrients such as magnesium, when applied to the soil in higher dosages significantly elevates the salinity of the soil and tend to leach from the soil. Thus application of macronutrients in forms and quantities that provide for their timely uptake and availability is desired.

Thus, application of macronutrients and micronutrients in forms and quantities that provide for their timely uptake and availability is desired.

Further, modern agriculture is challenged by degraded soils on account of excessive use of fertilizers, excessive cultivation, which in turn produce crops and harvest that are devoid of nutrients finally affecting human nutrition and health. It is observed that more than double the amount of Nitrogen, Phosphorous and Potassium fertilizers are being applied nowadays to the soil, than they were applied 20 or 30 years ago, to achieve similar yields. It is observed that excessive application of nitrogen fertilizers has increased the risk of nitrous oxide emission.

In agriculture, nitrous oxide is emitted into the atmosphere when micro-organisms act on nitrogen introduced to the soil via animal urine and dung, synthetic fertilisers and legumes. Both the production and use of nitrogen fertilizers lead to the release of CO₂, N₂O and CH₄ which are among the most important global green house gases, which not only lead to climate change by trapping the heat but also contribute to respiratory diseases due to smog and air pollution. Such green house gases contribute to extreme weather changes and by trapping sun's heat cause global warming and climate changes evident in present times. It is observed that excessive application of nitrogen fertilizers has increased the quantum of nitrous oxide emission. Nitrous oxide poses the greatest risk to climate change; one pound of Nitrous oxide has 300 times the global warming potential vs one pound of Carbon dioxide and therefore exerts greater pressure on temperature change. Thus, reducing nitrogen based fertilizer and as a result reducing nitrous oxide emissions is a real need of the hour.

Further, large losses of ammonia decrease the nitrogen use efficiency and increase the need for additional nitrogen fertilizers which raises the risk of nitrate leaching. High levels of nitrate leaching is toxic and can contaminate drinking water sources with nitrate, a water-soluble chemical compound of nitrogen and too much nitrate consumption can pose a health risk to humans. It is observed that drinking water concentrations of nitrate above 10 mg/L can cause immediate health problems to humans. At very high concentrations nitrates may react with amides and amines and form cancer causing compounds in humans such as nitrosamines and nitrosamides.

Furthermore, excess nitrate being not taken up by the plants, can leach away from the plant root zone, leaving behind hydrogen ions thereby increasing soil acidity and in turn resulting in poor nutrient uptake by the plants from the acidic soil.

Moreover, on account of high application of NPK fertilizers, potassium gets accumulated in the soil which leads to an antagonistic effect on the uptake of other nutrients such as magnesium and calcium i.e. it inhibits the uptake of magnesium or calcium by plants, leading to deficiency of these nutrients in plants.

Furthermore, with an increased rate of application of ammonium sulphate, the plants have become increasingly deficient in magnesium. The detrimental direct effect of ammonium sulphate on the magnesium supply to the plants was assumed to be due to a competitive effect of NH₄ and H-ions on Mg-uptake. These ions are formed in great excess in the root tissues soon after the absorption of the NH4-ions. (Nitrogen-Magnesium Relationships in Crop Plants by E. G. Mulder *, Agricultural Experiment Station and Institute for Soil Research T.N.O., Groningen, The Netherlands).

Therefore, proper crop nutrition is critical for optimizing the crop development and metabolism, which in turn contributes to improving the crop yield and the quality of the produce.

It is further observed that managing the nutrition of crops is difficult due to factors such as carbonate levels in the soil, soil salinity, soil moisture, soil alkalinity and low temperature.

A major challenge also lies in addressing the nutrient antagonism when multiple macronutrients and secondary or micronutrients are involved. It is sometimes noted that the interaction among plant nutrients can show antagonistic or synergistic outcomes that influence nutrient use efficiency. It is observed at times that plants suffer from “nutrient antagonism” when an excess application of a particular element blocks the absorption of another element needed by the plant, which can result into deficiencies in the plant. Imbalanced soils suffer from nutrient antagonism and require a different solution than normal practice to become productive. Nutrients compete with one another in a fertilizer composition when applied to the soil or even as a foliar application. Thus, nutrient antagonism in the soil and the inputs or fertilizers, are both significant challenges and both these challenges need to be addressed when trying to deliver balanced nutrition to crops. Some of the most common antagonisms are iron blocking zinc or manganese (or the reverse), magnesium blocking calcium (or the reverse) and potassium blocking both magnesium and calcium.

It is also known that one sided oversupply of potassium inhibits the uptake of magnesium, resulting in K—Mg antagonism. Antagonistic interactions/competitive nature of potassium and magnesium has been reported (K. L. Kabu et. al, Influence of potassium-magnesium antagonism on tomato Plant growth, Can. J. Plant Sci. 50:711-715 (November 1970)). The soils with high-Potassium fertilization can decrease the availability of Magnesium to the plant, and may result in Magnesium deficiency of crops grown on soils that are already low in Magnesium. Conversely, crops grown on soils high in Magnesium can suffer from Potassium deficiency, especially if the soils are high in phosphorus and low in potassium.

Thus, knowing the antagonism between magnesium and potassium, or between zinc and iron, it has always been challenging to develop an agricultural composition that would not only overcome this issue in terms of increasing the uptake of these nutrients, but simultaneously also maintain the pH of the soil and successfully meet the nutritional requirements of both potassium and magnesium in plants as well as other micronutrients such as zinc and iron, which ultimately affects human nutrition.

Another reason for a plant being deficient for certain nutrients is “binding” which occurs when elements mix together and bond, forming a compound that is insoluble and cannot be absorbed by plant's roots. Thus, it is imperative to apply balanced amounts of the most limiting nutrients to obtain the highest yield while minimizing the nutrient losses.

Thus, providing adequate and balanced nutrition in a manner such that there is maximum uptake of nutrients by the plant, along with protection to the crops, remains a great challenge.

Therefore, proper crop nutrition is critical for optimizing the crop development and metabolism, which in turn contributes to improving the crop yield and the quality of the produce. Adequate crop nutrition is also essential while reducing the application of NPK or ammonium fertilizers so as to avoid the drawbacks associated with nitrous oxide emission and nitrate leaching from the soil.

Furthermore, problems associated with agriculture include environmental conditions such as drought, biotic and abiotic stress, poor soil conditions or depletion of nutrients in the soil, which leads to reduction in the yield and quality of the produce.

Suitable compositions comprising macronutrients such as potassium, sulphur, magnesium in combination with other micronutrients such as iron and zinc, whereby the compositions facilitate a maximum uptake of nutrients by the plant, while addressing the issue of nutrient antagonism, are not known.

It is a further object of the invention to develop a crop nutrition and fortification composition which eliminates the excessive usage of synthetic NPK fertilizers or ammonium sulphate based fertilizers which not only prevents soil degradation but also reduces nitrous oxide emission and avoids nitrate leaching, improves soil health and pH but also increases the yield and quality of the produce at reduced application rates of the composition.

Presently available conventional fertilizers or nutrient compositions exist in forms, which either do not solubilize or do not disperse adequately and hence not available for ready uptake by the plant roots, resulting in their deficiency. Furthermore, water soluble fertilizers applied at higher concentrations exhibit a tendency to leach from the soil on its application reducing its availability to the crops or the plants.

Conventionally, micronutrient-based compositions are also known in the art in the form of bentonite granules or pastilles, pellets/prills, granules prepared through molten process etc. Such granule or pellet or pastille based compositions comprise swelling clays and have been associated with several drawbacks. These compositions are generally bigger in size whereby the clay swells on coming in contact with moisture and disintegrates into large particles of uneven size. Such granules or pastilles also exhibit an irregular and slow release of the micronutrients, resulting in their reduced availability, not meeting the plant's nutritional requirement and eventually resulting in poor field efficacy.

Furthermore, the patent application No. US20170283334A1 discloses a micronutrient composition comprising a combination of water insoluble and soluble micronutrients contained within a hydrated polyelectrolyte solution. The polyelectrolytes of such composition physically crosslinks to create a thick, gel-like matrix in which the solid micronutrients are dispersed. Such compositions intend to deliver both immediate and sustained release of nutrients with the aid of a polyelectrolyte and a metal complexing agent. However, these highly concentrated formulations are difficult to dilute in water and do not form a stable dispersion and tend to form a hard pack, thus rendering them unsuitable for use. Such viscous formulations being unpourable tend to clog the nozzles and pose a problem in the delivery of nutrients to the plant or the crop.

The present inventors have surprisingly found that the crop nutrition and fortification composition comprising effective amounts of elemental sulphur; one or more of water insoluble or water soluble magnesium salts or their derivatives or mixtures thereof; one or more of water insoluble or water soluble potassium fertilizers or salts or their derivatives or mixtures thereof; one or more of water insoluble or water soluble iron salts or their derivatives or mixtures thereof; one or more of water insoluble or water soluble zinc salts or their derivatives or mixtures thereof; along with one or more excipients, wherein the composition comprises particles in the size range of 0.1 micron to 50 microns, and wherein the total content of the water soluble salts or derivatives or mixtures in the composition does not exceed 80% by the weight of the total composition and wherein the elemental sulphur content in the composition is in the range of 5% to 90% by the weight of the total composition; elemental potassium content is in the range 0.1% to 40% by the weight of the total composition, elemental magnesium content is in the range of 0.1% to 40% by the weight of the total composition; elemental iron content in the range of 0.1% to 45% by the weight of the total composition; and elemental zinc content in the range of 0.1% to 45% by the weight of the total composition, demonstrates excellent field efficacy.

It was noted by the inventors that the crop nutrition and fortification composition comprising a combination of various nutrients in specific proportions, when formulated as per the embodiments of the invention and include particles with a specific particle size distribution, also surprisingly addresses the challenges of nutrient antagonism in the soil for instance, between zinc and iron or between magnesium and potassium. Further, the application of the present composition, surprisingly allows for greater assimilation of all nutrients and reduces the need for the excess application of conventional NPK fertilizers and avoids drawbacks such as nitrate leaching associated with the excess use of NPK fertilizers. This results in a more balanced uptake of all nutrients, leading to healthier plants or crops, and increases the overall crop yield as well as the quality of the produce. It was particularly observed that the crop nutrition and fortification composition of the invention not only eliminates the excessive use of NPK fertilizers being applied at higher dosages, but also meets the needs of the crops by providing a multi-nutritive solution with improved uptake of macronutrients such as potassium, magnesium, and sulphur along with other micronutrients trapped into the soil, by the crops, at reduced application rates, while also improving the soil health.

Moreover, the inventors of the present application have determined that the crop nutrition and fortification composition in the form of water dispersible granules, liquid suspension or water disintegrable granules, helps to improve the plant yield, improves soil health, maintains the soil pH and balances uptake of all nutrients by the crops or the plants, reduces yellowing of leaves and exhibits improved plant physiological parameters such as increased rooting, improved foliage, disease resistance, increased greenness of the crops, providing a nutritionally rich and fortified crop.

The composition of the present invention in the form of water dispersible granules or liquid suspension also exhibits superior physical characteristics such as suspensibility, dispersibility, flowability and wettability, whereby the composition demonstrates excellent field efficacy even when applied at reduced dosage of application, as compared to individual applications of said nutrients or commercially available products.

### SUMMARY OF THE INVENTION

The present invention relates to a crop nutrition and fortification composition comprising effective amounts of elemental sulphur; one or more of water insoluble or water soluble magnesium salts or derivatives or mixtures thereof; one or more of water insoluble or water soluble potassium fertilizers or salts or derivatives or mixtures thereof; one or more of water insoluble or water soluble iron salts or derivatives or mixtures thereof; one or more of water insoluble or water soluble zinc salts or derivatives or mixtures thereof; and one or more excipients. Particularly, the crop nutrition and fortification composition comprises particles in the size range of 0.1 to 50 microns, and wherein the total content of the water soluble salts or derivatives or mixtures in the composition does not exceed 80% by the weight of the total composition.

Thus, application of macronutrients and micronutrients in forms and quantities that provide for their timely uptake and availability is desired. More particularly, the crop nutrition and fortification composition comprises elemental sulphur in the range of 5% to 90% by the weight of the total composition; elemental magnesium content in the range of 0.1% to 40% by the weight of the total composition; elemental potassium content in the range 0.1% to 40% by the weight of the total composition, elemental iron content in the range of 0.1% to 45% by the weight of the total composition; and elemental zinc content in the range of 0.1% to 45% by the weight of the total composition.

According to an embodiment, the composition is in a solid or a liquid or a gel or a paste form. According to an embodiment, the composition is in the form of water dispersible granules, liquid suspension or water disintegrable granules.

According to an embodiment, the invention relates to a process of preparing the crop nutrition and fortification composition in the form of water dispersible granules or water disintegrable granules or liquid suspension.

According to a still further embodiment, the invention relates to a method of treating plants, seeds, crops, plant propagation material, locus, parts thereof or soil with the crop nutrition and fortification composition.

It was observed that the crop nutrition and fortification composition of the invention facilitates a balanced uptake of all nutrients by the crops or the plants overcoming the drawbacks of nutrient antagonism exhibited by conventional multi-nutrient compositions. It was further surprising to observe that the use of this composition results in healthier plant and higher nutrient harvest in all types of soils and improved soil health. The present composition acts as a nutrient efficient composition while meeting the need of crops by providing a multi-nutritive solution with improved uptake by crops.

Further, the composition of the invention reduces the need for the excess application of conventional NPK fertilizers and avoids the drawbacks such as nitrate leaching and nitrous oxide emission that are associated with the excessive use of NPK fertilizers.

### 1. DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described hereinbelow, the phrase comprising may be replaced by the phrases “consisting of” or “consisting essentially of” or “consisting substantially of”. In these aspects or embodiment, the composition described includes or comprises or consists of or consists essentially of or consists substantially of the specific components recited therein, to the exclusion of other ingredients or excipients not specifically recited therein.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Granules refers mainly to solid granules. The granules refer mainly to water dispersible granules, water disintegrable granules, extruded granules or spheronised granules or pellets. As described herein, “GR” refers to water disintegrable granules which can be either extruded granules or spheronized granules or broadcast granules or pellets.

As described herein, “WG” or “WDG” refer to water dispersible granules and are defined as a formulation which disperses or dissolves rapidly when added to water to give a fine particle suspension. Water-dispersible granules are formulated as small, easily measured granules by blending and agglomerating ground nutrients together with surfactants and other formulation excipients which disperse into finer/primary particles upon addition to water. The water-dispersible granules are obtained by spray drying or by an extrusion process.

A ‘Suspension’ encompasses, “aqueous suspension” or aqueous dispersion” or “suspension concentrate (SC)” or “suspo-emulsion” or a “liquid suspension” composition. The suspension is defined as composition wherein solid particles are dispersed or suspended in a liquid. The liquid as a vehicle can be water and/or a water miscible solvent. The water miscible solvent is environmentally safe.

A water disintegrable granule or “GR” refers to a granular composition comprising agglomerated granules or particles which are generally hard and possess resistance not to easily break or crumble. These granules upon contact with sufficient water or soil moisture disintegrate or break into individual particles releasing the nutrients over a prolonged period of time.

The term ‘Elemental Sulphur’ used in the composition refers to elemental sulphur (S°). The term includes allotropes of elemental sulfur such as plastic (amorphous) sulfur, monoclinic sulfur, rhombic sulfur composed of S8 molecules, and other ring molecules such as S7 and S12. The term also comprises sulphur produced through processing and refining of petrochemicals. The term also comprises ‘biosulfur’. The term also comprises elemental Sulphur produced through microbial processes.

The term ‘derivatives’ used in this application shall encompass the minerals and ores containing the minerals of potassium, magnesium, zinc, iron, boron, trace nutrients such as selenium or vanadium along with copper and magnesium. The term derivatives shall also encompass compounds from which potassium, magnesium, zinc, iron, boron, trace nutrients such as selenium or vanadium along with copper and magnesium can be obtained in a form that is assimilable by the plants.

The term ‘plant’ refers to all physical parts of a plant, including seeds, seedlings, saplings, roots, tubers, stems, stalks, foliage, and fruits. The term plant includes transgenic and non-transgenic plants.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The particle size of the composition is defined as the size of particles of the composition in the form of water dispersible granules (WG) or aqueous suspension (SC) or water disintegrable granules, as a whole comprising Sulphur, Potassium salts, Magnesium salts, Zinc salts and Iron salts and excipient/s.

D50 is the corresponding particle size when the cumulative percentage reaches 50%. D50 is also called the median particle diameter or median particle size or average particle size and represent an average 50% of the total particles to be smaller than the determined size.

D90 is used to indicate particle size distribution and represent average 90% of the total particles to be smaller than the determined size. D90 is also the corresponding particle size when the cumulative percentage reaches 90%.

The term ‘GHG’ used in this application encompasses the green house gases.

Nutrient use efficiency (NUE) is defined as a measure of how well plants use the available mineral nutrients. Improvement of NUE is an essential pre-requisite for expansion of crop production into marginal lands with low nutrient availability but also a way to reduce use of inorganic fertilizer.

“Quick release” or “instant release” or “instantaneous dispersion” can be used interchangeably and is applicable to granules which disperses rapidly and get dissolved to release the nutrients.

A mixture is defined as a combination of two or more substances that are not chemically united to each other. A homogeneous mixture is defined as one whose composition is uniform throughout the mixture. It is the type of mixture where the composition is constant throughout or the components that make up the mixture are distributed uniformly.

The present invention relates to a composition for crop nutrition or fortification comprising effective amounts of elemental sulphur; one or more of water insoluble or water soluble magnesium salts or derivatives or mixtures thereof; one or more of water insoluble or water soluble potassium fertilizers or salts or derivatives or mixtures thereof; one or more of water insoluble or water soluble iron salts or derivatives or mixtures thereof; one or more of water insoluble or water soluble zinc salts or derivatives or mixtures thereof and one or more excipients in the range of 0.1% to 60% by the weight of the total composition, wherein the composition comprises elemental sulphur in the range of 5% to 90% by the weight of the total composition; elemental potassium content in the range 0.1% to 40% by the weight of the total composition, elemental magnesium content in the range of 0.1% to 40% by the weight of the total composition; elemental iron content in the range of 0.1% to 45% by the weight of the total composition and elemental zinc content in the range of 0.1% to 45% by the weight of the total composition. In an embodiment, the crop nutrition and fortification composition is in the form of a homogenous mixture.

More particularly, the present composition for crop nutrition and fortification comprises of particles in the size range of 0.1-50 microns, wherein the total content of the water soluble salts or derivatives or mixtures in the composition does not exceed 80% by the weight of the total composition and exhibits improved physical properties in terms of dispersibility suspensibility, viscosity, spontaneity of dispersion, and pourability. The present composition also demonstrated excellent field efficacy even when applied at a reduced dosage of application. In addition, the present composition was further observed to prevent the leaching of these nutrients and making them available to the fullest extent for the uptake by crops and increase the overall yield.

More particularly, the present composition for crop nutrition and fortification comprises the total content of the water soluble salts or derivatives or mixtures not exceeding 70% by the weight of the total composition.

More particularly, the present composition for crop nutrition and fortification comprises the total content of the water soluble salts or derivatives or mixtures not exceeding 60% by the weight of the total composition.

More particularly, the present composition for crop nutrition and fortification comprises the total content of the water soluble salts or derivatives or mixtures not exceeding 50% by the weight of the total composition.

The crop nutrition or fortification composition comprises elemental sulphur in the range of 5% to 90% w/w, the magnesium salts or derivatives or mixtures thereof in the range of 1%-75% w/w of the total composition; the potassium fertilizers, salts or derivatives or mixtures thereof present in the range of 1%-55% w/w of the total composition; the iron salts or derivatives or mixtures thereof in a range of 0.1%-60% w/w of the total composition; and the zinc salts or derivatives or mixtures thereof present in the range of 0.1%-55% w/w of the total composition.

According to an embodiment, the crop nutrition and fortification composition is in the form of a solid or a liquid or a gel. The solid composition is in the form of one of water dispersible granules, broadcast granules, extruded granules, wettable powders and water disintegrable granules. According to an embodiment, the crop nutrition and fortification composition is in the form of water dispersible granules or water disintegrable granules.

According to an embodiment, the crop nutrition and fortification composition is in the form of liquid suspension.

According to an embodiment, the crop nutrition and fortification composition in the form of water dispersible granules or water disintegrable granules comprises:
i. elemental sulphur; wherein the elemental sulphur content is in the range of 5% to 90% by the weight of the total composition;
ii. one or more of water insoluble or water soluble magnesium salts or derivatives or mixtures thereof; wherein the elemental magnesium content is in the range of 0.1% to 40% by the weight of the total composition;
iii. one or more of water insoluble or water soluble potassium fertilizers or salts or derivatives or mixtures thereof; wherein the elemental potassium content is in the range 0.1% to 40% by the weight of the total composition;
iv. one or more of water insoluble or water soluble iron salts or derivatives or mixtures thereof; wherein the elemental iron content is in the range of 0.1% to 45% by the weight of the total composition;
v. one or more of water insoluble or water soluble zinc salts or derivatives or mixtures thereof; wherein the elemental zinc content is in the range of 0.1% to 45% by the weight of the total composition; and
vi. one or more excipients in the range of 0.1% to 60% by the weight of the total composition,
wherein the composition comprises of particles in the size range of 0.1-50 microns, and wherein the total content of the water soluble salts or derivatives or mixtures in the composition does not exceed 80% by the weight of the total composition.

According to further embodiment, the water dispersible granules are in the size range of 0.05 mm to 4 mm. According to further embodiment, the water dispersible granules are in the size range of 0.05 mm to 3 mm. According to further embodiment, the water dispersible granules are in the size range of 0.05 mm to 2 mm. According to further embodiment, the water dispersible granules are in the size range of 0.05 mm to 1.5 mm.

According to further embodiment, the water disintegrable granules are in the size range of 0.05 mm to 6 mm. According to further embodiment, the water disintegrable granules are in the size range of 0.05 mm to 5 mm. According to further embodiment, the water disintegrable granules are in the size range of 0.05 mm to 4 mm. According to further embodiment, the water disintegrable granules are in the size range of 0.05 mm to 3.5 mm.

According to an embodiment, the composition in the form of water dispersible granules comprise particles in the size range of 0.1 micron to 30 microns. According to an embodiment, the composition in the form of water dispersible granules comprise particles in the size range of 0.1 micron to 25 microns. According to an embodiment, the composition in the form of water dispersible granules comprise particles in the size range of 0.1 micron to 20 microns. According to an embodiment, the composition in the form of water dispersible granules comprise particles in the size range of 0.1 micron to 15 microns.

According to another embodiment, the crop nutrition and fortification composition of the present invention in the form of water dispersible granules comprises particles having diameter distribution of D90 of about 20 microns. According to another embodiment, the crop nutrition and fortification composition of the present invention in the form of water dispersible granules comprises particles having diameter distribution of D90 of about 10 microns.

According to another embodiment, the crop nutrition and fortification composition of the present invention in the form of water dispersible granules comprises particles having diameter distribution of D50 of about 10 microns. According to another embodiment, the crop nutrition and fortification composition of the present invention in the form of water dispersible granules comprises particles having diameter distribution of less than 1 micron.

According to an embodiment, the composition in the form of water disintegrable granules comprise particles in a size range of 0.1 micron to 50 microns. According to an embodiment, the composition in the form of water disintegrable granules comprise particles in a size range of 0.1 micron to 40 microns. According to an embodiment, the composition in the form of water disintegrable granules comprise particles in a size range of 0.1 micron to 30 microns.

According to another embodiment, the crop nutrition and fortification composition of the present invention in the form of water disintegrable granules comprises particles having diameter distribution of D90 of about 30 microns. According to another embodiment, the crop nutrition and fortification composition of the present invention in the form of water disintegrable granules comprises particles having diameter distribution of D90 of about 20 microns.

It was further observed that the crop nutrition and fortification composition of the invention when formulated as water dispersible granules or liquid suspension at a specific particle size of 0.1 micron to 30 microns or as water disintegrable granules in a size range of 0.1 micron to 50 microns made the nutrients such as sulphur, magnesium, potassium, zinc and iron readily available for uptake by the plants and increased the overall yield. Thus, the particle size range of 0.1 micron to 50 microns of the crop nutrition and fortification composition was found to be important not only in terms of ease of invention but also in terms of efficacy.

The composition of the present invention meets the nutritional requirements of the crops or the plants by providing a balanced uptake of essential nutrients like potassium, sulphur and magnesium along with micronutrients such as zinc and iron. It was further surprising to observe that the use of this composition leads to a healthier plant that could withstand pest infestation, a higher nutrient harvest in all soil types and finally improve the overall soil health. The present composition acts as a nutrient-use efficient composition while meeting the need of crops by providing a multi nutritive solution with improved uptake by crops in a single application.

According to another embodiment, the ranges of each of the nutrients are kept wide based on the local soil requirements, soil type, prior fertilizer practice and also on the requirement of the crop. Many a times a specific formulation with a particular range of nutrient, such as sulphur or potassium or magnesium is selected on the higher or lower side of the range, to address soil pH, along with targeting yield. Many a times a higher amount of nutrient is taken based on the stage of application of the product. Thus, it is within the scope of the invention, to have a range of nutrients, as claimed, beyond that which is exemplified or described in the embodiments in the specification.

According to an embodiment, the crop nutrition or fortification composition comprises elemental sulphur in the range of 5% to 90% w/w; one or more of water insoluble or water soluble magnesium salts or derivatives or mixtures thereof in the range of 1%-75% w/w of the total composition; one or more of water insoluble or water soluble potassium fertilizers, salts or derivatives or mixtures thereof present in the range of 1%-55% w/w of the total composition; one or more of water insoluble or water soluble iron salts or derivatives or mixtures thereof in a range of 0.1%-60% w/w of the total composition; and one or more of water insoluble or water soluble zinc salts or derivatives or mixtures thereof present in the range of 0.1%-55% w/w of the total composition, wherein the composition is in the form of water dispersible granules or water disintegrable granules.

According to an embodiment, the composition in the form of water dispersible granules or water disintegrable granules comprise water soluble salts or derivatives or mixtures not exceeding 80% by the weight of the total composition. According to an embodiment, the composition in the form of water dispersible granules or water disintegrable granules comprise water soluble salts or derivatives or mixtures not exceeding 70% by the weight of the total composition. According to an embodiment, the composition in the form of water dispersible granules or water disintegrable granules comprise water soluble salts or derivatives or mixtures not exceeding 60% by the weight of the total composition. According to further embodiment, the composition in the form of water dispersible granules or water disintegrable granules comprise water soluble salts or derivatives or mixtures not exceeding 50% by the weight of the total composition.

According to an embodiment, the elemental sulphur is present in the composition in a concentration range of 10% w/w to 90% w/w of the total composition, when the composition is in the form of water dispersible granules or water disintegrable granules. According to an embodiment, the elemental sulphur is present in the composition in a concentration range of 20% w/w to 90% w/w of the total composition, when the composition is in the form of water dispersible granules or water disintegrable granules. According to an embodiment, the elemental sulphur is present in the composition in a concentration range of 20% w/w to 70% w/w of the total composition, when the composition is in the form of water dispersible granules or water disintegrable granules. According to an embodiment, the elemental sulphur is present in the composition in a concentration range of 20% w/w to 50% w/w of the total composition, when the composition is in the form of water dispersible granules or water disintegrable granules.

According to an embodiment, the elemental potassium is present in the composition in a concentration range of 0.1% w/w to 35% w/w of the total composition, when the composition is in the form of water dispersible granules or water disintegrable granules. According to an embodiment, the elemental potassium is present in the composition in a concentration range of 0.1% w/w to 30% w/w of the total composition, when the composition is in the form of water dispersible granules or water disintegrable granules. According to an embodiment, the elemental potassium is present in the composition in a concentration range of 0.1% w/w to 20% w/w of the total composition, when the composition is in the form of water dispersible granules or water disintegrable granules.

According to a further embodiment, the elemental magnesium is present in the composition in a concentration range of 0.1% w/w to 35% w/w of the total composition, when the composition is in the form of water dispersible granules. According to a further embodiment, the elemental magnesium is present in the composition in a concentration range of 0.1% w/w to 30% w/w of the total composition, when the composition is in the form of water dispersible granules. According to a further embodiment, the elemental magnesium is present in the composition in a concentration range of 0.1% w/w to 25% w/w of the total composition, when the composition is in the form of water dispersible granules.

According to a further embodiment, the elemental iron is present in the composition in a concentration range of 0.1% w/w to 40% w/w of the total composition, when the composition is in the form of water dispersible granules or water disintegrable granules. According to a further embodiment, the elemental iron is present in the composition in a concentration range of 0.1% w/w to 30% w/w of the total composition, when the composition is in the form of water dispersible granules or water disintegrable granules. According to a further embodiment, the elemental iron is present in the composition in a concentration range of 0.1% w/w to 25% w/w of the total composition, when the composition is in the form of water dispersible granules or water disintegrable granules. According to a further embodiment, the elemental iron is present in the composition in a concentration range of 0.1% w/w to 20% w/w of the total composition, when the composition is in the form of water dispersible granules or water disintegrable granules.

According to an embodiment, the elemental zinc is present in the composition in a concentration range of 0.1% w/w to 40% w/w of the total composition, when the composition is in the form of water dispersible granules or water disintegrable granules. According to an embodiment, the elemental zinc is present in the composition in a concentration range of 0.1% w/w to 30% w/w of the total composition, when the composition is in the form of water dispersible granules or water disintegrable granules. According to a further embodiment, the elemental zinc is present in the composition in a concentration range of 0.1% w/w to 25% w/w of the total composition, when the composition is in the form of water dispersible granules or water disintegrable granules. According to a further embodiment, the elemental zinc is present in the composition in a concentration range of 0.1% w/w to 20% w/w of the total composition, when the composition is in the form of water dispersible granules or water disintegrable granules.

According to an embodiment, the crop nutrition and fortification composition in the form of a liquid suspension comprises:
i. elemental sulphur in the range of 5% to 60% by the weight of the total composition;
ii. one or more of water insoluble or water soluble magnesium salts or derivatives or mixtures thereof; wherein the elemental magnesium content is in the range of 0.1% to 30% by the weight of the total composition;
iii. one or more of water insoluble or water soluble potassium fertilizers or salts or derivatives or mixtures thereof; wherein the elemental potassium content is in the range 0.1% to 20% by the weight of the total composition;
iv. one or more of water insoluble or water soluble iron salts or derivatives or mixtures thereof; wherein the elemental iron content is in the range of 0.1% to 30% by the weight of the total composition;
v. one or more of water insoluble or water soluble zinc salts or derivatives or mixtures thereof; wherein the elemental zinc content is in the range of 0.1% to 40% by the weight of the total composition; and
vi. one or more excipients in the range of 0.1% to 60% by the weight of the total composition;
wherein the composition comprises of particles in the size range of 0.1-30 microns, wherein the composition comprises water soluble salts or derivatives or mixtures not exceeding 50% by the weight of the total composition.

The crop nutrition or fortification composition in the form of liquid suspension comprises elemental sulphur in the range of 5% to 90% w/w, the magnesium salts or derivatives or mixtures thereof in the range of 0.5%-55% w/w of the total composition; the potassium fertilizers, salts or derivatives or mixtures thereof present in the range of 0.1%-30% w/w of the total composition; the iron salts or derivatives or mixtures thereof in a range of 0.1%-35% w/w of the total composition; and the zinc salts or derivatives or mixtures thereof present in the range of 0.1%-45% w/w of the total composition.

According to an embodiment, the composition in the form of liquid suspension comprises water soluble salts or derivatives or mixtures not exceeding 40% by the weight of the total composition. According to further embodiment, the composition in the form of liquid suspension comprises water soluble salts or derivatives or mixtures not exceeding 30% by the weight of the total composition. According to further embodiment, the composition in the form of liquid suspension comprises water soluble salts or derivatives or mixtures not exceeding 20% by the weight of the total composition.

According to an embodiment, the composition in the form of liquid suspension comprises particles in the size range of 0.1 micron to 25 microns. According to an embodiment, the composition in the form of liquid suspension comprise particles in the size range of 0.1 micron to 20 microns. According to an embodiment, the composition in the form of liquid suspension comprises particles in the size range of 0.1 micron to 15 microns.

According to another embodiment, the crop nutrition and fortification composition of the present invention in the form of liquid suspension comprises particles having diameter distribution of D90 of about 20 microns. According to another embodiment, the crop nutrition and fortification composition of the present invention in the form of liquid suspension comprises particles having diameter distribution of D90 of about 10 microns.

According to another embodiment, the crop nutrition and fortification composition of the present invention in the form of liquid suspension comprises particles having diameter distribution of D50 of about 10 microns. According to another embodiment, the crop nutrition and fortification composition of the present invention in the form of liquid suspension comprises particles having an average diameter distribution of less than 1 micron.

According to an embodiment, the elemental sulphur is present in the composition in a concentration range of 5% w/w to 50% w/w of the total composition, when the composition is in the form of liquid suspension. According to an embodiment, the elemental sulphur is present in the composition in a concentration range of 5% w/w to 40% w/w of the total composition, when the composition is in the form of liquid suspension. According to an embodiment, the elemental sulphur is present in the composition in a concentration range of 5% w/w to 30% w/w of the total composition, when the composition is in the form of liquid suspension. According to an embodiment, the elemental sulphur is present in the composition in a concentration range of 5% w/w to 20% w/w of the total composition, when the composition is in the form of liquid suspension.

According to an embodiment, the elemental potassium is present in the composition in a concentration range of 0.1% w/w to 15% w/w of the total composition, when the composition is in the form of liquid suspension. According to an embodiment, the elemental potassium is present in the composition in a concentration range of 0.1% w/w to 10% w/w of the total composition, when the composition is in the form of liquid suspension. According to an embodiment, the elemental potassium is present in the composition in a concentration range of 0.1% w/w to 5% w/w of the total composition, when the composition is in the form of liquid suspension.

According to a further embodiment, the elemental magnesium is present in the composition in a concentration range of 0.1% w/w to 25% w/w of the total composition, when the composition is in the form of liquid suspension. According to a further embodiment, the elemental magnesium is present in the composition in a concentration range of 0.1% w/w to 15% w/w of the total composition, when the composition is in the form of liquid suspension.

According to a further embodiment, the elemental iron is present in the composition in a concentration range of 0.1% w/w to 25% w/w of the total composition, when the composition is in the form of liquid suspension. According to a further embodiment, the elemental iron is present in the composition in a concentration range of 0.1% w/w to 20% w/w of the total composition, when the composition is in the form of liquid suspension. According to a further embodiment, the elemental iron is present in the composition in a concentration range of 0.1% w/w to 15% w/w of the total composition, when the composition is in the form of liquid suspension.

According to an embodiment, the elemental zinc is present in the composition in a concentration range of 0.1% w/w to 40% w/w of the total composition, when the composition is in the form of liquid suspension. According to an embodiment, the elemental zinc is present in the composition in a concentration range of 0.1% w/w to 30% w/w of the total composition, when the composition is in the form of liquid suspension. According to a further embodiment, the elemental zinc is present in the composition in a concentration range of 0.1% w/w to 20% w/w of the total composition, when the composition is in the form of liquid suspension. According to a further embodiment, the elemental zinc is present in the composition in a concentration range of 0.1% w/w to 15% w/w of the total composition, when the composition is in the form of liquid suspension.

According to further embodiment, the magnesium salts include one or more of but is not limited to, Magnesium Oxide, Magnesium Hydroxide (milk of magnesia), Magnesium Molybdate, Magnesium Phosphate, Calcium magnesium phosphate, Magnesium phosphate tribasic, Magnesium carbonate, Magnesium silicate, Magnesium trisilicate, Magnesium Aluminium Silicate, Calcium Magnesium Silicate; Magnesium ammonium phosphate, Magnesium humate, Magnesium fulvate; Magnesium oxalate, Magnesium tartrate, Magnesium sulphide or derivatives or mixtures thereof. However, those skilled in the art will appreciate that it is possible to utilize other magnesium salts or derivatives thereof without departing from the scope of the invention.

According to further embodiment, the water soluble magnesium salts include magnesium sulphate, magnesium nitrate, magnesium lignosulphonate, magnesium gluconate, magnesium glycinate, magnesium lactate, magnesium aspartate, magnesium ascorbate, magnesium acetate and magnesium citrate. However, those skilled in the art will appreciate that it is possible to utilize other magnesium salts or derivatives thereof without departing from the scope of the invention.

According to an embodiment, the derivatives of magnesium in the composition includes minerals or ores. The ores include ores containing Magnesium but are not limited to Periclase; Brucite; Sellaite; Kotoite; Pertsevite; Suanite; Magnesite; Szaibélyite, Kieserite, Dolomite, hydrated dolomite and struvite. However, those skilled in the art will appreciate that it is possible to utilize other minerals of magnesium without departing from the scope of the invention.

According to an embodiment, the composition of the invention comprises water insoluble magnesium salts.

According to an embodiment, the magnesium salts or derivatives or mixtures thereof are present in the range of 1% to 65% w/w of the total composition, when the composition is in the form of water dispersible granules water disintegrable granules. According to an embodiment, the magnesium salts or derivatives or mixtures thereof are present in the range of 1% to 60% w/w of the total composition, when the composition is in the form of water dispersible granules water disintegrable granules. According to an embodiment, the magnesium salts or derivatives or mixtures thereof are present in the range of 1% to 55% w/w of the total composition, when the composition is in the form of water dispersible granules water disintegrable granules. According to an embodiment, the magnesium salts or derivatives or mixtures thereof are present in the range of 1% to 40% w/w of the total composition, when the composition is in the form of water dispersible granules water disintegrable granules.

According to an embodiment, the magnesium salts or derivatives or mixtures thereof are present in the range of 1% to 45% w/w of the total composition, when the composition is in the form of liquid suspension. According to an embodiment, the magnesium salts or derivatives or mixtures thereof are present in the range of 1% to 25% w/w of the total composition, when the composition is in the form of liquid suspension.

According to an embodiment, the potassium fertilizers or salts or derivatives include muriate of potash; potassium magnesium sulphate; potassium nitrate; potassium sodium nitrate; potassium hydroxide; potassium carbonate; potassium orthophosphate; potassium polyphosphate; potassium phosphate; potassium metaphosphate; potassium sulphate; sulphate potash magnesia; potassium chloride; rock potash; bittern potassium salt (KCl(+NaCl+MgSO4)); plant and wood ashes (K2CO3+KHCO3) and kelp ashes (KCl+K2SO4); potassium fulvate; potassium humate and potassium rock powder or derivatives or mixtures thereof. However, those skilled in the art will appreciate that it is possible to utilize other potassium salts, their derivatives without departing from the scope of the invention.

According to an embodiment, the derivatives of potassium in the composition include minerals or ores. The ores include ores containing potassium but are not limited to Schoenite or Picromerite; Feldspar; Orthoclase; Slyvite; Carnallite; Kainite; Polyhalite or Ischelite or Polygalite; Leucite; Arrojadite; Gengenbachite; Haigerachite; Lepidolite Hazenite, Kosnarite, Langbeinite Leucophosphite, Lipuite, Manganoarrojadite, Mantienneite, Minyulite, Parwanite, Phosphofibrite, Sylvinite, Taranakite and Tinsleyite. However, those skilled in the art will appreciate that it is possible to utilize other minerals of potassium without departing from the scope of the invention.

According to an embodiment, the potassium fertilizers, salts or derivatives or mixtures thereof are present in the range of 1% to 45% w/w of the total composition, when the composition is in the form of water dispersible granules water disintegrable granules. According to an embodiment, the potassium fertilizers, salts or derivatives or mixtures thereof are present in the range of 1% to 35% w/w of the total composition, when the composition is in the form of water dispersible granules water disintegrable granules. According to an embodiment, the potassium fertilizers, salts or derivatives or mixtures thereof are present in the range of 1% to 25% w/w of the total composition, when the composition is in the form of water dispersible granules water disintegrable granules.

According to an embodiment, the potassium fertilizers, salts, or derivatives or mixtures thereof are present in the range of 0.1% to 25% w/w of the total composition, when the composition is in the form of liquid suspension. According to an embodiment, the potassium fertilizers, salts or derivatives or mixtures thereof are present in the range of 1% to 20% w/w of the total composition, when the composition is in the form of liquid suspension. According to an embodiment, the potassium fertilizers, salts or derivatives or mixtures thereof are present in the range of 1% to 15% w/w of the total composition, when the composition is in the form of liquid suspension.

According to further embodiment, the iron salts or derivatives include one or more of but not limited to, iron oxide, iron hydroxide, iron phosphate, iron fumarate, iron succinate, iron sulphide, iron tartarate, iron sucrate, carbonyl iron, iron silicate, iron carbonate; iron(II) oxalate (anhydrous), Iron(II) oxalate (dihydrate) or derivatives or mixtures thereof. The iron oxide includes, but is not limited to, Ferrous oxide (FeO) or Iron oxide, Ferric oxide (Fe2O3) or red oxide, and Ferroso ferric oxide (Fe3O4) or black iron oxide. Iron hydroxide includes, but is not limited to, Ferric hydroxide, yellow iron oxide (FeOOH), Iron hydroxide (Fe(OH)3), Iron hydroxide (III), Iron oxyhydroxide and limonite. Iron phosphate includes, but is not limited to, Iron(II) phosphate or ferrous phosphate, Ferric phosphate, Ferric phosphate dihydrate, Ferric phosphate hydrate, Ferric glycerophosphate, Ferrous pyrophosphate and Ferric pyrophosphate. Iron fumarate includes, but is not limited to Ferrous fumarate and Iron fumarate. Iron succinate includes but is not limited to Ferrous succinate and Succinic acid Iron(II) salt. However, those skilled in the art will appreciate that it is possible to utilize other iron salts, their derivatives or mixtures, without departing from the scope of the invention.

According to further embodiment, the water soluble iron salts or derivatives comprise one or more of iron sulphate, iron citrate, iron silicate, iron ascorbate, iron sucrose; iron gluconate, iron dextran, iron lignosulphonate and iron chelates. However, those skilled in the art will appreciate that it is possible to utilize other iron salts, their derivatives or mixtures, without departing from the scope of the invention.

According to further embodiment, the derivatives of iron in the composition include minerals or ores. The ores include ores containing Iron but are not limited to Roaldite, Wustite, Magnetite, Hematite, Goethite, Limonite, Siderite, Pyrite or Marcasite, Bernalite and Greenalite. However, those skilled in the art will appreciate that it is possible to utilize other minerals of iron without departing from the scope of the invention.

According to an embodiment, the iron salts or derivatives or mixtures thereof are present in the range of 0.1% to 50% by the weight of the total composition, when the composition is in the form of water dispersible granules or water disintegrable granules. According to an embodiment, the iron salts or derivatives or mixtures thereof are present in the range of 0.1% to 40% by the weight of the total composition, when the composition is in the form of water dispersible granules or water disintegrable granules. According to an embodiment, the iron salts or derivatives or mixtures thereof are present in the range of 0.1% to 35% by the weight of the total composition, when the composition is in the form of water dispersible granules or water disintegrable granules. According to an embodiment, the iron salts, or its derivatives or mixtures thereof are present in the range of 0.1% to 25% by the weight of the total composition, when the composition is in the form of water dispersible granules or water disintegrable granules. According to an embodiment, the iron salts, or its derivatives or mixtures thereof are present in the range of 0.1% to 20% by the weight of the total composition, when the composition is in the form of water dispersible granules or water disintegrable granules.

According to an embodiment, the iron salts, or its derivatives or mixtures thereof are present in the range of 0.1% to 30% by the weight of the total composition, when the composition is in the form of a liquid suspension composition. According to an embodiment, the iron salts, or its derivatives or mixtures thereof are present in the range of 0.1% to 20% by the weight of the total composition, when the composition is in the form of a liquid suspension composition. According to an embodiment, the iron salts, or its derivatives or mixtures thereof are present in the range of 0.1% to 15% by the weight of the total composition, when the composition is in the form of a liquid suspension composition.

According to a further embodiment, the water insoluble zinc salts or derivatives include zinc oxide, zinc hydroxide, zinc chromate, zinc nitride, zinc carbonate, zinc sulphide, zinc molybdate, zinc nitrilotriacetic acid (nta), zinc phosphate, zinc phosphide, zinc borate, zinc silicate, zinc pyrophosphate, zinc humate, zinc selenide, zinc telluride, zinc fulvate, zinc citrate, zinc oxalate, zinc monomethionine, zinc carnosine and zinc aspartate or derivatives or mixtures thereof. However, those skilled in the art will appreciate that it is possible to utilize other zinc salts without departing from the scope of the invention.

According to a further embodiment, the water soluble zinc salts or derivatives include zinc sulphate, zinc sulphate monohydrate, zinc sulphate heptahydrate, zinc chelate, zinc oxysulfate, zinc chloride, eugenol chelated zinc, zinc glycine, zinc carbohydrate, zinc sucrate, zinc acetate, zinc gluconate, zinc polyflavonoid, zinc glucoheptonate, zinc phenolate and zinc lignosulphonate. However, those skilled in the art will appreciate that it is possible to utilize other zinc salts, their derivatives or mixtures, without departing from the scope of the invention.

According to further embodiment, the zinc derivatives of zinc in the composition include minerals or ores. The ores include ores containing Zinc but are not limited Danbaite, Ashoverite, Periclase, Sphalerite, Wurtzite, Hydrozincite, Brianyoungite, Hemimorphite, Smithsonite, Bechererite, Aurichalcite, Hopeite, Hodgkinsonite, Fraipontite, Junitoite, Clinohedrite, Christelite, Gunningite, Cianciulliite, Ecandrewsite, Baileychlore, Boyleite and Bianchite, However, those skilled in the art will appreciate that it is possible to utilize other minerals of zinc without departing from the scope of the invention.

According to an embodiment, the zinc salts, its derivatives or mixtures thereof are present in the range of 0.1% to 45% by the weight of the total composition, when the composition is in the form of water dispersible granules or water disintegrable granules. According to an embodiment, the zinc salts, its derivatives or mixtures thereof are present in the range of 0.1% to 35% by the weight of the total composition, when the composition is in the form of water dispersible granules or water disintegrable granules. According to an embodiment, the zinc salts or derivatives or mixtures thereof are present in the range of 0.1% to 25% by the weight of the total composition, when the composition is in the form of water dispersible granules or water disintegrable granules.

According to an embodiment, the zinc salts, its derivatives or mixtures thereof are present in the range of 0.1% to 30% by the weight of the total composition, when the composition is in the form of a liquid suspension. According to an embodiment, the zinc salts, its derivatives or mixtures thereof are present in the range of 0.1% to 20% by the weight of the total composition, when the composition is in the form of a liquid suspension. According to an embodiment, the zinc salts, its derivatives or mixtures thereof are present in the range of 0.1% to 15% by the weight of the total composition, when the composition is in the form of a liquid suspension.

According to an embodiment, the crop nutrtion and fortification composition comprises water insoluble iron salts and water insoluble zinc salts.

In an embodiment, the crop nutrition and fortification composition further comprises one or more of excipients selected from one or more of surfactants emulsifiers, wetting agents, dispersing agents, fillers, carriers, diluents, spreading agents, colorants, anticaking agents, binders, buffers, pH adjusters, neutralizing agents, pigments, stabilizers, antifoaming agents, defoamers, penetrants, structuring agents, humectants, sticking agents, anti-freezing agent, freeze point depressants, chelating, complexing, sequestering agents, preservatives, bactericides, anti-fungal agents or biocides, anti-microbial agents or antioxidants.

According to an embodiment, the excipients are present in a concentration range of 0.01% to 60% by the weight of the total composition. According to an embodiment, the excipients are present in a concentration range of 0.1% to 60% by the weight of the total composition. According to an embodiment, the excipients are present in a concentration range of 0.1% to 50% by the weight of the total composition.

According to an embodiment, the excipients that are used in the crop nutrition composition include one or more of surfactants, emulsifiers, wetting agents, and dispersing agents.

According to an embodiment, the surfactants that are used in the composition include one or more of anionic, non-ionic and polymeric surfactants.

The anionic surfactants include one or more of, but not limited to a salt of fatty acid, a polycarboxylate, alkyl ether sulfates, an alkyl sulfate, an alkylarylsulfate, an alkylaryl sulfonate, an aryl sulfonate, a lignin sulfonate, an alkyl diphenyl ether disulfonate, a polystyrene sulfonate, a salt of alkylphosphoric acid ester, an alkylaryl phosphate, a styrylaryl phosphate, a salt of polyoxyethylene alkyl ether sulfuric acid ester, alpha olefin sulfonate sodium salt, alkyl benzene sulfonate or its salts, sodium lauroylsarcosinate, sulfosuccinates, polyacrylates, alkyl ether phosphate, a salt of polyoxyethylenealkylaryl phosphoric acid ester, sulfosuccinates-mono and other diesters, phosphate esters, alkyl naphthalene sulfonate-isopropyl and butyl derivatives, alkyl aryl ether phosphates, a salt of polyoxyethylene aryl ether phosphoric acid ester, mono-alkyl sulphosuccinates, aromatic hydrocarbon sulphonates, ammonium laurylsulphate, soap, soap substitute, sodium alkyl sulfate, sodium dodecyl sulfate, sodium dodecylbenzenesulfonate, sodium laurate, sodium laureth sulfate, sodium nonanoyloxybenzenesulfonate, alkyl carboxylates, sodium stearate, alpha olefin sulphonates, naphthalene sulfonate salts, alkyl naphthalene sulfonate fatty acid salts, naphthalene sulfonate condensates-sodium salt, fatty alcohol sulphates, alkyl naphthalene sulfonate condensates-sodium salt, a naphthalene sulfonic acid condensed with formaldehyde or a salt of alkylnaphthalene sulfonic acid condensed with formaldehyde or salts or derivatives thereof. However, those skilled in the art will appreciate that it is possible to utilize different anionic surfactants without departing from the scope of the present invention.

The non-ionic surfactants or polymeric surfactants include one or more of but not limited to Polyol Esters, Polyol Fatty Acid Esters, Ethoxylated and Propoxylated Fatty Alcohols, EO and PO Block Copolymers, Di, Tri-Block Copolymers, Polysorbates, Alkyl Polysaccharides, Polyoxyethylene Glycol, Sorbitan Derivatives, Fatty Acid Esters of Sorbitan (Spans) and their Ethoxylated Derivatives (Tweens), Cocamide Monoethanolamine (MEA), Decyl, Narrow-Range Ethoxylate, Oleyl Alcohol, PEG-10, Polysorbate, Polysorbate 20, Polysorbate 80, Sorbitan, Sorbitanmonolaurate, Sorbitanmonostearate, Sorbitantristearate, Stearyl Alcohol, Castor Oil Ethoxylate, Polyglycol Ethers, Polyadducts of Ethylene Oxide and Propylene Oxide, Polyoxy Ethylene Sorbitan, Fatty Acid Polyglyceride, Polyoxyethylene Alkyl Ether, Polyoxyethylenealkylaryl Ether, a Polyoxyethylenestyrylaryl Ether, a Polyoxyethylene Glycol Alkyl Ether, Alcohol Ethoxylates-C6 to C16/18 Alcohols, Linear and Branched, Alcohol Alkoxylates-various Hydrophobes and EO/PO contents and ratios, a Polyoxyethylene Hydrogenated Castor oil, salts or derivatives thereof. However, those skilled in the art will appreciate that it is possible to utilize different non-ionic surfactants or polymeric surfactants without departing from the scope of the present invention.

According to an embodiment, the surfactant is present in an amount of 0.1% to 40% w/w of the total composition. According to an embodiment, the surfactant is present in an amount of 0.1% to 30% w/w of the total composition.

According to an embodiment, the dispersing agents which are used in the crop nutrition composition include, but not limited to non-ionic dispersants selected from one or more of polyvinyl pyrrolidone, polyvinyl alcohol, polyoxyethylene alkyl ethers, polyoxyethylene alkyl phenyl ether, ethoxylated fatty acids, aliphatic alcohol ethoxylates, alkyl ethoxylates, EO-PO block and graft copolymers;

However, those skilled in the art will appreciate that it is possible to utilize different non-ionic dispersants without departing from the scope of the present invention.

Anionic dispersants include one or more of tristyrylphenolethoxylate phosphate esters, lignin sulphonates, phenyl naphthalene sulphonates, alkali metal, alkylarylsulfonates, alkylsulfonates, mixture of sodium salt of naphthalene sulphonic acid urea formaldehyde condensate and sodium salt of phenol sulphonic formaldehyde condensate, polycarboxylates, sodium alkyl benzene sulfonates, sodium salts of sulfonated naphthalene, sodium naphthalene sulfonate formaldehyde condensates, condensation products of aryl sulphonic acids and formaldehyde, polyaromatic sulfonates, sodium alkyl aryl sulfonates and kraft lignin. However, those skilled in the art will appreciate that it is possible to utilize different anionic dispersants without departing from the scope of the present invention.

According to an embodiment, the dispersing agent is present in an amount of 0.1%-40% w/w of the total composition. According to an embodiment, the dispersing agent is present in an amount of 0.1%-30% w/w of the total composition.

According to an embodiment the wetting agents used in the crop nutrition composition include, but are not limited to one or more of phenol naphthalene sulphonates, alkyl naphthalene sulfonate, sodium alkyl naphthalene sulfonate, naphthalene sulphonate sodium salt, dibutylnaphthalene sulfonic acid, alkylarylsulfonates, dioctyl sulfosuccinate, polyoxyethoxylated fatty alcohols, alkane sulfonates, alkylbenzene sulfonates, alkyl ether phosphates, alkyl ether sulphates and alkyl sulfosuccinic monoesters, salts or derivatives thereof. However, those skilled in the art will appreciate that it is possible to utilize different wetting agents without departing from the scope of the present invention.

According to an embodiment, the wetting agent is present in an amount of 0.1%-30% w/w of the total composition.

According to an embodiment, the carriers that are used in the crop nutrition composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention.

The solid carriers include natural minerals like clay such as china clay, acid clay, kaolin such as kaolinite, dickite, nacrite, and synthetic and diatomaceous silicas, micas, such as pyrophyllite, talc, silicas such as cristobalite and quartz, such as attapulgite and sepiolite, vermiculite, laponite, pumice, bauxite, hydrated aluminas, perlite, sodium bicarbonate, limestone, natural and synthetic silicates, silicas, surface-modified silicas, zeolite, diatomaceous earth, loess, mirabilite, white carbon, slaked lime, synthetic silicic acid, starch, modified starch, cellulose, plant carriers such as cellulose, chaff, wheat flour, wood flour, starch, rice bran, wheat bran, and soybean flour, casein sodium, sucrose, salt cake, potassium pyrophosphate, sodium tripolyphosphate or derivatives or mixtures thereof.

According to an embodiment, the carrier is present in an amount of 0.1% to 50% w/w of the composition. According to an embodiment, the carrier is present in an amount of 0.1% to 30% w/w of the composition.

According to an embodiment, the antifoaming agents or defoamers which are used in the crop nutrition composition include but are not limited to one or more of silica, siloxane, silicone dioxide, polydimethyl siloxane, alkyl polyacrylates, ethylene oxide/propylene oxide copolymers, silicone oils and magnesium stearate or derivatives thereof. Preferred antifoaming agents include silicone emulsions, long-chain alcohols, fatty acids, fluoro-organic compounds. However, those skilled in the art will appreciate that it is possible to utilize different antifoaming agents without departing from the scope of the present invention.

According to an embodiment, the anti-foaming agent is present in an amount of 0.01% to 20% w/w of the total composition.

According to an embodiment, the pH-adjusters or buffers or neutralizing agents that are used in the composition include both acids and bases of the organic or inorganic type and mixtures thereof. According to a further embodiment, pH-adjusters or buffers or neutralizing agents include, but are not limited to one or more of organic acids, inorganic acids, and alkali metal compounds or salts, derivatives thereof. According to an embodiment, the organic acids include, but not limited to one or more of citric, malic, adipic, fumaric, maleic, succinic, and tartaric acids, or salts, derivatives thereof, and the mono-, di-, or tribasic salts of these acids or derivatives thereof. According to an embodiment, the salts of inorganic acids include, but not limited to one or more of alkali metal salts such as, sodium chloride, sodium nitrate, and the like. Mixtures can also be used to create a pH-adjusters or buffers or neutralizing agents. However, those skilled in the art will appreciate that it is possible to utilize different pH adjusters without departing from the scope of the present invention.

According to an embodiment, the pH adjusters or buffers are present in an amount of 0.01% to 20% w/w of the total composition.

According to an embodiment, the anticaking agents which are used in the crop nutrition composition include, but are not limited to one or more of polysaccharides such as starch, alginic acid, mannose, galactose; poly(vinylpyrrolidone), fumed silica (white carbon), ester gum, a petroleum resin, Foammaster® Soap L sodium stearate, Brij® 700 polyoxyethylene (100) stearylether, sodium acetate, sodium metasilicate, sodium alkylsulfosuccinates, sodium carbonate or bicarbonate, salts or derivatives thereof. However, those skilled in the art will appreciate that it is possible to utilize different anticaking agents without departing from the scope of the present invention.

According to an embodiment, the anticaking agent is present in an amount of 0.1% to 20% w/w of the total composition.

According to an embodiment, the spreading agents which are used in the composition include but are not limited to one or more of copolymer of maleic acid with a styrene compound, a (meth)acrylic acid copolymer, aliphatic alcohols, vegetable oils such as cottonseed or inorganic oils, petroleum distillates, trisiloxanes and modified trisiloxanes or derivatives thereof. However, those skilled in the art will appreciate that it is possible to utilize different spreading agents without departing from the scope of the present invention.

According to an embodiment, the spreading agent is present in an amount of 0.01% to 20% w/w of the total composition.

According to an embodiment, the sticking agents which are used in the composition include, but not limited to one or more of paraffin, a polyamide resin, polyacrylate, polyoxyethylene, wax, latex, polyvinyl pyrrolidone, gums such as xanthan gum, vegetable oils such as cottonseed, or inorganic oils, petroleum distillates, modified trisiloxanes, polyglycol, a synthetic resin emulsion or salts or derivatives thereof. However, those skilled in the art will appreciate that it is possible to utilize different sticking agents without departing from the scope of the present invention.

According to an embodiment, the sticking agent is present in an amount of 0.01% to 30% w/w of the total composition.

According to an embodiment, the structuring agents that are used in the crop nutrition composition include, but are not limited to one or more of thickeners, viscosity modifiers, tackifiers, suspension aids, rheological modifiers or anti-settling agents. A structuring agent prevents sedimentation of the nutrient particles after prolonged storage.

According to an embodiment, the structuring agents which are used in the composition include, but not limited to one or more of polyacrylics, polysaccharides, cellulose derivatives, co-polymers of cellulose derivatives, polyvinyl alcohol and derivatives; clays such as kaolin, smectite, attapulgites and natural gums such as guar gum, xanthan gum, gelatin, dextrin, fumed silica, mixture of fumed silica and fumed aluminium oxide, swellable polymers, poly(ethylene glycol), stachyose, celluloses such as hemicellulose, carboxymethylcellulose, ethylcellulose, hydroxyethylcellulose, hydroxy-methyl ethyl cellulose, hydroxyl ethyl propyl cellulose, methylhydroxyethylcellulose, methylcellulose, plant starches such as corn starch and potato starch. However, those skilled in the art will appreciate that it is possible to utilize different structuring agents without departing from the scope of the present invention.

Preferred structuring agents include one or more of xanthan gum, aluminum silicate, Hydroxypropyl methylcellulose, carboxymethyl cellulose, methylcellulose, polysaccharide, alkaline earth metal silicate, clays, gelatin, and polyvinyl alcohol.

According to an embodiment, the structuring agent is present in an amount of 0.01% to 20% w/w of the composition. According to an embodiment, the structuring agent is present in an amount of 0.01% to 10% w/w of the composition. According to an embodiment, the structuring agent is present in 0.01% to 5% w/w of the composition.

According to an embodiment, the anti-freezing agents or freezing point depressants used in the composition include, but are not limited to one or more of polyhydric alcohols such as ethylene glycol, diethylene glycol, dipropylene glycol, propylene glycol, glycerol, monohydric or polyhydric alcohols, glycol ethers, glycerol, However, those skilled in the art will appreciate that it is possible to utilize different anti-freezing agents without departing from the scope of the present invention.

According to an embodiment, the anti-freezing agents or freezing point depressants is present in an amount of 0.01% to 30% w/w of the total composition.

According to an embodiment, the chelating or complexing or sequestering agents which are used in the composition include, but not limited to one or more of polycarboxylic acids such as polyacrylic acid and the various hydrolyzed poly (methyl vinyl ether/maleic anhydride); N-hydroxyethyliminodiacetic acid, nitrilotriacetic acid (NTA), N,N,N′,N′-ethylenediaminetetraacetic acid, N-hydroxyethyl-N, N′,N′-ethylenediaminetriacetic acid and N,N,N′,N″,N″-diethylenetriaminepentaacetic acid; a-hydroxy acids, such as citric acid, tartaric acid and gluconic acid; orthophosphates, disodium phosphate, monosodium phosphate; condensed phosphates, such as sodium tripolyphosphate, tetrasodium pyrophosphate, sodium hexametaphosphate and sodium tetrapolyphosphate; ethylene diamine tetraacetic acid (EDTA), diethylenetriaminepentaacetic acid (DTPA), N-hydroxyethyl-ethylenediamine-triacetic acid (HEDTA), ethylenediaminediacetate (EDDA), ethylenediaminedi (o-hydroxyphenylacetic) acid (EDDHA), cyclohexane diamine tetraacetic acid (CDTA), fulvic acid, ulmic acid, nucleic acids, cyclodextrin, humic acid, pyrophosphate. However, those skilled in the art will appreciate that it is possible to utilize different chelating agents without departing from the scope of the present invention.

According to an embodiment, the chelating agent is present in an amount of 0.01% to 30% w/w of the total composition.

According to an embodiment, the penetrant which is used in the composition include, but not limited to one or more of alcohol, glycol, glycol ether, ester, amine, alkanolamine, amine oxide, quaternary ammonium compound, triglyceride, fatty acid ester, fatty acid ether, N-methyl pyrrolidone, dimethyl formamide, dimethyl acetamide, or dimethyl sulfoxide, polyoxyethylenetrimethylolpropanemonooleate, polyoxyethylene sorbitan monooleate polyoxyethylenetrimethylolpropanedioleate, polyoxyethylene trimethylol propane trioleate, polyoxyethylene sorbitol hexaoleate. However, those skilled in the art will appreciate that it is possible to utilize different penetrants without departing from the scope of the present invention.

According to an embodiment, the penetrant is present in an amount of 0.01% to 30% w/w of the total composition.

According to an embodiment, the humectant is selected from, but not limited to one or more of polyoxyethylene/polyoxypropylene copolymers, particularly block copolymers. Other humectants are propylene glycol, monoethylene glycol, hexylene glycol, butylene glycol, ethylene glycol, diethylene glycol, poly(ethylene glycol), poly(propylene glycol), glycerol and the like; polyhydric alcohol compounds such as propylene glycol ether, derivatives thereof. However, those skilled in the art will appreciate that it is possible to utilize different humectants without departing from the scope of the present invention.

According to an embodiment, the humectant is present in the range of 0.1% to 40% w/w of the total composition.

According to an embodiment, the stabilizers which are used in the agricultural composition include, but not limited to one or more of peroxide compounds such as hydrogen peroxide and organic peroxides, zeolite, antioxidants such as phenol compounds, phosphoric acid compounds, EDTA, sodium sulphites, citric acid, citrates and the like. However, those skilled in the art will appreciate that it is possible to utilize other conventionally known stabilizers without departing from the scope of the present invention.

According to an embodiment, the stabilizer is present in the range of 1% to 30% w/w of the total composition.

According to an embodiment, preservative is selected from one or more of formic acid, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3 (2H)-one, BIT, commercially available as Proxel® types from Arch Biocides Ltd.) or 2-methyl-4,5-trimethylene-2H-isothiazol-3-one (MTIT), Proxel® or ActicideR RS and Kathon® MK, Sodium Propinoate, Sodium Benzoate, Propyl Paraben, Propyl Paraben Sodum, Potassium Sorbate, Potassium Benzoate, Phenyl Mercuric Nitrate, Phenyl Etehyl Alcohol, Sodium, Ethylparaben, Methylparaben, Butylparaben, Bezyl Alcohol, Benzothonium Chloride, Cetylpyridinium Chloride, Antioxidants includes but not limited to one or more of imidazole and imidazole derivatives (e.g. urocanic acid), 4,4′-thiobis-6-t-butyl-3-methylphenol, 2,6-di-t-butyl-p-cresol (BHT), penta erythrityl tetrakis [3-(3,5,-di-t-butyl-4-hydroxyphenyl)] propionate; amine antioxidants. However, those skilled in the art will appreciate that it is possible to utilize other conventionally known preservatives without departing from the scope of the present invention.

According to an embodiment, the preservative is present in the range of 0.01% to 2% w/w of the total composition.

According to an embodiment, the pigments and colorants are selected from but not limited to synthetic chemicals obtained from various manufacturers. The pigments and colorants can be water soluble or water insoluble, in the form of lakes. Dyes can be solvent dyes, acid dyes or basic dyes. However, those skilled in the art will appreciate that it is possible to utilize other conventionally known pigments and colorants without departing from the scope of the present invention.

According to an embodiment, the pigments and colorants are present in the range of 0.01% to 5% w/w of the total composition.

According to an embodiment, the disintegrating agents which are used in the agricultural composition include, but not limited to one or more of inorganic water soluble salts e.g. sodium chloride; water soluble organic compounds such as agar, hydroxypropyl starch, carboxymethyl starch ether, tragacanth, cross-linked sodium carboxymethyl cellulose, sodium tripolyphosphate, sodium hexametaphosphate, metal stearates, a cellulose powder, dextrin, methacrylate copolymer, Polyplasdone® XL-10 (crosslinked polyvinylpyrrolidone), poly(vinylpyrrolidone). However, those skilled in the art will appreciate that it is possible to utilize other conventionally known disintegrating agents without departing from the scope of the present invention.

According to an embodiment, the disintegrating agent is present in the range of 0.5% to 15% w/w of the total composition.

According to an embodiment, the binding agents or binders that are used in the agricultural composition include, but not limited to one or more of proteins, gums, maltodextrin, carbohydrates such as monosaccharides, disaccharides, oligosaccharides and polysaccharides, complex organic substance, synthetic organic polymers or derivatives and combinations thereof. However, those skilled in the art will appreciate that it is possible to utilize other conventionally known binding agents without departing from the scope of the present invention.

According to an embodiment, the binder is present in the range of 0.1% to 10% w/w of the total composition.

According to an embodiment, the crop nutrition and fortification composition opitionally includes at least one further active ingredient. According to an embodiment, the optional active ingredients include one or more of fertilizers, trace nutrients, biostimulants, pesticides, or mixtures thereof. According to an embodiment, the biostimulant for instance, comprises or contains organic carbon or is a source of organic carbon. According to a further embodiment, the biostimulant could be one or more of humic acid or humic substances, fulvic acid or biochar. However, those skilled in the art will appreciate that it is possible to utilize other active ingredients without departing from the scope of the present invention.

According to an embodiment, the crop nutrition composition and fortification composition is devoid of fertilizers that primarily comprise urea or other conventional nitrogen fertilizers.

According to an embodiment, the further active ingredient is present in the range of 0.1% to 30% w/w of the total composition.

According to an embodiment, the crop nutrition and fortification composition optionally comprises one or more of phosphorous fertilizers or salts, derivatives or mixtures thereof wherein the elemental phosphorous content in the composition is in the range of 0.1% to 30% by the weight of the total composition.

According to an embodiment, elemental phosphorous content is in the range of 0.1% to 20% by the weight of the total composition. According to an embodiment, elemental phosphorous content can be in the range of 0.1% to 10% by the weight of the total composition.

According to an embodiment, the phosphorus fertilizers include one or more of potassium phosphate; dipotassium hydrogen phosphate; potassium dihydrogen phosphate; rock phosphate; ammonium sulfate phosphate ((NH4)2SO4+NH4H2PO4); potassium sulfate ammonium phosphate ((NH4)2SO4+NH4H2PO4+K2SO4); ball fertilizer (ammonium sulfate+calcium superphosphate+potassium salt+peat, where the form of phosphate is Ca(H2PO4)2); compound fertilizer (Ca(H2PO4)2, CaHPO4, Ca3 (HPO4)2); calcium phosphate; dicalcium phosphate; tricalcium phosphate; bone meal; calcium superphosphate (Ca(H2PO4)2+CaSO₄); concentrated superphosphate (Ca(H₂PO₄)₂); serpentine-superphosphate (calcium superphosphate+serpentine); fused magnesium phosphate (CaO—MgO—P₂O₅—SiO₂ glass); calcined phosphate (Ca₃(PO₄)₂—CaNaPO₄ solid solution); phosphate mixture (calcium superphosphate (concentrated superphosphate)+fused magnesium phosphate); precipitated phosphate (CaHPO4); magnesium hydrogen phosphate; magnesium phosphate; ammonium phosphate; monoammonium dihydrogen phosphate; diammonium hydrogen phosphate and mixed salts such as dipotassium ammonium phosphate and potassium ammonium hydrogen phosphate and the hydrates of the aforementioned salts or derivatives of potassium or mixtures thereof. According to an embodiment, phosphorous fertilizer can be in the form of elemental phosphorous. The phosphorous fertililizer can also be in the form of phosphoric acid. However, those skilled in the art will appreciate that it is possible to utilize other phosphorous salts, or their derivatives or mixtures without departing from the scope of the invention.

According to an embodiment, the phosphorous derivatives include one or more of phosphorous containing minerals or ores or processed ores containing phosphorous including but not limited to one or more of Phosphorite, fluorapatite, francolite, phosphate rock or rock phosphate, Feldspar or microcline, Variscite, Strengite, Vivianite, Struvite, Turquoise, Lazulite, Triphylite, Archerite, Arrojadite, Arrojadite, Bicapite, Francoanellite, Gengenbachite, Haigerachite, Hazenite, Kosnarite, Leucophosphite, Manganoarrojadite, Mantienneite, Mantienneite, Meta-ankoleite, Millisite, Minyulite, Phosphofibrite, Phosphuranylite, Spheniscidite, Struvite-(K), Taranakite, Tinsleyite, and Apatite, bone meal, bone ash from which the phosphorous fertilizers, salts, derivatives can be derived. However, the above list of ores or minerals is exemplary and not meant to limit the scope of the invention.

According to an embodiment, the phosphorous salts, derivatives and mixtures can be present in the range of 1% w/w to 50% w/w of the total composition. According to an embodiment, the phosphorous salts, derivatives and mixtures can be present in the range of 1% w/w to 40% w/w of the total composition. According to an embodiment, the phosphorous salts, derivatives and mixtures can be present in the range of 1% w/w to 30% w/w of the total composition.

The present composition was also found to play a vital role in regulating the soil pH and facilitating the uptake of other nutrients that are trapped in the soil by the plants because of various factors, primarily being soil degradation on account of excessive use of synthetic fertilizers. The present composition acts as a nutrient-use efficient composition while meeting the need of crops by providing a multi-nutritive solution with improved uptake by crops in a single application.

It has been surprisingly found that the crop nutrition and fortification composition of the present invention has enhanced and improved physical properties of dispersibility, suspensibility, wettability, viscosity, pourability, hardness, disintegration, attrition resistance and provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the crop nutrition and fortification composition in the form of water dispersible granules has a wettability of less than 2 minutes. According to an embodiment, the composition in the form of water dispersible granules has a wettability of less than 1 minute. According to an embodiment, the composition in the form of water dispersible granules has a wettability of less than 30 seconds.

According to an embodiment, the crop nutrition and fortification composition in the form of water dispersible granules or liquid suspension passes the wet sieve retention test. The test is used to determine the amount of non-dispersible material in formulations that are applied as dispersions in water. The wet sieve retention value of the composition in the form of liquid suspension and granules is measured by using the Standard CIPAC Test MT-185 which describes a procedure for measuring the amount of material retained on the sieve. A sample of the formulation is dispersed in water and the suspension formed is transferred to a sieve and washed. The amount of the material retained on the sieve is determined by drying and weighing.

According to an embodiment, the crop nutrition composition in the form of water dispersible granule or liquid suspension has a wet sieve retention value on a 75-micron sieve of less than 2%. According to an embodiment, the crop nutrition composition has a wet sieve retention value on a 75-micron sieve of less than 0.2%. The wet sieve retention value of less than 2% indicates that the crop nutrition and fortification composition helps in the easy application of the formulation preventing clogging of the nozzles or filter equipment.

According to an embodiment, the crop nutrition composition in the form of liquid suspension is not highly concentrated and is easily pourable. The viscosity of a fluid is a measure of its resistance to gradual deformation by shear stress or tensile stress.

According to an embodiment, viscosity of the liquid suspension is determined as per CIPAC MT-192. A sample is transferred to a standard measuring system. The measurement is carried out under different shear conditions and the apparent viscosities are determined. During the test, the temperature of the liquid is kept constant. According to an embodiment, the liquid suspension composition has a viscosity at 25° C. of 150 cps to 2000 cps which makes it pourable. According to an embodiment, the liquid suspension composition has a viscosity at 25° C. of 200 cps to 1000 cps.

According to an embodiment, the liquid suspension composition has a viscosity at 25° C. of less than 2000 cps. According to an embodiment, the liquid suspension composition has a viscosity at 25° C. of less than 1000 cps. Too viscous and highly concentrated composition tends to form a cake making it unpourable and thus is undesirable.

According to an embodiment, the liquid suspension composition of the invention is easily pourable. The pourability is the measure of the percent of residue.

According to an embodiment, the pourability of the composition is determined as per CIPAC MT-148.1 by allowing the composition to stand for 24 hours and the amount remaining in the container after a standardized pouring procedure is determined. The container is rinsed and the amount remaining is determined and the maximum rinsed residue in percent is calculated. According to a further embodiment, the pourability of the liquid suspension composition is less than 5% rinsed residue. According to a further embodiment, the pourability of the liquid suspension composition is preferably less than 2.5% rinsed residue.

According to an embodiment, the spontaneity of dispersion is measured as per CIP AC MT 160. It involves preparing 250 ml of a mixture of formulation and water, mixed with only one inversion of the measuring cylinder. After standing under defined conditions the top nine-tenths is removed, and the remaining tenth assayed chemically, gravimetrically or by solvent extraction. The spontaneity of dispersion is readily calculated.

According to an embodiment, the liquid suspension composition of the invention has a spontaneity of dispersion of at least 50%. According to an embodiment, the liquid suspension composition of the invention has a spontaneity of dispersion of at least 60%. According to an embodiment, the liquid suspension composition of the invention has a spontaneity of dispersion of at least 70%. According to an embodiment, the liquid suspension composition of the invention has a spontaneity of dispersion of at least 80%.

According to an embodiment, the composition of the present invention demonstrates superior stability towards heat, light, temperature and caking. According to an embodiment, the stability exhibited by the composition is at least 3 years. According to a further embodiment, the stability exhibited by the composition is at least 2 years. According to a further embodiment, the stability exhibited by the composition is at least 1 year. According to a further embodiment, the stability exhibited by the composition is at least 6 months.

According to an embodiment, the crop nutrition composition in the form of water dispersible granules has hardness of less than 4 Newtons. According to further embodiment, the crop nutrition composition in the form of water dispersible granules has hardness of less than 3 Newtons. According to further embodiment, the crop nutrition composition in the form of water dispersible granules has hardness of less than 2 Newtons. According to further embodiment, the crop nutrition composition in the form of water dispersible granules has hardness of less than 1 Newtons.

More preferably, the crop nutrition composition in the form of water dispersible granules has a nil hardness. The reference to nil hardness is indicative of the fact that the hardness of the granules cannot be measured by the hardness measuring apparatus. The hardness exhibited by the granules can be estimated by hardness testers such as the ones provided by Vinsyst Portable Table Hardness Tester VTHT series.

The water disintegrable granular composition is formulated in a manner such that it is imparted with sufficient hardness which prevents the granules from crumbling during storage and transportation. The hardness exhibited by the granules is estimated by hardness testers such as the ones provided by Monsanto, Sotax, Erweka in accordance with the standard methods described in pharmacopoeias such as United States Pharmacopoeia section <1217>. According to an embodiment, the hardness exhibited by the water disintegrable granules of the invention is at least 5 Newton. According to an embodiment, the hardness exhibited by the water disintegrable granules of the invention is at least 10 Newton. According to an embodiment, the hardness exhibited by the water disintegrable granules of the invention is at least 25 Newton. According to an embodiment, the hardness exhibited by the water disintegrable granules of the invention is at least 30 Newton.

Dispersibility of the crop nutrition and fortification composition in the form of water dispersible granules is a measure of percent dispersion. Dispersibility of the granular composition of the present application, can be determined as per the standard CIPAC test, MT 174. According to an embodiment, the composition in the form of water dispersible granules has a dispersibility of at least 50%. According to an embodiment, the composition in the form of water dispersible granules has a dispersibility of at least 70%. According to an embodiment, the composition in the form of water dispersible granules has a dispersibility of at least 70%.

According to an embodiment, the composition of the present invention in the form of water dispersible granules demonstrates superior stability in terms of dispersibility under accelerated storage condition (ATS). According to an embodiment, the crop nutrition and fortification composition in the form of water dispersible granules demonstrates a dispersibility of more than 40% under ATS. According to an embodiment, the crop nutrition and fortification composition in the form of water dispersible granules demonstrates a dispersibility of more than 60% under ATS. According to an embodiment, the crop nutrition and fortification composition in the form of water dispersible granules demonstrates a dispersibility of more than 80% under ATS.

According to an embodiment, the crop nutrition and fortification composition in the form of water dispersible granules exhibits almost instantaneous dispersion thus making the nutrients readily available to the crops.

According to an embodiment, the crop nutrition and fortification composition in the form of water disintegrable granules has a percentage disintegration value of more than 30%. According to an embodiment, the crop nutrition and fortification composition in the form of water disintegrable granules has a percentage disintegration value of more than 50%. According to an embodiment, the crop nutrition and fortification composition in the form of water disintegrable granules has a percentage disintegration value of more than 70%. According to an embodiment, the crop nutrition and fortification composition in the form of water disintegrable granules has a percentage disintegration value of more than 90%.

### Disintegration Method:

One gm of sample is mixed in 100 ml water at 300 rpm and the solution is passed through a 150-micron sieve, and washed with water for 10 minutes, the residue obtained is dried and weighed, material passing through the sieve is calculated as % disintegration.

According to another embodiment, the solid bio-pesticidal composition in the form of water disintegrable granules makes the nutrients available instantaneously and also over a longer period which may extend throughout the crop cycle, providing an immediate and sustained release of nutrients eventually strengthening and protecting the crop at each and every stage of the crop cycle.

According to an embodiment, the crop nutrition and fortification composition in the form of water disintegrable granules makes the nutrients available instantaneously and also over a longer period which may extend throughout the crop cycle, providing an immediate and sustained release of nutrients eventually strengthening and protecting the crop at each and every stage of the crop cycle.

According to an embodiment, the crop nutrition and fortification in the form of water dispersible granules or liquid suspension exhibits good suspensibility.

Suspensibility is defined as the amount of nutrient suspended after a given time in a column of liquid, of stated height, expressed as a percentage of the amount of nutrient in the original suspension. The test for suspensibility is done as per the CIPAC Handbook, “MT 184 Test for Suspensibility”.

According to an embodiment, the composition of the crop nutrition and fortification composition of the invention in the form of water dispersible granules or liquid suspension has a suspensibility of at least 50%. According to an embodiment, the composition of the crop nutrition and fortification composition of the invention in the form of water dispersible granules or liquid suspension has a suspensibility of at least 70%. According to an embodiment, the composition of the crop nutrition and fortification composition of the invention in the form of water dispersible granules or liquid suspension has a suspensibility of at least 90%.

According to an embodiment, the composition of the present invention in the form of water dispersible granules or liquid suspension demonstrates superior stability in terms of suspensibility under accelerated storage condition (ATS). According to an embodiment, the crop nutrition and fortification composition in the form of water dispersible granules or liquid suspension demonstrates a suspensibility of more than 40% under ATS. According to an embodiment, the crop nutrition and fortification composition in the form of water dispersible granules or liquid suspension demonstrates a suspensibility of more than 60% under ATS. According to an embodiment, the crop nutrition and fortification composition in the form of water dispersible granules or liquid suspension demonstrates a suspensibility of more than 80% under ATS.

Attrition resistance determines the resistance of a granular material to wear. The water disintegrable granular composition has a good attrition resistance. The Samples can be tested for attrition as per the CIPAC Handbook specified test, “MT 178-Attrition resistance of granules”. According to an embodiment, the attrition resistance of the water disintegrable granular composition is at least 50%. According to an embodiment, the attrition resistance of the water disintegrable granular composition is at least 60%. According to an embodiment, the attrition resistance of the water disintegrable granular composition is at least 70%. According to an embodiment, the attrition resistance of the water disintegrable granular composition is at least 80%. According to an embodiment, the attrition resistance of the water disintegrable granular composition is at least 90%. According to an embodiment, the attrition resistance of the water disintegrable granular composition is at least 99%.

Surprisingly, the inventors have also determined that the crop nutrition and fortification composition in the form of water dispersible granules display superior efficacy even when applied at reduced dosages of applications as compared to prior known composition.

According to an embodiment, the invention relates to a process for preparing a crop nutrition and fortification composition, in the form of water dispersible granules or water disintegrable granules or liquid suspension wherein the composition comprises an effective amounts of elemental sulphur; one or more of water insoluble or water soluble magnesium salts or derivatives or mixtures thereof; one or more of water insoluble or water soluble potassium fertilizers or salts or derivatives or mixtures thereof; one or more of water insoluble or water soluble iron salts or derivatives or mixtures thereof; one or more of water insoluble or water soluble zinc salts or derivatives or mixtures thereof and one or more excipients, wherein the composition comprises particles in the size range of 0.1 to 50 microns; and wherein elemental sulphur content is in the range of 5% to 90% by weight; elemental potassium content is in the range 0.1% to 40% by weight; elemental magnesium content is in the range of 0.1% to 40% by weight; elemental iron content is in the range of 0.1% to 45% by weight; and elemental zinc content is in the range of 0.1% to 45% by the weight of the total composition and wherein the compositions comprise particles in a size range of 0.1 micron to 50 microns.

According to an embodiment, the invention relates to a process wherein the composition in the form of water dispersible granules or water disintegrable granules comprise water soluble salts or derivatives or mixtures not exceeding 80% by the weight of the total composition.

According to an embodiment, the invention relates to a process wherein the composition in the form of liquid suspension comprises water soluble salts or derivatives or mixtures not exceeding 50% by the weight of the total composition.

According to another embodiment, the crop nutrition and fortification composition in the form of water dispersible granules or water disintegrable granules, is made by various techniques such as spray drying, fluidized bed granulation, pan granulation, pin agglomerator, spheronizer, freeze drying etc. The granules can also be extruded through the extruder to obtain the extruded granules.

According to an embodiment, the process of preparing a water dispersible granular crop nutrition and fortification composition involves milling a blend comprising effective amounts of elemental sulphur; one or more of water insoluble or water soluble magnesium salts, or derivatives or mixtures thereof; one or more of water insoluble or water soluble potassium fertilizers, or salts or derivatives or mixtures thereof; one or more of water insoluble or water soluble iron salts, or derivatives or mixtures thereof; one or more of water insoluble or water soluble zinc salts, or derivatives or mixtures thereof and one or more excipients, to obtain a slurry or a wet mix with particles in the size range of 0.1 to 30 microns. The wet mix obtained is then dried, for instance in a spray dryer, fluid bed dryer or any suitable granulating equipment, followed by sieving to remove the undersized and oversized granules to obtain water dispersible granules in the size range of 0.05 mm-4.00 mm, if required. The granules obtained from the granulator can also be dried in open air or air-dried, to remove any residual moisture, if any. The water dispersible granules obtained have an elemental sulphur content in the range of 5% to 90% by weight; elemental potassium content is in the range 0.1% to 40% by weight; elemental magnesium content is in the range of 0.1% to 40% by weight; elemental iron content is in the range of 0.1% to 45% by weight; and elemental zinc content is in the range of 0.1% to 45% by the weight of the total composition.

According to another embodiment, the crop nutrition and fortification composition in the form of water dispersible granules are also be made by dry milling effective amounts of elemental sulphur; one or more of water insoluble or water soluble magnesium salts, or derivatives or mixtures thereof; one or more of water insoluble or water soluble potassium fertilizers or salts, or derivatives or mixtures thereof; one or more of water insoluble or water soluble iron salts, or derivatives or mixtures thereof; one or more of water insoluble or water soluble zinc salts, or derivatives or mixtures thereof and one or more excipients in an air mill or a jet mill to obtain a mixture with fine particle size in the range of 0.1 micron to 30 microns. Water is added to the dry powder and the mixture is blended to obtain a dough or a paste, which is then extruded through an extruder and the resultant extrudates are dried by suitable means such as air drying, fluid bed dryer and tray dryer, followed by sieving to remove the under sized and oversized granules to obtain the granules in the size range of 0.05-3.0 mm.

According to another embodiment, the invention further relates to the process for preparing the water disintegrable granules which involves milling a blend comprising an effective amounts of elemental sulphur; one or more of water insoluble or water soluble magnesium salts, derivatives or mixtures thereof; one or more of water insoluble or water soluble potassium fertilizers, or salts or derivatives or mixtures thereof; one or more of water insoluble or water soluble iron salts, derivatives or mixtures thereof; one or more of water insoluble or water soluble zinc salts, derivatives or mixtures thereof and one or more excipients, to obtain slurry or a wet mix, wherein the particles are in the size range of 0.1 micron to 50 microns. The wet mix obtained is then dried, for instance in a spray dryer, fluid bed dryer or any suitable granulating equipment, followed by sieving to remove the undersized and oversized granules to obtain a dried mix. Water is added to the dried mix and blended to obtain a dough or paste, which is then extruded through an extruder to obtain the extruded granules in a size range of 0.025 mm to 6 mm. Alternatively, the wet mix or dried mix obtained, is agglomerated in an agglomerator to obtain spheronised granular composition in a size range of 0.025 mm to 6 mm. The water disintegrable granules obtained have an elemental sulphur content in the range of 5% to 90% by weight; elemental potassium content is in the range 0.1% to 40% by weight; elemental magnesium content is in the range of 0.1% to 40% by weight; elemental iron content is in the range of 0.1% to 45% by weight; and elemental zinc content is in the range of 0.1% to 45% by the weight of the total composition.

The agglomerator can include various equipments such as a disc pelletizer or pan granulator, pin agglomerator, spheronizer, or combinations thereof.

According to an embodiment, the invention further relates to the process for preparing the water disintegrable granules which involves milling a blend comprising an effective amounts of elemental sulphur; one or more of water insoluble or water soluble magnesium salts, derivatives or mixtures thereof; one or more of water insoluble or water soluble potassium fertilizers, or salts or derivatives or mixtures thereof; one or more of water insoluble or water soluble iron salts, derivatives or mixtures thereof; one or more of water insoluble or water soluble zinc salts, derivatives or mixtures thereof and one or more excipients, to obtain dry mix, wherein the particles are in the size range of 0.1 micron to 50 microns. Water is introduced into the dry mix and then extruded to large extruders to form water disintegrable granules of 0.05 mm to 6 mm.

According to an embodiment, the process of preparation of the crop nutrition and fortification composition in the form of a liquid suspension, comprising: homogenizing effective amounts of elemental sulphur; one or more of water insoluble or water soluble magnesium salts, or derivatives or mixtures thereof; one or more of water insoluble or water soluble potassium fertilizers; or salts or derivatives or mixtures thereof; one or more of water insoluble or water soluble iron salts, or derivatives or mixtures thereof; one or more of water insoluble or water soluble zinc salts, or derivatives or mixtures thereof and at least one agrochemically acceptable excipient, in a liquid vehicle to obtain a suspension, wherein the liquid suspension comprises elemental sulphur in the range of 5% to 60% by weight; elemental potassium content in the range 0.1% to 20% by weight; elemental magnesium content is in the range of 0.1% to 30% by weight; elemental iron content is in the range of 0.1% to 30% by weight; and elemental zinc content is in the range of 0.1% to 40% by the weight of the total composition. The process further involves wet milling the suspension to obtain a composition with a particle size range of 0.1 micron to 30 microns. According to an embodiment, the composition in the form of liquid suspension comprises water soluble salts or derivatives or mixtures not exceeding 50% by the weight of the total composition.

According to an embodiment, the invention further relates to the use of the crop nutrition or fortification composition as at least one of a nutrient composition, a crop strengthener composition, a soil conditioner composition, crop fortification composition, crop protection and a yield enhancer composition.

According to further embodiment, the present invention also relates to the method of application of the present invention, wherein the composition is applied to the seeds, seedlings, crops, a plant, plant propagation material, locus, parts thereof or to the surrounding soil.

According to an embodiment, the present invention further relates to a method of providing balanced uptake of all the nutrients, improving the crop health, improving the crop nutrition by facilitating the uptake of essential nutrients, protecting the crop, enhancing the crop yield, strengthening the plant or conditioning the soil; the method comprising treating at least one of seeds, seedling, crops, a plant, plant propagation material, locus, parts thereof or to the surrounding soil with the application of effective amounts of the present crop nutrition and fortification composition.

According to an embodiment, the invention relates to a method for treating plants and meeting their nutritional requirement by enhancing uptake of sulphur, magnesium, potassium, iron and zinc with the application of the crop nutrition composition comprising a mixture of:
i. elemental sulphur; wherein the elemental sulphur content is in the range of 5% to 90% by the weight of the total composition;
ii. one or more of water insoluble or water soluble magnesium salts or derivatives or mixtures thereof; wherein the elemental magnesium content is in the range of 0.1% to 40% by the weight of the total composition;
iii. one or more of water insoluble or water soluble potassium fertilizers or salts or derivatives or mixtures thereof; wherein the elemental potassium content is in the range 0.1% to 40% by the weight of the total composition;
iv. one or more of water insoluble or water soluble iron salts or derivatives or mixtures thereof; wherein the elemental iron content is in the range of 0.1% to 45% by the weight of the total composition;
v. one or more of water insoluble or water soluble zinc salts or derivatives or mixtures thereof; wherein the elemental zinc content is in the range of 0.1% to 45% by the weight of the total composition; and
vi. one or more excipients in the range of 0.1% to 40% by the weight of the total composition,
wherein the composition comprises of particles in the size range of 0.1-50 microns and wherein the total content of the water soluble salts or derivatives or mixtures in the composition does not exceed 80% by weight.

The present composition can be applied through a variety of methods. Methods of applying to the soil includes any suitable method, which ensures that the composition penetrates the soil, for example, nursery tray application, in furrow application, drip irrigation, sprinker irrigation, soil drenching, soil injection, or incorporation into the soil, and such other methods. The composition also can be applied in the form of a foliar spray.

The rates of application or the dosage of the composition depends on the type of crops, or the specific nutrient in the composition but is such that the nutrient, is in an effective amount to provide the desired action such as crop protection, crop yield and nutrient uptake.

It has been observed that the composition of the present invention, demonstrates enhanced, efficacious and superior behaviour in the fields. It was noted by the present inventors that the application of the composition of the present invention renders a greater and balanced uptake of not only magnesium, even in the presence of potassium, or the uptake of iron in the presence of zinc but also facilitates the uptake of all the macronutrients or micronutrients contained in the composition. Further, it was also observed that the application of the present composition, particularly in acidic soils, allows for greater assimilation of all nutrients. This results in a more balanced uptake of all nutrients, leading to a healthier plant, and higher nutrient harvest. Through the composition of the present invention, the number of applications or the amount of nutrients, fertilizers or pesticides are minimized. The composition of the invention was found to substantially reduce the emission of green house gases such as CO₂ and N₂O and is thereby highly safe to the user and to the environment. It was observed that the composition of the present invention is not only synergistic but also improves the crop yield as well as enhances the crop physiological characteristics etc. such as increased greenness and improved foliage. Thus, it has been observed that the compositions of the present invention, demonstrates enhanced, efficacious and superior behavior in the fields at a reduced dosage of application. The composition of the invention also promotes soil health.

It was also observed that the present composition provided better uptake of magnesium, zinc, iron and other micronutrients trapped into the soil, along with the macronutrients, when the particles of the composition are in the form of water dispersible granules or liquid suspension or water disintegrable granules and comprises particles in the size range of 0.1 to 50 microns.

It was further observed that the composition of the present invention, allows for the greater assimilation of all the nutrients and reduces the need for the excess application of conventional NPK fertilizers thereby eliminating the drawbacks such as nitrous oxide emissions and nitrate leaching associated with the excess use of NPK fertilizers. It was particularly observed that the crop nutrition and fortification composition of the invention not only eliminates the excessive use of NPK fertilizers being applied at higher dosages, but also meets the needs of the crops by providing a multi-nutritive solution with improved uptake of macronutrients such as potassium, magnesium, and sulphur along with other micronutrients trapped into the soil, by crops at reduced application rates, while also improving the soil health.

Further, the various advantageous properties associated with the compositions according to the invention, include but are not limited to improved stability, improved toxicological and/or ecotoxicological behaviour, improved crop characteristics including crop yields, crop qualities, improved rooting, dense foliage and characteristics and other advantages familiar to a person skilled in the art.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

### A. PREPARATION EXAMPLES

The following examples illustrate the basic methodology and versatility of the composition of the invention. The sources of magnesium, zinc, iron and water soluble or insoluble sources of potassium exemplified in the preparation examples can be replaced by any other salts or derivatives of magnesium, zinc, iron or water soluble or insoluble salts of potassium as covered in the present specification varying the claimed concentration ranges respectively. It should be noted that this invention is not limited to these exemplifications.

### I. Water Dispersible Granular Composition or Water Disintegrable Granular Compositions:

### Example No 1: Sulphur 90%+Magnesium Carbonate 1% (Elemental Mg: 0.28%)+Potassium Schoenite 1% (Elemental K: 0.19%)+Ferroso Ferric Oxide 0.2% (Elemental Fe: 0.14%)+Zinc Oxide 0.15% (Elemental Zn: 0.12%) GR

91 Parts of sulphur technical was blended with 1 part of magnesium carbonate, 1 part of potassium schoenite, 0.2 parts of ferroso ferric oxide, 0.15 parts of zinc oxide, 3 parts of kaolin, 2.35 parts of Sodium lauryl sulphate, and 1.3 parts of Sodium alkyl naphthalene sulfonate condensate in a ribbon blender to obtain a powder. The mixture was then jet milled to obtain a powder having the desired particle size.

10 gms of water was added to the above mixture to prepare a dough and the material was then granulated and dried to obtain granules having mesh size below 4 mm.

### Results:

The composition exhibited an attrition resistance of 98%, a disintegration value of 70% and a hardness of 15 N. The composition had a particle size distribution as follows: D10:7.5 microns; D50:10.5 microns and D90:13.2 microns.

### Example No 2: Sulphur 5%+Magnesium Oxide 65% (Elemental Mg: 39.197%)+Potassium Carbonate 1% (Elemental K: 0.57%)+Ferroso Ferric Oxide 12% (Elemental Fe: 8.604%)+Zinc Carbonate 8% (Elemental Zn: 4.17%) GR

5.5 Parts of sulphur technical was blended with 65 parts of magnesium oxide, 1 part of potassium carbonate, 12 parts of ferroso ferric oxide, 8 parts of zinc carbonate, 1.5 parts of clay, 3 parts of Sodium lauryl sulphate, 2 parts of sodium ligno sulphonate and 2 parts of sodium alkyl naphthalene sulfonate condensate in a ribbon blender to obtain a homogeneous powder. The mixture was then jet milled to obtain a powder having the desired particle size. 10 Gms of water was added to the above mixture to prepare a dough and the material was then granulated and dried to obtain granules having mesh size below 3 mm.

### Results:

The composition exhibited an attrition resistance of 99%, a disintegration of 75% and a hardness of 20 N. The composition had a particle size distribution as follows: D10:5.5 microns; D50:9.5 microns and D90:11.4 microns.

### Example No 3: Sulphur 45%+Magnesium Hydroxide 1% (Elemental Mg: 0.416%)+Potassium Silicate 1% (Elemental K: 0.5%)+Ferric Oxide 1% (Elemental Fe: 0.67%)+Zinc Oxide 40% (Elemental Zn: 32.1%) WG Spray Drying

46 Parts of sulphur technical was blended with 1 part of magnesium hydroxide, 1 part of potassium silicate, 1 part of ferric oxide, 40 parts of zinc oxide, 4 parts of mixture blended with salt of naphthalene sulphonic acid and phenol sulphonic acid condensation product, 4 parts of sodium ligno sulphonate, in 120 parts of water and milled to an average desired particle size. To the milled slurry under blending, 3 parts of sodium citrate was added and stirred for one hour, the material was then spray dried/fluid bed dried to obtain the water dispersible granules having a granule size below 1 mm.

### Results:

The composition exhibited a suspensibility of 90%, wet sieve retention value of 0.4% on a 75-micron sieve, had a dispersibility of 86%, attrition resistance of 94% and a wettability of less than 15 secs. The composition further demonstrated suspensibility of about 85%, dispersibility of 82% and a wettability of less than 10 secs under accelerated storage conditions. The composition had a particle size distribution as follows: D10:2.2 microns; D50:4.3 microns and D90:9.5 microns.

### Example No 4: Sulphur 5%+Magnesium Oxide 24% (Elemental Mg: 14.47%)+Potassium Silicate 1% (Elemental K: 0.5%)+Ferrous Oxide 57% (Elemental Fe: 44.3%)+Zinc Carbonate 1% (Elemental Zn: 0.52%) WG Spray Drying

5.5 Parts of sulphur technical was blended with 24 parts of magnesium oxide, 1 part of potassium silicate, 57 parts of ferrous oxide, 1 part of zinc carbonate, 3 parts of mixture blended with salt of naphthalene Sulphonic acid and phenol sulphonic acid condensation product, 5.9 parts of sodium ligno sulphonate in 120 parts of water and milled to obtain the desired particle size. To the milled slurry under blending, 2.6 parts of sodium alkyl naphthalene sulfonate condensate was added and stirred for one hour. The mixture obtained was then spray dried/fluid bed dried to obtain product having granule size below 1 mm. The composition had a particle size distribution as follows: D10:4.5 microns; D50:8.9 microns and D90:15.5 microns.

### Results:

The composition exhibited a suspensibility of 85%, wet sieve retention value of 0.5% on a 75-micron sieve, had a dispersibility of 80%, attrition resistance of 92% and a wettability of less than 10 secs. The composition further demonstrated suspensibility of about 80%, dispersibility of 75% and a wettability of less than 8 secs under accelerated storage conditions. The composition had a particle size distribution as follows: D10:3.4 microns; D50:4.9 microns and D90:10.6 microns.

### Example No 5: Sulphur 5%+Magnesium Sulphate 1% (Elemental Mg: 0.20%)+Potassium Hydroxide 55% (Elemental K: 38.32%)+Ferroso Ferric Oxide 10% (Elemental Fe: 7.17%)+Zinc Oxide 16% (Elemental Zn: 12.85%) GR

5.5 parts of sulphur technical was blended with 1 part of magnesium sulphate, 55 parts of potassium hydroxide, 10 parts of ferroso ferric oxide, 16 parts of zinc oxide, 6 parts of talc, 4.5 parts of sodium dioctyl sulfosuccinate and 2 parts of Kraft lignin polymer in a Ribbon blender to obtain homogeneous powder. The mixture was then jet milled to obtain a powder having a desired particle size. 7 Gms of water was added to the above mixture to prepare a dough and the material was then granulated and dried to obtain granules having a mesh size below 5 mm.

### Results:

The composition exhibited an attrition resistance of 98%, disintegration of 80% and exhibited a hardness of 23 N. The composition had a particle size distribution as follows: D10:8.3; D50:2.2 and D90:18.3.

### Example No 6: Sulphur 20%+Magnesium Carbonate 15% (Elemental Mg: 4.32%)+Potassium Schoenite 15% (Elemental K: 2.9%)+Ferric Oxide 15% (Elemental Fe: 10.10%)+Zinc Oxide 15% (Elemental Zn: 12.04%) WG

20.5 Parts of sulphur technical was blended with 15 parts of magnesium carbonate, 15 parts of potassium schoenite, 15 parts of ferric oxide, 15 parts of zinc oxide, 6 parts of mixture blended with salt of naphthalene sulphonic acid and phenol sulphonic acid condensation product, 9.4 parts of sodium ligno sulphonate in 120 parts of water and milled to obtain the desired particle size.

To the milled slurry under blending, 4.1 parts of sodium alkyl naphthalene sulfonate condensate was added and stirred for one hour. The mixture obtained was then spray dried/fluid bed dried to obtain the water dispersible granules having granule size below 2 mm.

### Results:

The composition exhibited a suspensibility of 95%, wet sieve retention value of 0.2% on a 75-micron sieve, had a dispersibility of 90%, attrition resistance of 90% and a wettability of less than 5 secs. The composition further demonstrated suspensibility of about 90%, dispersibility of 80% and a wettability of less than 10 secs under accelerated storage conditions. The composition had a particle size distribution as follows: D10:3.3; D50:8.5 and D90:11.2.

### Example No 7: Sulphur 70%+Magnesium Phosphate 5% (Elemental Mg: 1.387%; Elemental P: 1.16%)+Potassium Sulphate 2% (Elemental K: 0.448%)+Ferrous Oxide 5% (Elemental Fe: 3.88%)+Zinc Silicate 5% (Elemental Zn: 2.93%) WG Spray Drying

71 Parts of sulphur technical was blended with, 5 parts of magnesium phosphate, 2 parts of potassium sulphate, 5 parts of ferrous oxide, 5 parts of zinc silicate, 6.33 parts of sodium ligno sulphonate, 5.67 parts of salt of naphthalene sulphonic condensation product in 120 parts of water and milled to obtain the desired particle size. The milled slurry was then spray dried/fluid bed dried to obtain the water dispersible granules having granule size below 1.5 mm.

### Results:

The composition exhibited a suspensibility of 70%, Wet sieve retention value of 0.09% on a 75 micron sieve, dispersibility of 65%, attrition resistance of 98.4% and a wettability of less than time 5 secs. The composition further demonstrated suspensibility of 65%, dispersibility of 60% and a wettability of less than 10 secs under accelerated storage conditions. The composition had a particle size distribution as follows: D10:2.5 microns; D50:6.4 microns and D90:10.8 microns

### Example No 8: Sulphur 5%+Magnesium Phosphate 25% (Elemental Mg: 6.93%)+Potassium Schoenite 1% (Elemental K: 0.194%)+Iron Carbonate 1% (Elemental Fe: 0.48%)+Zinc Oxide 55% (Elemental Zn: 44.17%) GR

5.5 Parts of sulphur technical was blended with 25 parts of magnesium phosphate, 1 part of potassium schoenite, 1 part of iron carbonate, 55 parts of zinc oxide, 1.5 parts of sodium isopropyl naphthalene sulfonate, 2 parts of talc, 8 parts of clay and 1 parts of sodium alkyl naphthalene sulfonate condensate in a ribbon blender to a obtain homogeneous powder. The mixture was then jet milled to obtain a powder having a desired particle size range. 12 Gms of water was added to the above mixture to prepare a dough and the material was then granulated and dried to obtain water disintegrable granules having a size range below 2.5 mm.

### Results:

The composition exhibited an attrition resistance of 98% and a hardness of 21 N. The composition had a particle size distribution as follows: D10: 5.5 microns; D50:12.5 microns and D90:21 microns.

### Example No 9: Sulphur 5%+Magnesium Sulphate 30% (Elemental Mg: 6.057%)+Potassium Sulphate 20% (Elemental K: 4.487%)+Ferric Oxide 5% (Elemental Fe: 3.36%)+Zinc Sulphate 30% (Elemental Zn: 12.147%) WG

5.5 Parts of sulphur technical was blended with 30 parts of magnesium sulphate, 20 parts of potassium sulphate, 5 parts of ferric oxide, 30 parts of zinc sulphate, 3 parts of mixture blended with salt of naphthalene Sulphonic acid and phenol sulphonic acid condensation product, 3 parts of sodium ligno sulphonate in 120 parts of water and milled to obtain the desired particle size.

To the milled slurry under blending, 3.5 parts of sodium alkyl naphthalene sulfonate condensate was added and stirred for one hour. The mixture obtained was then spray dried/fluid bed dried to obtain the water dispersible granules having granule size below 2 mm.

### Results:

The composition exhibited a suspensibility of 70%, wet sieve retention value of 0.8% on a 75-micron sieve, had a dispersibility of 66%, attrition resistance of 90% and a wettability of less than 10 secs. The composition further demonstrated suspensibility of about 67%, dispersibility of 64% and a wettability of less than 15 secs under accelerated storage conditions. The composition had a particle size distribution based on the insoluble components as follows: D10:4.5 microns; D50:9. 0 microns and D90:15.5 microns.

### II. Liquid Suspension Composition:

### Example No 10: Sulphur 60%+Magnesium Silicate 0.5% (Elemental Mg: 0.12%)+Potassium Hydroxide 0.15% (Elemental K: 0.104%)+Ferric Oxide 0.1% (Elemental Fe: 0.06%)+Zinc Carbonate 0.1% (Elemental Zn: 0.05%) SC

5 Parts of sodium alkyl naphthalene sulfonate condensate and 50 parts of propylene glycol were added to 310 parts of water and homogenized by feeding them into a vessel provided with stirring facilities. 610 Parts of sulphur powder, 5 Parts of magnesium silicate, 1.5 parts of potassium hydroxide, 1 part of ferric oxide, 1 part of zinc carbonate is further added to the homogenized blend and stirred continuously for approximately 10 minutes until the total mixture was homogeneous. To the above mixture, 10 parts of solution of modified styrene-maleic acid anhydride copolymer, 0.5 parts of polydimethylsiloxane emulsion was added under continuous homogenization to obtain liquid suspension. Subsequently, the suspension obtained was passed through the wet mill to reduce the particle size. Then, 1.3 parts of xanthan gum, 1 parts of 1,2-benzisothiazolin-3-one, balance water and 0.5 parts of polydimethylsiloxane emulsion were added under continuous homogenization to obtain the liquid suspension.

### Results:

The composition had a viscosity of 850 cps and suspensibility of 92%. The pourability rinsed residue was found to be 0.82%, spontaneity of dispersion of 88%, wet sieve retention on a 75 micron sieve of 0.08%. The composition further demonstrated suspensibility of about 86%, spontaneity of dispersion of 84% under accelerated storage conditions. The composition had a particle size distribution as follows: D10:2.84 microns; D50:4.56 microns and D90:12 microns.

### Example No 11: Sulphur 5%+Magnesium Oxide 50% (Elemental Mg: 30.1%)+Potassium Carbonate 1% (Elemental K: 0.57%)+Ferroso Ferric Oxide 3% (Elemental Fe: 2.17%)+Zinc Oxide 1% (Elemental Zn: 0.803%) SC

10 Parts of Sodium alkyl naphthalene sulfonate condensate and 70 parts of propylene glycol were added to 295 parts of water and homogenized by feeding them into a vessel provided with stirring facilities. 51 Parts of sulphur powder, 500 Parts of Magnesium oxide, 10 parts of potassium carbonate, 30 parts of ferroso ferric oxide, 10 parts of zinc oxide were further added to the homogenized blend and stirred continuously for approximately 10 minutes until the total mixture was homogeneous. To the above mixture, 15 parts of solution of modified styrene-maleic acid anhydride copolymer, 0.5 parts of polydimethylsiloxane emulsion was added under continuous homogenization to obtain a liquid suspension composition. Subsequently, the suspension obtained was passed through the wet mill to reduce the particle size. Then, 1.3 parts of xanthan gum, 1 parts of 1,2-benzisothiazolin-3-one, balance water and 0.5 parts of polydimethylsiloxane emulsion was added under continuous homogenization to obtain the liquid suspension.

### Results:

The composition had a viscosity of 850 cps and a suspensibility of 92%. The pourability rinsed residue was found to be 0.82%, spontaneity of dispersion was 88% and a wet sieve retention value on a 75 micron sieve of 0.08%. The composition further demonstrated a suspensibility of about 88% and spontaneity of dispersion of 83% under accelerated storage conditions. The composition had a particle size distribution as follows: D10:3.5 microns; D50:6.68 microns and D90:14 microns.

### Example No 12: Sulphur 5%+Magnesium Silicate 15% (Elemental Mg: 3.632%)+Potassium Carbonate 30% (Elemental K: 16.9%)+Ferric Oxide 1% (Elemental Fe: 0.67%)+Zinc Oxide 5% (Elemental Zn: 4%) SC

25 Parts of sodium alkyl naphthalene sulfonate condensate and 70 parts of ethylene glycol glycol were added to 310 parts of water and homogenized by feeding them into a vessel provided with stirring facilities. 52 Parts of sulphur powder, 150 parts of Magnesium silicate, 300 parts of potassium carbonate, 10 parts of Ferric oxide, 50 parts of zinc oxide, were further added to the homogenized blend and stirred continuously for approximately 10 minutes until the total mixture was homogeneous. To the above mixture, 18 parts of polyalkylene oxide modified heptamethyltrisiloxane, 0.5 parts of polydimethylsiloxane emulsion were added under continuous homogenization to obtain the liquid suspension. Subsequently, the suspension obtained was passed through the wet mill to reduce the particle size. Then, 1.2 parts of xanthan gum, 0.75 parts of 1,2-benzisothiazolin-3-one, balance water and 0.5 parts of polydimethylsiloxane emulsion were added under continuous homogenization to obtain the liquid suspension.

### Results:

The composition had a viscosity of 600 cps and a suspensibility of 91%. The pourability rinsed residue was found to be 0.53%. The spontaneity of dispersion was 88% and the wet sieve retention value on a 75 micron sieve was 0.07%. The composition further demonstrated suspensibility of about 88%, spontaneity of dispersion of 83% under accelerated storage conditions. The composition had a particle size distribution as follows: D10:2.75 microns, D50:8.2 microns and D90:10.5 microns.

### Example No 13: Sulphur 10%+Magnesium Phosphate 0.35% (Elemental Mg: 0.10%)+Potassium Schoenite 0.5% (Elemental K: 0.10%)+Iron Silicate 0.5% (Elemental Fe: 0.137%)+Zinc Oxide 35% (Elemental Zn: 28.11%) SC

30 Parts of alkyl polyalkylene glycol ethers and 90 parts of ethylene glycol were added to 290 parts of water and homogenized by feeding them into a vessel provided with stirring facilities. 102 Parts of sulphur powder, 3.5 parts of Magnesium phosphate, 5 parts of potassium schoenite, 5 parts of Iron silicate, 350 parts of zinc oxide were further added to the homogenized blend and stirred continuously for approximately 10 minutes until the total mixture was homogeneous. To the above mixture, 20 parts of polycarboxylate, 0.4 parts of polydimethylsiloxane emulsion were added under continuous homogenization to obtain liquid suspension. Subsequently, the suspension obtained was passed through the wet mill to reduce the particle size. Then, 2 parts of xanthan gum, 1 parts of 1,2-benzisothiazolin-3-one, balance water and 0.6 parts of polydimethylsiloxane emulsion was added under continuous homogenization to obtain the liquid suspension.

### Results:

The composition had a viscosity of 800 cps and a suspensibility of 96%. The pourability rinsed residue was found to be 0.52%, spontaneity of dispersion was 90% and wet sieve retention value on a 75 micron sieve was 0.08%. The composition further demonstrated suspensibility of about 92%, spontaneity of dispersion of 85% under accelerated storage conditions. The composition had a following particle size distribution: D10:2.11 microns; D50:4.9 microns and D90: 9.3 microns.

### Example No 14: Sulphur 5%+Magnesium Phosphate 15% (Elemental Mg: 4.16%, Elemental P: 3.5%)+Potassium Sulphate 2% (Elemental Potassium 0.448%)+Ferrous Oxide 35% (Elemental Fe: 27.2%)+Zinc Carbonate 5% (Elemental Zn: 2.60%) SC

35 Parts of alkyl polyalkylene glycol ethers and 88 parts of ethylene glycol were added to 330 parts of water and homogenized by feeding them into a vessel provided with stirring facilities. 52 Parts of Sulphur powder, 150 parts of Magnesium phosphate, 20 parts of potassium sulphate, 350 parts of ferrous oxide, 50 parts of zinc carbonate were further added to the homogenized blend and stirred continuously for approximately 10 minutes until the total mixture was homogeneous. To the above mixture, 20 parts of polycarboxylate, 0.4 parts of polydimethylsiloxane emulsion were added under continuous homogenization to obtain liquid suspension. Subsequently, the suspension obtained was passed through the wet mill to reduce the particle size. Then, 1.5 parts of xanthan gum, 1 parts of 1,2-benzisothiazolin-3-one, balance water and 0.9 parts of polydimethylsiloxane emulsion were added under continuous homogenization to obtain the liquid suspension.

### Results:

The composition had a viscosity of 900 cps and a suspensibility of 75%. The pourability rinsed residue was found to be 0.72%, spontaneity of dispersion was 70% and wet sieve retention value on a 75 micron sieve is 0.09%. The composition further demonstrated suspensibility of about 70%, spontaneity of dispersion of 65% under accelerated storage conditions. The composition had a particle size distribution as follows: D10:2.90 micron; D50:5.3 microns and D90:11. 3 microns,

### Example No 15: Sulphur 20%+Magnesium Carbonate 10% (Elemental Mg: 2.88%)+Potassium Schoenite 5% (Elemental K: 0.971%)+Ferroso Ferric Oxide 7.5% (Elemental Fe: 5.377%)+Zinc Oxide 15% (Elemental Zn: 12.04%) SC

28 Parts of alkyl polyalkylene glycol ethers and 80 parts of ethylene glycol were added to 300 parts of water and homogenized by feeding them into a vessel provided with stirring facilities. 200 Parts of sulphur powder, 100 parts of Magnesium carbonate, 50 parts of potassium shoenite, 75 parts of ferroso ferric oxide, 150 parts of zinc oxide were further added to the homogenized blend and stirred continuously for approximately 10 minutes until the total mixture was homogeneous. To the above mixture, 10 parts of polycarboxylate, 0.6 parts of polydimethylsiloxane emulsion were added under continuous homogenization to obtain liquid suspension. Subsequently, the suspension obtained was passed through the wet mill to reduce the particle size. Then, 1.5 parts of xanthan gum, 1 parts of 1,2-benzisothiazolin-3-one, balance water and 0.7 parts of polydimethylsiloxane emulsion were added under continuous homogenization to obtain the liquid suspension.

### Results:

The composition had a viscosity of 500 cps and a suspensibility of 85%. The pourability rinsed residue was found to be 0.32%, spontaneity of dispersion was 80% and wet sieve retention value on a 75 micron sieve of 0.06%. The composition further demonstrated suspensibility of about 80%, spontaneity of dispersion of 75% under accelerated storage conditions. The composition had a particle size distribution as follows: D10:2.70 micron; D50:7.3 microns and D90:19. 3 microns.

### Example No 16: Sulphur 5%+Magnesium Sulphate 15% (Elemental Mg: 3.028%)+Potassium Carbonate 30% (Elemental K: 16.9%)+Ferric Oxide 1% (Elemental Fe: 0.67%)+Zinc Sulphate 5% (Elemental Zn: 2.02%) SC

25 Parts of sodium alkyl naphthalene sulfonate condensate and 70 parts of ethylene glycol glycol were added to 310 parts of water and homogenized by feeding them into a vessel provided with stirring facilities. 52 parts of Sulphur powder, 150 parts of Magnesium sulphate, 300 parts of potassium carbonate, 10 parts of Ferric oxide, 50 parts of zinc sulphate, were further added to the homogenized blend and stirred continuously for approximately 10 minutes until the total mixture was homogeneous. To the above mixture, 18 parts of polyalkylene oxide modified heptamethyltrisiloxane, 0.5 parts of polydimethylsiloxane emulsion were added under continuous homogenization to obtain the liquid suspension. Subsequently, the suspension obtained was passed through the wet mill to reduce the particle size. Then, 1.2 parts of xanthan gum, 0.75 parts of 1,2-benzisothiazolin-3-one, balance water and 0.5 parts of polydimethylsiloxane emulsion were added under continuous homogenization to obtain the liquid suspension.

### Results:

The composition had a viscosity of 500 cps and a suspensibility of 80%. The pourability rinsed residue was found to be 0.47%. The spontaneity of dispersion was 85% and the wet sieve retention value on a 75 micron sieve is 0.04%. The composition further demonstrated suspensibility of about 75%, spontaneity of dispersion of 81% under accelerated storage conditions. The composition had a particle size distribution as follows: D10:3.78 microns, D50:9.5 microns and D90:12. 6 microns.

### Example No 17: Sulphur 5%+Magnesium Silicate 7.5% (Elemental Mg: 1.816%)+Potassium Carbonate 23.5% (Elemental K: 13.24%)+Ferric Oxide 1% (Elemental Fe: 0.67%)+Zinc Oxide 5% (Elemental Zn: 4%) Rock Phosphate 14% (Elemental P: 0.83%) SC

25 Parts of sodium alkyl naphthalene sulfonate condensate and 70 parts of ethylene glycol glycol were added to 310 parts of water and homogenized by feeding them into a vessel provided with stirring facilities. 52 Parts of sulphur powder, 75 parts of Magnesium silicate, 235 parts of potassium carbonate, 10 parts of Ferric oxide, 50 parts of zinc oxide, 140 parts of rock phosphate were further added to the homogenized blend and stirred continuously for approximately 10 minutes until the total mixture was homogeneous. To the above mixture, 18 parts of polyalkylene oxide modified heptamethyltrisiloxane, 0.5 parts of polydimethylsiloxane emulsion were added under continuous homogenization to obtain the liquid suspension. Subsequently, the suspension obtained was passed through the wet mill to reduce the particle size. Then, 1.2 parts of xanthan gum, 0.75 parts of 1,2-benzisothiazolin-3-one, balance water and 0.5 parts of polydimethylsiloxane emulsion were added under continuous homogenization to obtain the liquid suspension.

### Results:

The composition had a viscosity of 700 cps and a suspensibility of 90%. The pourability rinsed residue was found to be 0.55%. The spontaneity of dispersion was 85% and the wet sieve retention value on a 75 micron sieve was 0.05%. The composition further demonstrated suspensibility of about 80%, spontaneity of dispersion of 80% under accelerated storage conditions. The composition had a particle size distribution as follows: D10:2.85 microns, D50: 7.25 microns and D90:10.5 microns.

### B. FIELD STUDY

### Experiment 1

To study the effect of compositions of “Sulphur, Potassium with salts of Magnesium, Zinc and Iron” in commercially cultivated paddy crop, where the compositions are in the form of water dispersible granules, suspension concentrate and water disintegrable granules, and included particles in a size range as per the embodiments of the present invention, as against comparative samples which included particles of a higher size range.

### Field Experiment Methodology:

The field trials were carried out to evaluate the effect of embodiments of the composition of the present invention on yield of rice (paddy) at Koppal, Karnataka. The trial was laid out during the Kharif season in Randomized Block Design (RBD) with nine treatments including the untreated control, replicated four times. For each treatment, plot size of 40 sq.m (8 m×5 m) was maintained. The test products with prescribed dose were applied as top dressing at 15 days after transplanting of the paddy. The paddy crop in trial field was raised following good agricultural practice. The seeds of paddy variety Jaya, were used for raising the nursery and 25 days old nursery was used for transplanting the trial field in 30 cm row to row and 25 cm plant to plant spacing. The nutrient dosage applied in the field experiment is of elemental Sulphur, elemental Potassium, elemental Magnesium, elemental Zinc and elemental Iron.

Details of experiment

| | |
|---|---|
| a) Trial Location | Koppal, Karnataka |
| b) Crop | Rice (var: Jaya) |
| c) Experiment season | Kharif 2023 |
| d) Trial Design | Randomized Block Design |
| e) Replications | Four |
| f) Treatments | 9 |
| g) Plot size | 8 m × 5 m = 40 sq. m |
| h) Date of transplanting | 16 Jun. 2023 |
| i) Date of Application | 1 Jul. 2023 |
| j) Method of application | Top dressing |
| k) Date of Harvesting | 30 Sep. 2023 |

The observations on yield were recorded at the time of harvesting and mean data is presented in Table 1 to enumerate the efficacy of the compositions of “Sulphur, Potassium, Magnesium, Zinc and Iron” prepared as per the embodiment of the present invention.

TABLE 1

| | Nutrients g/acre- | | | | | Paddy | % |
|---|---|---|---|---|---|---|---|
| | (Elemental content) | | | | | Yield | increase |
| Treatment Details | S | Zn | Fe | Mg | K | (kg/ha) | in yield |
| T1-Sulphur 88% + Zinc | 6160 | 20.51 | 26.6 | 84 | 79.1 | 3820 | 20.35 |
| silicate 0.5% (El. Zn: | | | | | | | |
| 0.293%) + Ferrous oxide | | | | | | | |
| 0.5% (El. Fe: 0.38%) + | | | | | | | |
| Magnesium oxide 2% (El. | | | | | | | |
| Mg: 1.20%) + Potassium | | | | | | | |
| carbonate 2% (El. K: | | | | | | | |
| 1.13%) WG with p.s | | | | | | | |
| range of 0.1 micron to 30 | | | | | | | |
| microns @ 7000 g/acre as | | | | | | | |
| per an embodiment of the | | | | | | | |
| present invention | | | | | | | |
| T2-Sulphur 88% + Zinc | 6160 | 20.51 | 26.6 | 84 | 79.1 | 3450 | 8.69 |
| Silicate 0.5% (El. Zn: | | | | | | | |
| 0.293%) + Ferrous oxide | | | | | | | |
| 0.5 % (El. Fe: 0.38%) + | | | | | | | |
| Magnesium oxide 2% (El. | | | | | | | |
| Mg: 1.20%) + Potassium | | | | | | | |
| carbonate 2% (El. K: | | | | | | | |
| 1.13%) WG with p.s | | | | | | | |
| range of 0.1 microns to | | | | | | | |
| 100 microns @ 7000 | | | | | | | |
| g/acre | | | | | | | |
| T3-Sulphur 88% + Zinc | 6160 | 20.51 | 26.6 | 84 | 79.1 | 3350 | 5.54 |
| silicate 0.5% (El. Zn: | | | | | | | |
| 0.293%) + Ferrous oxide | | | | | | | |
| 0.5 % (El. Fe: 0.38%) + | | | | | | | |
| Magnesium oxide 2% (El. | | | | | | | |
| Mg: 1.20%) + Potassium | | | | | | | |
| carbonate 2% (El. K: | | | | | | | |
| 1.13%) WG with p.s | | | | | | | |
| range of 51 microns to | | | | | | | |
| 100 microns @ 7000 | | | | | | | |
| g/acre | | | | | | | |
| T4-Sulphur 60% + Zinc | 5400 | 9.36 | 12.87 | 26.1 | 17.1 | 3810 | 20.03 |
| carbonate 0.2% (El. Zn: | | | | | | | |
| 0.104%) + Ferroso ferric | | | | | | | |
| oxide 0.2% (El. Fe: | | | | | | | |
| 0.143%) + Magnesium | | | | | | | |
| carbonate 1% (El. Mg: | | | | | | | |
| 0.29%) + Potassium | | | | | | | |
| schoenite 1% (El. K: | | | | | | | |
| 0.19%) SC with p.s range | | | | | | | |
| of 0.1 micron to 30 | | | | | | | |
| microns @ 9000 g/acre as | | | | | | | |
| per an embodiment of the | | | | | | | |
| present invention | | | | | | | |
| T5-Sulphur 60% + Zinc | 5400 | 9.36 | 12.87 | 26.1 | 17.1 | 3425 | 7.90 |
| carbonate 0.2% (El. Zn: | | | | | | | |
| 0.104%) + Ferroso ferric | | | | | | | |
| oxide 0.2% (El. Fe: | | | | | | | |
| 0.143%) + Magnesium | | | | | | | |
| carbonate 1% (El. Mg: | | | | | | | |
| 0.29%) + Potassium | | | | | | | |
| schoenite 1% (El. K: | | | | | | | |
| 0.19%) SC with p.s range | | | | | | | |
| of 0.1 micron to 100 | | | | | | | |
| microns @ 9000 g/acre | | | | | | | |
| T6-Sulphur 60% + Zinc | 5400 | 9.36 | 12.87 | 26.1 | 17.1 | 3329 | 4.88 |
| carbonate 0.2% (El. Zn: | | | | | | | |
| 0.104%) + Ferroso ferric | | | | | | | |
| oxide 0.2% (El. Fe: | | | | | | | |
| 0.143%) + Magnesium | | | | | | | |
| carbonate 1% (El. Mg: | | | | | | | |
| 0.29%) + Potassium | | | | | | | |
| schoenite 1% (El. K: | | | | | | | |
| 0.19%) SC with p.s range | | | | | | | |
| of 51 microns to 100 | | | | | | | |
| microns @ 9000 g/acre | | | | | | | |
| T7-Sulphur 10 + Zinc | 800 | 320.8 | 269.6 | 2894.4 | 77.68 | 3725 | 17.35 |
| oxide 5% (El. Zn: 4.01%) + | | | | | | | |
| Ferric oxide 5% (El. Fe: | | | | | | | |
| 3.37%) + Magnesium | | | | | | | |
| oxide 60% (El. Mg: | | | | | | | |
| 36.18%) + Potassium | | | | | | | |
| schoenite 5% (El. K: | | | | | | | |
| 0.971%) GR with p.s | | | | | | | |
| range of 0.1 micron to 50 | | | | | | | |
| microns @ 8000 g/acre as | | | | | | | |
| per an embodiment of the | | | | | | | |
| present invention | | | | | | | |
| T8-Sulphur 10% + Zinc | 800 | 320.8 | 269.6 | 2894.4 | 77.68 | 3380 | 6.49 |
| oxide 5% (El. Zn: 4.01%) + | | | | | | | |
| Ferric oxide 5% (El. Fe: | | | | | | | |
| 3.37%) + Magnesium | | | | | | | |
| oxide 60% (El. Mg: | | | | | | | |
| 36.18%) + Potassium | | | | | | | |
| schoenite 5% (El. K: | | | | | | | |
| 0.971%) GR with p.s | | | | | | | |
| range of 0.1 micron to | | | | | | | |
| 100 microns @ 8000 | | | | | | | |
| g/acre | | | | | | | |
| T9: Untreated | | | | | | 3174 | |

From the data set forth in the Table 1 above, it can be inferred that the treatment T1 with the water dispersible granular composition, as per the embodiments of the present invention with particle size in the range of 0.1 to 30 microns, demonstrated a significantly enhanced increase in the yield as compared to the treatment T2 with water dispersible granular composition having particles in the size range of 0.1 micron to 100 microns or as compared to treatment T3 with water dispersible granular composition having particles in the size range of 51 microns to 100 microns. It can be seen that the treatment T1 with composition as per the present invention show a yield increase of 20.35% over the untreated control, as compared to treatments T2 and T3, which showed a yield increase of only 8.69% and 5.54% respectively over the untreated control. Further, treatment T4 with the liquid suspension composition, as per the present invention with particle size in the range of 0.1 to 30 microns, demonstrated a significantly enhanced increase in the yield of 20.03% as compared to the treatment T5 and T6 having higher particle size ranges, which showed a yield increase of only 7.90% and 4.88% respectively over the untreated control. Further, treatment T7 with the water disintegrable granular composition, as per the embodiments of the present invention with particle size in the range of 0.1 to 50 microns showed a yield increase in paddy of 17.35% as against treatment T8 with a composition having higher particle size range which showed a yield increase of only 6.49% over the untreated control. The results are all the more surprising as the nutrient dosage in each of the comparative treatments are the same.

TABLE 1A

| | | | | | | | | % |
|---|---|---|---|---|---|---|---|---|
| | | | | | Plant | % | No. of | increase |
| | Nutrient concentration | | | | height | increase | tillers | in |
| | (mg/1 Kg of seeds) | | | | in cms | in plant | per hill | no. of |
| Treatment Details | Mg | Zn | Fe | K | (60 DAA) | height | (60 DAA) | tillers |
| T1-Sulphur 88% + | 144 | 145 | 157 | 134 | 75.8 | 24.46 | 26.2 | 23.58 |
| Zinc silicate 0.5% | | | | | | | | |
| (El. Zn: 0.293%) + | | | | | | | | |
| Ferrous oxide 0.5% | | | | | | | | |
| (El. Fe: 0.38%) + | | | | | | | | |
| Magnesium | | | | | | | | |
| oxide 2% (El. Mg: | | | | | | | | |
| 1.20%) + | | | | | | | | |
| Potassium | | | | | | | | |
| carbonate 2% (El. | | | | | | | | |
| K: 1.13%) WG | | | | | | | | |
| with p.s range of | | | | | | | | |
| 0.1 micron to 30 | | | | | | | | |
| microns @ 7000 | | | | | | | | |
| g/acre as per an | | | | | | | | |
| embodiment of | | | | | | | | |
| the present | | | | | | | | |
| invention | | | | | | | | |
| T2-Sulphur 88% + | 123 | 121 | 132 | 122 | 69.9 | 14.77 | 24.1 | 13.67 |
| Zinc Silicate | | | | | | | | |
| 0.5% (El. Zn: | | | | | | | | |
| 0.293%) + | | | | | | | | |
| Ferrous oxide 0.5% | | | | | | | | |
| (El. Fe: 0.38%) + | | | | | | | | |
| Magnesium | | | | | | | | |
| oxide 2% (El. Mg: | | | | | | | | |
| 1.20%) + | | | | | | | | |
| Potassium | | | | | | | | |
| carbonate 2% (El. | | | | | | | | |
| K: 1.13%) WG | | | | | | | | |
| with p.s range of | | | | | | | | |
| 0.1 microns to 100 | | | | | | | | |
| microns @ 7000 | | | | | | | | |
| g/acre | | | | | | | | |
| T3-Sulphur 88% + | 112 | 114 | 123 | 111 | 66.7 | 9.52 | 22.7 | 7.07 |
| Zinc silicate | | | | | | | | |
| 0.5% (El. Zn: | | | | | | | | |
| 0.293%) + | | | | | | | | |
| Ferrous oxide 0.5% | | | | | | | | |
| (El. Fe: 0.38%) + | | | | | | | | |
| Magnesium | | | | | | | | |
| oxide 2% (El. Mg: | | | | | | | | |
| 1.20%) + | | | | | | | | |
| Potassium | | | | | | | | |
| carbonate 2% (El. | | | | | | | | |
| K: 1.13%) WG | | | | | | | | |
| with p.s range of | | | | | | | | |
| 51 microns to 100 | | | | | | | | |
| microns @ 7000 | | | | | | | | |
| g/acre | | | | | | | | |
| T4-Sulphur 60% + | 142 | 151 | 149 | 141 | 77.3 | 26.92 | 26.3 | 24.05 |
| Zinc carbonate | | | | | | | | |
| 0.2% (El. Zn: | | | | | | | | |
| 0.104%) + | | | | | | | | |
| Ferroso ferric | | | | | | | | |
| oxide 0.2% (El. | | | | | | | | |
| Fe: 0.143%) + | | | | | | | | |
| Magnesium | | | | | | | | |
| carbonate 1% (El. | | | | | | | | |
| Mg: 0.29%) + | | | | | | | | |
| Potassium | | | | | | | | |
| schoenite 1% (El. | | | | | | | | |
| K: 0.19%) SC | | | | | | | | |
| with p.s range of | | | | | | | | |
| 0.1 micron to 30 | | | | | | | | |
| microns @ 9000 | | | | | | | | |
| g/acre as per an | | | | | | | | |
| embodiment of | | | | | | | | |
| the present | | | | | | | | |
| invention | | | | | | | | |
| T5-Sulphur 60% + | 119 | 129 | 126 | 117 | 70.2 | 15.27 | 24.1 | 13.67 |
| Zinc carbonate | | | | | | | | |
| 0.2% (El. Zn: | | | | | | | | |
| 0.104%) + | | | | | | | | |
| Ferroso ferric | | | | | | | | |
| oxide 0.2% (El. | | | | | | | | |
| Fe: 0.143%) + | | | | | | | | |
| Magnesium | | | | | | | | |
| carbonate 1% (El. | | | | | | | | |
| Mg: 0.29%) + | | | | | | | | |
| Potassium | | | | | | | | |
| schoenite 1% (El. | | | | | | | | |
| K: 0.19%) SC | | | | | | | | |
| with p.s range of | | | | | | | | |
| 0.1 micron to 100 | | | | | | | | |
| microns @ 9000 | | | | | | | | |
| g/acre | | | | | | | | |
| T6-Sulphur 60% + | 110 | 120 | 116 | 106 | 67.9 | 11.49 | 23.1 | 8.96 |
| Zinc carbonate | | | | | | | | |
| 0.2% (El. Zn: | | | | | | | | |
| 0.104%) + | | | | | | | | |
| Ferroso ferric | | | | | | | | |
| oxide 0.2% (El. | | | | | | | | |
| Fe: 0.143%) + | | | | | | | | |
| Magnesium | | | | | | | | |
| carbonate 1% (El. | | | | | | | | |
| Mg: 0.29%) + | | | | | | | | |
| Potassium | | | | | | | | |
| schoenite 1% (El. | | | | | | | | |
| K: 0.19%) SC | | | | | | | | |
| with p.s range of | | | | | | | | |
| 51 microns to 100 | | | | | | | | |
| microns @ 9000 | | | | | | | | |
| g/acre | | | | | | | | |
| T7-Sulphur 10 + | 139 | 153 | 150 | 140 | 76.4 | 25.45 | 24.9 | 17.45 |
| Zinc oxide 5% | | | | | | | | |
| (El. Zn: 4.01%) + | | | | | | | | |
| Ferric oxide 5% | | | | | | | | |
| (El. Fe: 3.37%) + | | | | | | | | |
| Magnesium oxide | | | | | | | | |
| 60% (El. Mg: | | | | | | | | |
| 36.18%) + | | | | | | | | |
| Potassium | | | | | | | | |
| schoenite 5% (El. | | | | | | | | |
| K: 0.971%) GR | | | | | | | | |
| with p.s range of | | | | | | | | |
| 0.1 micron to 50 | | | | | | | | |
| microns @ 8000 | | | | | | | | |
| g/acre as per an | | | | | | | | |
| embodiment of | | | | | | | | |
| the present | | | | | | | | |
| invention | | | | | | | | |
| T8-Sulphur 10% + | 116 | 130 | 128 | 118 | 67.1 | 10.18 | 22.4 | 5.66 |
| Zinc oxide 5% | | | | | | | | |
| (El. Zn: 4.01%) + | | | | | | | | |
| Ferric oxide 5% | | | | | | | | |
| (El. Fe: 3.37%) + | | | | | | | | |
| Magnesium oxide | | | | | | | | |
| 60% (El. Mg: | | | | | | | | |
| 36.18%) + | | | | | | | | |
| Potassium | | | | | | | | |
| schoenite 5% (El. | | | | | | | | |
| K: 0.971%) GR | | | | | | | | |
| with p.s range of | | | | | | | | |
| 0.1 micron to 100 | | | | | | | | |
| microns @ 8000 | | | | | | | | |
| g/acre | | | | | | | | |
| T9: Untreated | 104 | 118 | 115 | 105 | 60.9 | — | 21.2 | — |

From the data set forth in the Table 1A above, it can be inferred that the compositions T1, T4 and T7 with water dispersible granules, liquid suspension and water disintegrable granular compositions with particle size ranges as per the embodiments of the present invention, demonstrated a significantly enhanced increase in the rice plant height at 60 DAA as well as a notable increase in the number of tillers at 60 DAA as compared to the treatments T2, T3, T5, T6 and T8 with compositions having higher particle size ranges. It can be seen that the treatment T1 with composition as per the present invention show an increased plant height of 24.46% over the untreated control as compared to Treatment T2 or T3, which showed an increase of only 14.77% and 9.52% over the untreated control. Further, Treatments T4 and T7 with compositions as per the present invention showed an increase in the plant height of 26.92% and 25.45%, respectively at 60 DAA over the untreated control as compared to treatments T5, T6 and T8 with compositions having higher particle size ranges which showed a height increase of only 15.27%, 11.49% and 10.18% respectively, over the untreated control. Furthermore, treatments T1, T4 and T7 with compositions as per the present invention showed a 23.58%, 24.05% and 17.45% increase, respectively, in the number of tillers over the untreated control, as compared to treatments T2, T3, T5, T6 and T8 with compositions having a higher particle size ranges.

It can be further observed from the table 1A above, that the composition with particle size ranges as per the embodiment of the present invention showed a significant increase in the seed nutrient content of Potassium, Zinc, Iron and Magnesium in rice grains, as compared to comparative samples with higher particle size ranges. The surprising results are observed despite the nutrient dosage in each of the comparative treatment being the same.

### Experiment No. 2

To study the effect of the compositions comprising “sulphur, potassium, magnesium, zinc and iron, where the compositions were in the form of water disintegrable granules and liquid suspension, in commercially cultivated tomato crop, with comparative samples where each comparative sample did not include either of sulphur, zinc, iron, magnesium and potassium:

The trial was laid out in Pimpalgaon, Nashik, Maharashtra during Kharif season in Randomized Block Design (RBD) with eight treatments including untreated control, replicated four times. For each treatment, plot size of 40 sq. m (8 m×5 m) was maintained. The compositions evaluated include sulphur, potassium magnesium, zinc and iron, as per the present invention along with the comparative samples. The tomato crop in the trial field was raised following good agricultural practices. The seeds of Tomato, HS 101 variety, were used for the study and planted in 120 cm row to row and 45 cm plant to plant spacing. The details of the experiment are as follows:

Details of experiment

| | |
|---|---|
| a) Trial Location | Pimpalgaon, Nashik, Maharashtra |
| b) Crop | Tomato (variety HS 101) |
| c) Experiment season | Kharif 2023 |
| d) Trial Design | Randomized Block Design |
| e) Replications | Four |
| f) Treatments | Eight |
| g) Plot size | 8 m × 5 m = 40 sq. m |
| h) Date of Application | 10 Jul. 2022 |
| i) Method of application | Bend/side placement |
| j) Date of transplanting | 10 Jul. 2022 |
| k) Date of Pickings | 23 Oct. 2022, 1 Nov. 2022, 8 Nov. 2022 |

The observations on fruit setting were carried out by tagging newly opened blossoms once a week, and counting the number of tagged blossoms which set fruits one week later. The fruits were harvested six times and weighed each time.

The observations were recorded in the Table below:

TABLE 2

| | Nutrients g/acre - | | | | | | % |
|---|---|---|---|---|---|---|---|
| | (Elemental content) | | | | | Yield | increase |
| Treatment Details | S | Zn | Fe | Mg | K | (Kg/ha) | in yield |
| T1: Sulphur 15% + Zinc | 1200 | 2569.6 | 460 | 482.4 | 233.04 | 24185 | 15.44 |
| oxide 40% (*32.12%) + | | | | | | | |
| Ferroso ferric oxide 8% | | | | | | | |
| (*5.75%) + Magnesium | | | | | | | |
| oxide 10% (*6.03%) + | | | | | | | |
| Potassium shoenite 15% | | | | | | | |
| (*2.913) GR with p.s range | | | | | | | |
| of 0.1 to 50 microns @ 8000 | | | | | | | |
| g/acre as per the | | | | | | | |
| embodiment of the present | | | | | | | |
| invention | | | | | | | |
| T2: Zinc oxide 40% | — | 2569.6 | 460 | 482.4 | 233.04 | 22198 | 5.95 |
| (*32.12%) + Ferroso ferric | | | | | | | |
| oxide 8% (*5.75%) + | | | | | | | |
| Magnesium oxide 10% | | | | | | | |
| (*6.03%) + Potassium | | | | | | | |
| shoenite 15% (*2.913) GR | | | | | | | |
| with p.s range of 0.1 to 50 | | | | | | | |
| microns @ 8000 g/acre | | | | | | | |
| T3: Sulphur 15% + Ferroso | 1200 | — | 460 | 482.4 | 233.04 | 22357 | 6.72 |
| ferric oxide 8% (*5.75%) + | | | | | | | |
| Magnesium oxide 10% | | | | | | | |
| (*6.03%) + Potassium | | | | | | | |
| shoenite 15% (*2.913) GR | | | | | | | |
| with p.s range of 0.1 to 50 | | | | | | | |
| microns @ 8000 g/acre | | | | | | | |
| T4: Sulphur 15% + Zinc | 1200 | 2569.6 | — | 482.4 | 233.04 | 22241 | 6.16 |
| oxide 40% (*32.12%) + | | | | | | | |
| Magnesium oxide 10% | | | | | | | |
| (*6.03%) + Potassium | | | | | | | |
| shoenite 15% (*2.913) GR | | | | | | | |
| with p.s range of 0.1 to 50 | | | | | | | |
| microns @ 8000 g/acre | | | | | | | |
| T5: Sulphur 10% + Zinc | 1600 | 333.6 | 4352 | 675.2 | 217.44 | 24110 | 15.08 |
| carbonate 4% (*2.085%) + | | | | | | | |
| Ferrous oxide 35% | | | | | | | |
| (*27.20%) + Magnesium | | | | | | | |
| oxide 7% (*4.22%) + | | | | | | | |
| Potassium shoenite 7% | | | | | | | |
| (*1.359) SC with p.s range | | | | | | | |
| of 0.1 to 30 microns @ | | | | | | | |
| 16000 g/acre as per an | | | | | | | |
| embodiment of the present | | | | | | | |
| invention | | | | | | | |
| T6: Sulphur 10% + Zinc | 1600 | 333.6 | 4352 | — | 217.44 | 22436 | 7.09 |
| carbonate 4% (*2.085%) + | | | | | | | |
| Ferrous oxide 35% | | | | | | | |
| (*27.20%) + Potassium | | | | | | | |
| shoenite 7% (*1.359) SC | | | | | | | |
| with p.s range of 0.1 to 30 | | | | | | | |
| microns @ 16000 gacre | | | | | | | |
| T7: Sulphur 10% + Zinc | 1600 | 333.6 | 4352 | 675.2 | — | 22145 | 5.70 |
| carbonate 4% (*2.085%) + | | | | | | | |
| Ferrous oxide 35% | | | | | | | |
| (*27.20%) + Magnesium | | | | | | | |
| oxide 7% (*1.359%) SC | | | | | | | |
| with p.s range of 0.1 to 30 | | | | | | | |
| microns @ 16000 g/acre | | | | | | | |
| T8: Untreated | — | — | — | — | — | 20950 | |

*Elemental nutrient content

From the data set forth in the table 2 above, it can be noted that the composition T1 with the water disintegrable granular composition (GR), as per the embodiments of the present invention demonstrated a significantly enhanced increase in the tomato yield as compared to treatment T2 with the comparative sample which excludes elemental sulphur or treatment T3 which does not include any zinc salt and treatment T4 which excludes the iron salt. It is observed that the treatment T1 showed a yield increase of 15.44% over the untreated control, as compared to Treatments T2, T3 and T4 which only showed a yield increase of 5.96%, 6.72% and 6.16%, respectively, over the untreated control. Furthermore, Treatment T5 with the liquid suspension composition as per the present invention showed an enhanced yield increase of 15.08% as compared to the treatments T6 which excludes the magnesium salt or Treatment T7 which excluded the potassium salt and only showed a yield increase of 7.09% and 5.70% respectively. Moreover, it was observed that the plants treated with the composition of the invention exhibited increased greenness and improved rooting.

TABLE 2A

| | Plant | | No. of | % |
|---|---|---|---|---|
| | Height | % | fruits | increase |
| | (cm) at | increase | per | in |
| | 60 | in | plant | no of |
| Treatment Details | DAA | height | (in kg) | fruits |
| T1: Sulphur 15% + Zinc oxide 40% | 88.7 | 16.86 | 27.9 | 16.73 |
| (*32.12%) + Ferroso ferric oxide 8% | | | | |
| (*5.75%) + Magnesium oxide 10% | | | | |
| (*6.03%) + Potassium shoenite 15% | | | | |
| (*2.913) GR with p.s range of 0.1 to 50 | | | | |
| microns @ 8000 g/acre as per an | | | | |
| embodiment of the present invention | | | | |
| T2: Zinc oxide 40% (*32.12%) + | 80.7 | 6.32 | 24.8 | 3.76 |
| Ferroso ferric oxide 8% (*5.75%) + | | | | |
| Magnesium oxide 10% (*6.03%) + | | | | |
| Potassium shoenite 15% (*2.913) GR | | | | |
| with p.s range of 0.1 to 50 microns @ | | | | |
| 8000 g/acre | | | | |
| T3: Sulphur 15% + Ferroso ferric oxide | 81.2 | 6.98 | 25.4 | 6.27 |
| 8% (*5.75%) + Magnesium oxide 10% | | | | |
| (*6.03%) + Potassium shoenite 15% | | | | |
| (*2.913) GR with p.s range of 0.1 to 50 | | | | |
| microns @ 8000 g/acre | | | | |
| T4: Sulphur 15% + Zinc oxide 40% | 80.9 | 6.58 | 25.1 | 5.02 |
| (*32.12%) + Magnesium oxide 10% | | | | |
| (*6.03%) + Potassium shoenite 15% | | | | |
| (*2.913) GR with p.s range of 0.1 to 50 | | | | |
| microns @ 8000 g/acre | | | | |
| T5: Sulphur 10% + Zinc carbonate 4% | 89.2 | 17.52 | 28.2 | 17.99 |
| (*2.085%) + Ferrous oxide 35% | | | | |
| (*27.20%) + Magnesium oxide 7% | | | | |
| (*4.22%) + Potassium shoenite 7% | | | | |
| (*1.359) SC with p.s range of 0.1 to 30 | | | | |
| microns @ 16000 g/acre as per an | | | | |
| embodiment of the present invention | | | | |
| T6: Sulphur 10% + Zinc carbonate 4% | 81.8 | 7.77 | 25.7 | 7.53 |
| (*2.085%) + Ferrous oxide 35% | | | | |
| (*27.20%) + Potassium shoenite 7% | | | | |
| (*1.359) SC with p.s range of 0.1 to 30 | | | | |
| microns @ 16000 g/acre | | | | |
| T7: Sulphur 10% + Zinc carbonate 4% | 82.1 | 8.16 | 25.2 | 5.43 |
| (*2.085%) + Ferrous oxide 35% | | | | |
| (*27.20%) + Magnesium oxide 7% | | | | |
| (*1.359%) SC with p.s range of 0.1 to | | | | |
| 30 microns @ 16000 g/acre | | | | |
| T8: Untreated | 75.9 | | 23.9 | |

DAA—Days After Application
*Elemental Nutrient content

It can be noted from the Table 2A above, that the treatments T1 with the water disintegrable granular composition and T5 with the liquid suspension composition, with particle sizes as per the embodiments of the present invention demonstrated a significantly enhanced increase in the tomato plant height and the number of fruits per plant as compared to treatments T2, T3, T4 or treatments T6 or T7. Treatment T2 with comparative sample excludes elemental sulphur, Treatment T3 does not include any zinc salt whereas treatments T4, T6 and T7 excludes the iron salt; magnesium salt and potassium salt respectively. Treatments T1 and T5 with compositions as per the present invention showed a plant height increase of 16.86% and 17.52% respectively over the untreated control, whereas treatments T2, T3, T4, T6 and T7 showed a plant height of only 6.32%, 6.98%, 6.58%, 7.77% and 8.16%, respectively, over the untreated control. Further, treatments T1 and T5 with compositions as per the present invention showed an increase of 16.73% and 17.99% in the number of fruits per plant respectively over the untreated control, whereas treatments T2, T3, T4, T6 and T7 showed an increase of only 3.76%, 6.27%, 5.02%, 7.53% and 5.43%, respectively, over the untreated control.

The surprising results observed in tables 2 and 2A with treatments including compositions as per the present invention, can be attributed to the presence of all the elements, i.e. sulphur, potassium and the insoluble salts of magnesium, zinc and iron in specific concentrations and formulations, with particle size as per the embodiment of the present invention and the absence of any one element i.e. sulphur, potassium or the insoluble salts of magnesium, zinc and iron was found to show a significant decrease in the tomato fruit yield and other crop characteristics.

### Experiment No 3

To assess the efficacy of different formulations comprising Sulphur, Potassium, Magnesium, Zinc and Iron, wherein the composition has a particle size as per the embodiments of the present invention applied in combination with varying dosage of RDF (120-60-60 N-P2O5-K2O/ha) and compositions which only include RDF, in maize:

### Field Experiment Methodology:

The trial was laid out during Kharif season in Randomized Block Design (RBD) with eight treatments including untreated control, replicated four times. The Maize crop in the trial field was raised following good agricultural practices.

Details of experiment

| a) Trial Location | Shimoga, Karnataka |
|---|---|
| b) Crop & Variety | DHM 103 |
| c) Experiment season | Kharif 2023 |
| d) Trial Design | Randomized Block Design |
| e) Replications | 4 |
| f) Treatment | 8 |
| g) Plot size | 6 m × 5 m = 30 sq. m |
| h) Date of sowing | 14 Jul. 2023 |
| i) Date of Application | 14 Jul. 2023 |
| j) Method of application | Soil application |
| k) Date of Harvesting | 22 Nov. 2023 |
| l) Soil pH | 6.5-7 |

The observations were recorded at the harvesting time and the mean data was presented in Table 3 to enumerate the efficacy of the compositions in the form of liquid suspension prepared as per the embodiment of the present invention.

TABLE 3

| | | | | | | | | GHG emission | |
|---|---|---|---|---|---|---|---|---|---|
| | Nutrient g/acre - | | | | | Grain | % | in Maize | |
| | (Elemental content) | | | | | Yield | increase | Kg | Kg |
| Treatment Details | S | Zn | Fe | Mg | K | (kg/ha) | in yield | CO₂ | N₂O |
| T1 - Sulphur 5% + | 1200 | 6746.4 | 465.6 | 665.8 | 678.96 | 5512 | 28.18 | 108.5 | 0.84 |
| Zinc oxide 35% (El. | | | | | | | | (83.34% | (71.72% |
| Zn: 28.11%) + | | | | | | | | reduction | reduction |
| Ferrous oxide 2.5% | | | | | | | | over T7) | over T7) |
| (El. Fe: 1.94%) + | | | | | | | | | |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first and | | | | | | | | | |
| second top dressing | | | | | | | | | |
| as per an | | | | | | | | | |
| embodiment of the | | | | | | | | | |
| present invention | | | | | | | | | |
| with 25% RDF | | | | | | | | | |
| T2 - Sulphur 5% + | 1200 | 6746.4 | 465.6 | 665.8 | 678.96 | 5598 | 30.18 | 312.23 | 1.26 |
| Zinc oxide 35% (El. | | | | | | | | | |
| Zn 28.11%) + | | | | | | | | | |
| Ferrous oxide 2.5% | | | | | | | | | |
| (El. Fe: 1.94%) + | | | | | | | | | |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first and | | | | | | | | | |
| second top dressing | | | | | | | | | |
| as per an | | | | | | | | | |
| embodiment of the | | | | | | | | | |
| present invention | | | | | | | | | |
| with 50% RDF | | | | | | | | | |
| T3 - Sulphur 5% + | 1200 | 6746.4 | 465.6 | 665.8 | 678.96 | 5640 | 31.16 | 639 | 2.72 |
| Zinc oxide 35% (El. | | | | | | | | | |
| Zn: 28.11%) + | | | | | | | | | |
| Ferrous oxide 2.5% | | | | | | | | | |
| (El. Fe: 1.94%) + | | | | | | | | | |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first and | | | | | | | | | |
| second top dressing | | | | | | | | | |
| as per an | | | | | | | | | |
| embodiment of the | | | | | | | | | |
| present invention | | | | | | | | | |
| with 100% RDF | | | | | | | | | |
| T4 - Sulphur 5% + | 400 | — | — | 221.6 | 226.32 | 4740 | 10.23 | 108.8 | 0.88 |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first and | | | | | | | | | |
| second top dressing | | | | | | | | | |
| with 25% RDF | | | | | | | | | |
| T5 - Sulphur 5% + | 400 | — | — | 221.6 | 226.32 | 4960 | 15.34 | 368.5 | 1.58 |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first nd | | | | | | | | | |
| second top dressing | | | | | | | | | |
| with 50% RDF | | | | | | | | | |
| T6 - Sulphur 5% + | 400 | — | — | 221.6 | 226.32 | 5090 | 18.37 | 645 | 2.92 |
| Magnesium | | | | | | | | | |
| phosphate 10% (El. | | | | | | | | | |
| Mg: 2.774%) + | | | | | | | | | |
| Potassium carbonate | | | | | | | | | |
| 5% (El. K: 2.829%) | | | | | | | | | |
| SC with p.s range of | | | | | | | | | |
| 0.1 to 30 microns @ | | | | | | | | | |
| 24000 g/acre applied | | | | | | | | | |
| at basal, first and | | | | | | | | | |
| second top dressing | | | | | | | | | |
| with 100% RDF | | | | | | | | | |
| T7: Traditional RDF | — | — | — | — | — | 5010 | 16.51 | 651.3 | 2.97 |
| fertilizer (120-60-60 | | | | | | | | | |
| N-P2O5-K2O) | | | | | | | | | |
| T8: Untreated | — | — | — | — | — | 4300 | | 20.5 | 0.69 |

RDF (120-60-60 N-P2O5-K2O/ha)

From the data set forth in the Table 3, it can be observed that treatment T1 is carried out with the liquid suspension composition as per the embodiment of the present invention with 25% RDF. Treatments T2 and T3 are carried out with composition as per the embodiment of the present invention in combination with 50% RDF and 100% RDF. Treatments T4, T5 and T6 are carried out with three way compositions of Sulphur, Potassium and Magnesium in varying concentrations, where Treatment T4 includes 25% RDF, Treatment T5 includes 50% RDF and Treatment T6 includes 100% RDF. Treatment T7 is carried out with RDF alone. It can be noted from the data provided in the above table that the treatment T1 with composition as per the embodiment of the present invention applied at a formulation dose of 24000 g/acre with 25% RDF showed a good increase in the yield as compared to RDF alone (treatment T7). The composition in T1 as per the present invention further showed a significant increase in yield over Treatment T4 with the three way composition of the nutrients.

It is more pertinent to note that the composition in T1 as per the embodiment of the present invention resulted in a significant reduction in N₂O and CO₂ emissions, as compared to treatment T7 thereby rendering the composition environment friendly and eliminating the hazards associated with nitrous oxide emission.

It is further pertinent to note that treatments T1 and T2 with composition as per the embodiment of the present invention when applied with 25% RDF i.e. 75% reduction in RDF and 50% reduction in RDF (conventional NPK fertilizers) respectively not only showed good yields in the maize, but at the same time exhibited a significant reduction in the green house gas emissions. For instance, treatment T1 with composition as per the present invention, with 25% inclusion of RDF showed a surprising significant reduction in CO₂ and N₂O emission, as compared to treatment T7 which only included RDF.

Further, treatments T1, T2 and T3 with compositions as per the present invention showed significant increase in yield as compared to treatments T4, T5 and T6, which includes the three way compositions of Sulphur, Potassium and Magnesium.

### Experiment No 4

To study the effect of different compositions of “Sulphur, Potassium, Magnesium, Zinc and Iron, in the form of water dispersible granules and suspension concentrate, as per the embodiment of the present invention, along with comparative samples, where one of the comparative sample does not include magnesium salt, the second sample does not include zinc and potassium, and the third sample does not include zinc, iron and potassium, wherein the trial are carried out in commercially cultivated groundnut crop:

Field trials were conducted for the evaluation of the composition of the present invention at Junagadh, Gujarat on Groundnut crop, variety JL-501. The trials were laid down in Randomized Block Design (RBD) with six treatments including untreated control, replicated four times. For each treatment, plot size of 35 sq.m (7 m×5 m) was maintained. The test nutritional compositions as per the embodiment of the invention in the form of water dispersible granules or suspension concentrate with varying concentration range and the comparative samples with the prescribed dose were applied as basal application at the time of sowing of Groundnut crop. The nutrient dosage applied in the field experiment is of elemental Sulphur, elemental potassium, elemental Magnesium, elemental Zinc and elemental Iron.

The details of the experiment are as follows:

| | |
|---|---|
| a) Trial Location | Junagadh, Gujarat |
| b) Crop | Groundnut (variety JL-501) |
| c) Experiment season | Rabi 2023 |
| d) Trial Design | Randomized Block Design |
| e) Replications | Four |
| f) Treatments | Six |
| g) Plot size | 7 m × 5 m = 35 sq. m |
| h) Date of Application | 26 Jan. 2023 |
| i) Date of sowing | 26 Jan. 2023 |
| j) Method of application | Basal |
| k) Date of Harvesting | 1 May 2023 |

TABLE 4

| | | | | | | Ground | |
|---|---|---|---|---|---|---|---|
| | | | | | | nut | |
| | Nutrients g/acre - | | | | | Kernel | % |
| | (Elemental content) | | | | | Yield | increase |
| Treatment Details | S | Mg | Zn | Fe | K | (kg/ha) | in yield |
| T1: Sulphur 20% + | 1400 | 302.4 | 842.8 | 815.5 | 593.6 | 2845 | 24.23 |
| Magnesium carbonate | | | | | | | |
| 15% + Potassium | | | | | | | |
| carbonate 15% + Ferrous | | | | | | | |
| oxide 15% + Zinc oxide | | | | | | | |
| 15% WG * (S = 20% + Mg | | | | | | | |
| 4.32% + K 8.48% + Fe | | | | | | | |
| 11.65% + Zn 12.04%)with | | | | | | | |
| p.s range of 0.1 micron to | | | | | | | |
| 30 microns @ 7000 g/acre | | | | | | | |
| as per the present | | | | | | | |
| invention | | | | | | | |
| T2: Sulphur 10%+ | 1400 | 302.4 | 842.8 | 815.5 | 593.6 | 2820 | 23.14 |
| Magnesium carbonate | | | | | | | |
| 7.5% + Potassium | | | | | | | |
| carbonate 7.5% + Ferrous | | | | | | | |
| oxide 7.5% + Zinc oxide | | | | | | | |
| 7.5% SC * (S = 10% + Mg | | | | | | | |
| 2.16% + K 4.24% + Fe | | | | | | | |
| 5.82% + Zn 6.02%)with | | | | | | | |
| p.s range of 0.1 micron to | | | | | | | |
| 30 microns @ 14000 | | | | | | | |
| g/acre as per an | | | | | | | |
| embodiment of the present | | | | | | | |
| invention | | | | | | | |
| T3: Sulphur 20% + | 1400 | — | 842.8 | 815.5 | 593.6 | 2595 | 13.31 |
| Potassium carbonate 15% + | | | | | | | |
| Ferrous oxide 15% + | | | | | | | |
| Zinc oxide 15% WG * (S = | | | | | | | |
| 20% + K 8.48% + Fe | | | | | | | |
| 11.65% + Zn 12.04%) | | | | | | | |
| with p.s range of 0.1 | | | | | | | |
| micron to 30 microns a | | | | | | | |
| 7000 g/acre | | | | | | | |
| T4: Sulphur 20% + | 1400 | 302.4 | — | 815.5 | — | 2505 | 9.38 |
| Magnesium carbonate | | | | | | | |
| 15% + Ferrous oxide 15% | | | | | | | |
| WG *(S = 20% + Mg | | | | | | | |
| 4.32% + Fe 11.65%) with | | | | | | | |
| p.s range of 0.1 micron to | | | | | | | |
| 30 microns @ 7000 g/acre | | | | | | | |
| T5: Sulphur 20% + | 1400 | — | 842.8 | — | — | 2410 | 5.24 |
| Magnesium carbonate | | | | | | | |
| 15% WG * (S = 20% + Mg | | | | | | | |
| 4.32%%) @ 7000 g/acre | | | | | | | |
| T6: Untreated | | | | | | 2290 | |

*Elemental nutrient content

From the data set forth in the Table 4, it can be observed that the treatments T1, and T2 with the compositions in the form of water dispersible granules and liquid suspensions comprising sulphur, magnesium, zinc, iron and potassium in varying concentrations, as per the embodiments of the present invention demonstrated a significantly enhanced increase in the groundnut kernel yield of 24.23% and 23.14% respectively, as compared to treatment T3 which does not include magnesium in the composition, or treatment T4 which does not include zinc and potassium in the composition or as compared to treatment T5 which does not 10 include zinc, iron and potassium in the composition. It can be seen that treatments T2, T3 and T4 only exhibited a yield increase of 13.31%, 9.38% and 5.24% respectively. Further the crops treated with the compositions as per the present invention showed increased branching and greener foliage.

TABLE 4A

| | | | Protein | |
|---|---|---|---|---|
| | Avg No. | % | content in | % |
| | of pods | increase in | 1 kg of | increase |
| | per plant | no. of | groundnut | in |
| | (at 90 | pods per | seeds (in | protein |
| Treatment Details | DAA) | plant | gms) | content |
| T1: Sulphur 20% + Magnesium | 34.4 | 26.47 | 285.7 | 26.92 |
| carbonate 15% + Potassium | | | | |
| carbonate 15% + Ferrous oxide | | | | |
| 15% + Zinc oxide 15% WG * | | | | |
| (S = 20% + Mg 4.32% + K 8.48% + | | | | |
| Fe 11.65% + Zn 12.04%)with p.s | | | | |
| range of 0.1 micron to 30 microns | | | | |
| @ 7000 g/acre as per an | | | | |
| embodiment of the present | | | | |
| invention | | | | |
| T2: Sulphur 10% + Magnesium | 34.2 | 25.73 | 284.8 | 26.52 |
| carbonate 7.5% + Potassium | | | | |
| carbonate 7.5% + Ferrous oxide | | | | |
| 7.5% + Zinc oxide 7.5% SC * | | | | |
| (S = 10% + Mg 2.16% + K 4.24% + | | | | |
| Fe 5.82% + Zn 6.02%)with p.s | | | | |
| range of 0.1 micron to 30 microns | | | | |
| @ 14000 g/acre as per an | | | | |
| embodiment of the present | | | | |
| invention | | | | |
| T3: Sulphur 20% + Potassium | 30.9 | 13.60 | 257.6 | 14.43 |
| carbonate 15% + Iron oxide | | | | |
| 15% + Zinc oxide 15% WG * | | | | |
| (S = 20% + K 8.48% + Fe 11.65% + | | | | |
| Zn 12.04%)with p.s range of | | | | |
| 0.1 micron to 30 microns @ 7000 | | | | |
| g/acre | | | | |
| T4: Sulphur 20% + Magnesium | 29.7 | 9.19 | 248.3 | 10.30 |
| carbonate 15% + Iron oxide 15% | | | | |
| WG *(S = 20% + Mg 4.32% + Fe | | | | |
| 11.65%) with p.s range of 0.1 | | | | |
| micron to 30 microns @ 7000 | | | | |
| g/acre | | | | |
| T5: Sulphur 20% + Magnesium | 28.6 | 5.14 | 237.4 | 5.46 |
| carbonate 15% WG * (S = 20% + | | | | |
| Mg 4.32%%) @ 7000 g/acre | | | | |
| T6: Untreated | 27.2 | | 225.1 | |

DAA—Days After Application
*Elemental content

It can be further noted from the Table 4A, that the treatments T1 and T2, with the compositions in the form of water dispersible granules and suspension concentrates, as per the embodiments of the present invention demonstrated an increased number of groundnut pods per plant as well as an increased protein content in groundnut as compared to the treatment T3 which does not include magnesium in the composition, or treatment T4 which does not include zinc and potassium in the composition or as compared to Treatment T5 which does not include zinc, iron and 10 potassium in the composition. It can be seen that treatments T1 and T2 showed 26.47% and 25.73% increase in the number of groundnut pods per plant over the untreated control whereas treatments T3, T4 and T5 only exhibited 13.6%, 9.19% and 5.14% increase in the number of groundnut pods, respectively. Moreover, it can be seen that the treatments T1 and T2 showed a 26.92% and 26.52% increase in the protein content in groundnut seeds as compared to the treatments T3, T4 and T5 which only showed an increase of 14.43%, 10.30% and 5.46% increase in the protein content of groundnut seed, respectively, over the untreated control.

The surprising results observed in tables 4 and 4A with treatments including compositions as per the present invention, can be attributed to the presence of all the elements, i.e. sulphur, potassium and particularly, the insoluble salts of magnesium, zinc and iron in specific concentrations and formulations, with particle size as per the embodiment of the present invention. It can be further noted from the above table that treatments T3, T4 and T5 with the four way, three way and two way combinations of nutrients, showed a drastic reduction in the yield and other parameters such as the number of groundnut pods per plant or the protein content in groundnut seeds as compared to the composition, as per the present invention which included sulphur, potassium and the salts of magnesium, zinc and iron, whereby all the five components have to be present in the specified concentrations and forms, so as to exhibit the enhancement in efficacy.

### Experiment 5

To assess the composition comprising “Sulphur, Potassium, Magnesium, Zinc and Iron, in the form of water disintegrable granules, where the composition includes particles in the size range of 0.1 micron to 50 microns, as per the present invention as compared to the comparative samples in the form of water disintegrable granules, wherein the comparative samples included either of water soluble salts zinc, iron and magnesium in a concentration exceeding 80% by weight in the form of water dispersible granules or exceeding 50% by weight in the form of liquid suspension, in soybean:

### Field Experiment Methodology:

The field trial was carried out to observe the effect of water disintegrable granules as per the invention comprising sulphur, potassium, magnesium, zinc, and iron along with the comparative samples in Soybean at Satara, Maharashtra. The trial was laid out during the Kharif season in Randomized Block Design (RBD) with three treatments including untreated control, replicated four times. For each treatment, plot size of 30 sq.m (6 m×5 m) was maintained. The test product compounds with water disintegrable granular compositions as per the present invention with varying concentration range, along with comparative compositions, with prescribed dose were applied to the soil at the time of sowing. The Soybean crop in trial field was raised following good agricultural practices.

Details of Experiment:

| | |
|---|---|
| a) Trial Location | Satara, Maharashtra |
| b) Crop & Variety | Soybean (KPS-344) |
| c) Experiment season | Kharif 2023 |
| d) Trial Design | Randomized Block Design |
| e) Replications | 4 |
| f) Treatments | 3 |
| g) Plot size | 6 m × 5 m = 30 sq. m |
| h) Date of sowing | 25 Jul. 2023 |
| i) Date of Application | 25 Jul. 2023 |
| j) Method of application | Soil application |
| k) Date of Harvesting | 28 Oct. 2023 |

The observations were recorded in the table below:

TABLE 5

| | Nutrients g/acre - | | | | | | % |
|---|---|---|---|---|---|---|---|
| | (Elemental content) | | | | | Yield | increase |
| Treatment Details | S | Zn | Fe | Mg | K | (Kg/ha) | in yield |
| T1: Sulphur 5% + Magnesium | 350 | 850.29 | 235.2 | 423.9 | 314.09 | 1950 | 16.07 |
| sulphate 30% (Elemental Mg: | | | | | | | |
| 6.057%) + Potassium | | | | | | | |
| Sulphate 20% (Elemental K: | | | | | | | |
| 4.487%) + Ferric oxide 5% | | | | | | | |
| (Elemental Fe: 3.36%) + Zinc | | | | | | | |
| sulphate 30% (Elemental Zn: | | | | | | | |
| 12.147%) WG @ 7000 g/acre | | | | | | | |
| with p.s of 0.1 to 30 microns | | | | | | | |
| as per the present invention | | | | | | | |
| with water soluble nutrient | | | | | | | |
| salt content of 80% | | | | | | | |
| T2: Sulphur 5% + Magnesium | 350 | 850.29 | 235.2 | 494.9 | 314.09 | 1810 | 7.73 |
| sulphate 35% (Elemental Mg: | | | | | | | |
| 7.07%) + Potassium Sulphate | | | | | | | |
| 20% (Elemental K: 4.487%) + | | | | | | | |
| Ferric oxide 5% (Elemental | | | | | | | |
| Fe: 3.36%) + Zinc sulphate | | | | | | | |
| 30% (Elemental Zn: | | | | | | | |
| 12.147%) WG @ 7000 g/acre | | | | | | | |
| with p.s of 0.1 to 30 microns | | | | | | | |
| and water soluble nutrient | | | | | | | |
| salt content of 85% | | | | | | | |
| T3: Untreated | — | — | — | — | — | 1680 | |

From the data set forth in the Table above, it can be seen that after the treatments with composition as per the embodiment of the present invention and the comparative sample, treatment T1 in the form of water dispersible granules as per the embodiment of the present invention with water soluble nutrient content not exceeding 80%, demonstrated a significant enhancement in the yield of soybean of 16.07% over the untreated control, as compared to the treatment T2 with a composition comprising water soluble nutrient salts in a concentration exceeding 80% by weight. It was also observed that compositions of T2, over a long period of time degraded and became hygroscopic and were not found suitable for application.

TABLE 5A
Treatment Details

| | Nutrient concentration in 1000 | | | |
|---|---|---|---|---|
| | gms of grain in ppm | | | |
| | Zn | Fe | Mg | K |
| T1: Sulphur 5% + Magnesium sulphate 30% | 132.9 | 145.7 | 138.1 | 150.5 |
| (Elemental Mg: 6.057%) + Potassium Sulphate | | | | |
| 20% (Elemental K: 4.487%) + Ferric oxide 5% | | | | |
| (Elemental Fe: 3.36%) + Zinc sulphate 30% | | | | |
| (Elemental Zn: 12.147%) WG @ 7000 g/acre | | | | |
| with p.s of 0.1 to 30 microns as per the present | | | | |
| invention with water soluble nutrients salt | | | | |
| content of 80% | | | | |
| T2: Sulphur 5% + Magnesium sulphate 35% | 118.3 | 113.1 | 92.2 | 76.2 |
| (Elemental Mg: 7.07%) + Potassium Sulphate | | | | |
| 20% (Elemental K: 4.487%) + Ferric oxide 5% | | | | |
| (Elemental Fe: 3.36%) + Zinc sulphate 30% | | | | |
| (Elemental Zn: 12.147%) WG @ 7000 g/acre | | | | |
| with p.s of 0.1 to 30 microns and water soluble | | | | |
| nutrient salt content of 85% | | | | |
| T3: Untreated | 65.2 | 82.2 | 70.5 | 45.6 |
| Initial Soil Nutrient content (in ppm) | 1020 | 980 | 1049 | 950 |

Soil nutrient content before the sowing and after the application of treatments was estimated and it was noted that the plot under treatment and observation initially had a magnesium content of 1049 ppm, zinc content of 1020 ppm, iron content of 980 ppm and potassium content of 950 ppm.

From the data set forth in the Table above, it can be seen that treatment T1 with composition in the form of water dispersible granules as per the embodiment of the present invention wherein the composition included 80% water soluble nutrient salts demonstrated a significant enhancement in the uptake of Zinc, Iron, Magnesium and Potassium from the soil, as compared to the treatment T2 where the composition included higher concentration of the water soluble nutrient salts.

### Experiment No 6

To assess the efficacy of different formulations of Sulphur, Potassium, Magnesium, Zinc and Iron, wherein the composition has a particle size as per the embodiments of the present invention as against the comparative conventional samples having higher particle size ranges, in commercially cultivated wheat crop:

### Field Experiment Methodology:

The field trial was carried out to see the effect of water dispersible granular composition or liquid suspension compositions of the present invention in wheat at Kaithal, Haryana, as compared to conventional compositions in the form of pellets. The trial was laid out during Rabi season in Randomized Block Design (RBD) with nine treatments including untreated control, replicated four times. For each treatment, plot size of 30 sq.m (6 m×5 m) was maintained. The test product compounds and their combination in water dispersible granular compositions or liquid suspension composition as per the present invention, along with the comparative samples in varying concentration ranges with prescribed dose were applied to the soil at the time of 1^{st} irrigation of wheat (25 days after sowing). The Wheat crop in trial field was raised following good agricultural practices.

Details of experiment

| | |
|---|---|
| a) Trial Location | Kaithal, Haryana |
| b) Crop | Wheat (var Sonalika) |
| c) Experiment season | Rabi 2022 |
| d) Trial Design | Randomized Block Design |
| e) Replications | Four |
| f) Treatments | Nine |
| g) Plot size | 6 m × 5 m = 30 sq. m |
| h) Date of sowing | 4 Nov. 2022 |
| i) Date of Application | 29 Nov. 2022 |
| j) Method of application | Soil application |
| k) Date of Harvesting | 18 Mar. 2023 |

TABLE 6

| | Nutrients g/acre - | | | | | | % |
|---|---|---|---|---|---|---|---|
| | (Elemental content) | | | | | Yield | increase |
| Treatment Details | S | Zn | Fe | Mn | K | (kg/ha) | in yield |
| T1: Sulphur 10% + zinc | 750 | 7.8 | 2622.75 | 21.6 | 42 | 3940 | 25.07 |
| carbonate 0.2% | | | | | | | |
| (*0.104%) + Ferrous | | | | | | | |
| oxide 45% (*34.97%) + | | | | | | | |
| Magnesium carbonate 1% | | | | | | | |
| (*0.288%) + Potassium | | | | | | | |
| carbonate 1% (*0.56%) | | | | | | | |
| GR with p.s range of 0.1 | | | | | | | |
| micron to 50 microns @ | | | | | | | |
| 7500 g/acre as per an | | | | | | | |
| embodiment of the | | | | | | | |
| present invention | | | | | | | |
| T2: Sulphur 10% + zinc | 750 | 7.8 | 2622.75 | 21.6 | 42 | 3510 | 11.42 |
| carbonate 0.2% | | | | | | | |
| (*0.104%) + Ferrous | | | | | | | |
| oxide 45% (*34.97%) + | | | | | | | |
| Magnesium carbonate 1% | | | | | | | |
| (*0.288%) + Potassium | | | | | | | |
| carbonate 1% (*0.56%) | | | | | | | |
| pellets with p.s range of | | | | | | | |
| above 75 microns @ 7500 | | | | | | | |
| g/acre | | | | | | | |
| T3: Sulphur 20% + zinc | 1500 | 21.75 | 87 | 226.1 | 2874 | 3856 | 22.41 |
| silicate 0.5% (*0.29%) + | | | | | | | |
| Ferrous oxide 1.5% | | | | | | | |
| (*1.16%) + Magnesium | | | | | | | |
| oxide 5% (*3.015%) + | | | | | | | |
| potassium hydroxide 55% | | | | | | | |
| (*38.32%) WG with p.s | | | | | | | |
| range of 0.1 to 30 microns @ | | | | | | | |
| 7500 g/acre as per an | | | | | | | |
| embodiment of the | | | | | | | |
| present invention | | | | | | | |
| T4: Sulphur 20% + zinc | 1500 | 21.75 | 87 | 226.1 | 2874 | 3410 | 8.25 |
| silicate 0.5% (*0.29%) + | | | | | | | |
| Ferrous oxide 1.5% | | | | | | | |
| (*1.16%) + Magnesium | | | | | | | |
| oxide 5% (*3.015%) + | | | | | | | |
| potassium hydroxide 55% | | | | | | | |
| (*38.32%) pellets with | | | | | | | |
| p.s range of above 75 | | | | | | | |
| microns @ 7500 g/acre | | | | | | | |
| T5: Sulphur 5% + zinc | 800 | 41.6 | 52.8 | 1448 | 2787.2 | 3720 | 18.09 |
| carbonate 0.5% (*0.26%) + | | | | | | | |
| Ferric oxide 0.5% | | | | | | | |
| (*0.33%) + Magnesium | | | | | | | |
| oxide 15% (*9.05%) + | | | | | | | |
| potassium hydroxide 25% | | | | | | | |
| (*17.42%) SC with p.s | | | | | | | |
| range of 0.1 micron to 30 | | | | | | | |
| microns @ 16000 g/acre | | | | | | | |
| as per an embodiment of | | | | | | | |
| the present invention | | | | | | | |
| T6: Sulphur 10% + zinc | 800 | 41.6 | 52.8 | 1448 | 2787.2 | 3400 | 7.94 |
| carbonate 1% (*0.52%) + | | | | | | | |
| Ferric oxide 1% (*0.66%) + + | | | | | | | |
| Magnesium oxide | | | | | | | |
| 30% (*18.1%) + | | | | | | | |
| potassium hydroxide 50% | | | | | | | |
| (*34.8%) pellets with p.s | | | | | | | |
| range of above 75 | | | | | | | |
| microns @ 8000 g/acre | | | | | | | |
| T7: Sulphur 5% + zinc | 600 | 31.2 | 15.6 | 2170 | 339.4 | 3825 | 21.42 |
| carbonate 0.5% (*0.26%) + | | | | | | | |
| Ferric oxide 0.2% | | | | | | | |
| (*0.13%) + Magnesium | | | | | | | |
| oxide 30% (*18.09%) + | | | | | | | |
| potasium carbonate 5% | | | | | | | |
| (*2.829) SC with p.s | | | | | | | |
| range of 0.1 to 30 microns | | | | | | | |
| at 12000 g/acre as per an | | | | | | | |
| embodiment of the | | | | | | | |
| present invention | | | | | | | |
| T8: Sulphur 10% + zinc | 600 | 31.22 | 15.6 | 2170 | 339.4 | 3425 | 8.73 |
| carbonate 1% (*0.52%) + | | | | | | | |
| Ferric oxide 0.4% | | | | | | | |
| (*0.26%) + Magnesium | | | | | | | |
| oxide 60% (*36.18%) + | | | | | | | |
| potasium carbonate 10% | | | | | | | |
| (*5.658) pellets with p.s | | | | | | | |
| range above 75 microns at | | | | | | | |
| 6000 g/acre | | | | | | | |
| T9: Untreated | — | — | — | — | — | 3150 | |

It can be observed from the Table 6 above, that the treatments T1, T3, T5 and T7 with the compositions in the form of water dispersible granules or liquid suspension or water disintegrable granules, with particle sizes as per the embodiments of the present invention, demonstrated a significantly enhanced increase in the yield of wheat, as compared to the treatment T2, T4, T6 and T8 with the conventional pellet composition which includes swelling clay and has a particle size range above 75 microns. It can be seen that the treatment T1, T3, T5 and T7 with compositions as per the present invention show a wheat yield increase of 25.07%, 22.41%, 18.09% and 21.42%, respectively, over the untreated control, as compared to treatments T2, T4, T6 and T8, which showed a yield increase of only 11.42%, 8.25%, 7.94% and 8.73% respectively, over the untreated control.

TABLE 6A

| | | | No. of | |
|---|---|---|---|---|
| | Plant | | tillers | |
| | height | % | at 40 | % |
| | at 60 | increase | DAA | increase |
| | DAA | in | (Avg of | in |
| | (in | plant | 10 | no. of |
| Treatment Details | cm) | height | plants) | tillers |
| T1: Sulphur 10% + zinc carbonate 0.2% | 32.1 | 23.93 | 4.5 | 18.42 |
| (*0.104%) + Ferrous oxide 45% (*34.97%) + | | | | |
| Magnesium carbonate 1% (*0.288%) + | | | | |
| Potassium carbonate 1% (*0.56%) GR with | | | | |
| p.s range of 0.1 micron to 50 microns @ 7500 | | | | |
| g/acre as per an embodiment of the the | | | | |
| present invention | | | | |
| T2: Sulphur 10% + zinc carbonate 0.2% | 28.3 | 9.26 | 4.1 | 7.894 |
| (*0.104%) + Ferrous oxide 45% (*34.97%) + | | | | |
| Magnesium carbonate 1% (*0.288%) + | | | | |
| Potassium carbonate 1% (*0.56%) pellets | | | | |
| with p.s range of above 75 microns @ 7500 | | | | |
| g/acre | | | | |
| T3: Sulphur 20% + zinc silicate 0.5% | 31.6 | 22.00 | 4.35 | 14.47 |
| (*0.29%) + Ferrous oxide 1.5% (*1.16%) + | | | | |
| Magnesium oxide 5% (*3.015%) + | | | | |
| potassium hydroxide 55% (*38.32%) WG | | | | |
| with p.s range of 0.1 to 30 microns @ 7500 | | | | |
| g/acre as per an embodiment of the present | | | | |
| invention | | | | |
| T4: Sulphur 20% + zinc silicate 0.5% | 28.7 | 10.81 | 4.02 | 5.78 |
| (*0.29%) + Ferrous oxide 1.5% (*1.16%) + | | | | |
| Magnesium oxide 5% (*3.015%) + | | | | |
| potassium hydroxide 55% (*38.32%) pellets | | | | |
| with p.s range of above 75 microns @ 7500 | | | | |
| g/acre | | | | |
| T5: Sulphur 5% + zinc carbonate 0.5% | 31.5 | 21.62 | 4.3 | 13.15 |
| (*0.26%) + Ferric oxide 0.5% (*0.33%) + | | | | |
| Magnesium oxide 15% (*9.05%) + | | | | |
| potassium hydroxide 25% (*17.42%) SC | | | | |
| with p.s range of 0.1 micron to 30 microns @ | | | | |
| 16000 g/acre as per an embodiment of the | | | | |
| present invention | | | | |
| T6: Sulphur 10% + zinc carbonate 1% | 28.3 | 9.26 | 4 | 5.26 |
| (*0.52%) + Ferric oxide 1% (*0.66%) ++ | | | | |
| Magnesium oxide 30% (*18.1%) + | | | | |
| potassium hydroxide 50% (*34.8%) pellets | | | | |
| with p.s range of above 75 microns @ 8000 | | | | |
| g/acre | | | | |
| T7: Sulphur 5% + zinc carbonate 0.5% | 31.3 | 20.84 | 4.4 | 15.78 |
| (*0.26%) + Ferric oxide 0.2% (*0.13%) + | | | | |
| Magnesium oxide 30% (*18.09%) + | | | | |
| potasium carbonate 5% (*2.829) SC with p.s | | | | |
| range of 0.1 to 30 microns at 12000 g/acre as | | | | |
| per an embodiment of the present invention | | | | |
| T8: Sulphur 10% + zinc carbonate 1% | 27.8 | 7.33 | 4.05 | 6.57 |
| (*0.52%) + Ferric oxide 0.4% (*0.26%) + | | | | |
| Magnesium oxide 60% (*36.18%) + | | | | |
| potasium carbonate 10% (*5.658) pellets | | | | |
| with p.s range above 75 microns at 6000 | | | | |
| g/acre | | | | |
| T9: Untreated | 25.9 | | 3.8 | |

DAA—Days After Application

It can be observed from the data provided in the table 6A above that the treatments T1, T3, T5 and T7 in the form of water dispersible granules or liquid suspension or water disintegrable granules, with particle sizes as per the embodiments of the present invention, demonstrated a significantly enhanced increase in the wheat plant height at 60 DAA as well as a significant increase in the number of tillers at 40 DAA as compared to the treatments T2, T4, T6 and T8. The treatments T2, T4, T6 and T8 were carried out with the conventional pellet compositions which include swelling clay and had a particle size range above 75 microns. It can be seen that the treatments T1, T3, T5 and T7 with compositions as per the present invention show a wheat plant height increase of 23.93%, 22%, 21.62% and 20.84% respectively, over the untreated control, as compared to treatments T2, T4, T6 and T8, which showed a yield increase of only 9.26%, 10.81%, 9.26% and 7.33% respectively, over the untreated control. Further the compositions of treatments T1, T3, T5 and T7 as per the embodiment of the present invention also recorded a surprising increase in the number of tillers at 40 DAA as compared to the treatments T2, T4, T6 and T8 with the conventional pellet compositions having a higher particle size range.

### Experiment 7

To study the effect of the compositions of “Sulphur, Potassium, Magnesium, Zinc, Iron wherein the composition includes particles with an average particle size diameter distribution of less than 1 micron against comparative samples with higher average particle size diameter distribution, in commercially cultivated paddy crop:

### Field Experiment Methodology:

The field trials were carried out to evaluate the effect of embodiments of the composition of the present invention on yield of rice (paddy) at Kheda, Gujarat.

The trial was laid out during Kharif season in Randomized Block Design (RBD) with five treatments including untreated control, replicated four times. For each treatment, plot size of 40 sq.m (8 m×5 m) was maintained. The test products with prescribed dose were applied as top dressing at 15 days after transplanting of the paddy. The paddy crop in trial field was raised following good agricultural practice. The seeds of paddy variety PUSA-205 were used for raising the nursery and 25 days old nursery was used for transplanting the trial field in 30 cm row to row and 25 cm plant to plant spacing. The active dosage applied in the field experiment is of elemental Sulphur, elemental Potassium, elemental Magnesium, elemental Zinc and elemental Iron.

Details of experiment

| | |
|---|---|
| a) Trial Location | Kheda, Gujarat |
| b) Crop | Rice (var: PUSA-205) |
| c) Experiment season | Kharif 2023 |
| d) Trial Design | Randomized Block Design |
| e) Replications | Four |
| f) Treatments | 5 |
| g) Plot size | 8 m × 5 m = 40 sq. m |
| h) Date of transplanting | 25 Jun. 2023 |
| i) Date of Application | 10 Jul. 2023 |
| j) Method of application | Top dressing |
| k) Date of Harvesting | 3 Oct. 2023 |

The observations on yield were recorded at the time of harvesting and the data is presented in the table below.

TABLE 7

| | | | | | | Plant | | |
|---|---|---|---|---|---|---|---|---|
| | | | | | | height | | |
| | Nutrient g/acre - | | | | | at 60 | Grain | % |
| | (Elemental content) | | | | | DAA | Yield | increase |
| Treatment Details | S | Mg | K | Fe | Zn | (cms) | (Kg/ha) | in yield |
| T1: Sulphur 20% + | 1200 | 259.2 | 174 | 606 | 722.4 | 75.2 | 4350 | 24.64 |
| Magnesium carbonate | | | | | | | | |
| 15% (Elemental Mg: | | | | | | | | |
| 4.32%) + Potassium | | | | | | | | |
| Schoenite 15% | | | | | | | | |
| (Elemental K: 2.9%) + | | | | | | | | |
| Ferric oxide 15% | | | | | | | | |
| (Elemental Fe: 10.10%) + | | | | | | | | |
| Zinc oxide 15% | | | | | | | | |
| (Elemental Zn: 12.04%) | | | | | | | | |
| WG with avg. p.s | | | | | | | | |
| distribution <1 micron @ | | | | | | | | |
| 6000 g/acre as per the | | | | | | | | |
| embodiment of the | | | | | | | | |
| present invention | | | | | | | | |
| T2: Sulphur 20% + | 1200 | 259.2 | 174 | 606 | 722.4 | 56.8 | 3845 | 10.17 |
| Magnesium carbonate | | | | | | | | |
| 15% (Elemental Mg: | | | | | | | | |
| 4.32%) + Potassium | | | | | | | | |
| Schoenite 15% | | | | | | | | |
| (Elemental K: 2.9%) + | | | | | | | | |
| Ferric oxide 15% | | | | | | | | |
| (Elemental Fe: 10.10%) + | | | | | | | | |
| Zinc oxide 15% | | | | | | | | |
| (Elemental Zn: 12.04%) | | | | | | | | |
| WG with p.s range of 0.1 | | | | | | | | |
| micron to 100 microns | | | | | | | | |
| with average p.s | | | | | | | | |
| distribution <30 microns @ | | | | | | | | |
| 6000 g/acre | | | | | | | | |
| T3: Sulphur 20% + | 1500 | 216 | 72.82 | 403 | 903 | 73.8 | 4465 | 27.94 |
| Magnesium carbonate | | | | | | | | |
| 10% (Elemental Mg: | | | | | | | | |
| 2.88%) + Potassium | | | | | | | | |
| schoenite 5% (Elemental | | | | | | | | |
| K: 0.971%) + Ferroso | | | | | | | | |
| ferric oxide 7.5% | | | | | | | | |
| (Elemental Fe: 5.377%) + | | | | | | | | |
| Zinc oxide 15% | | | | | | | | |
| (Elemental Zn: 12.04%) | | | | | | | | |
| SC with avg. p.s | | | | | | | | |
| distribution <1 micron @ | | | | | | | | |
| 7500 g/acre as per the | | | | | | | | |
| embodiment of the | | | | | | | | |
| present invention | | | | | | | | |
| T4: Sulphur 1% + Zinc | 1500 | 216 | 72.82 | 403 | 903 | 55.3 | 3912 | 12.09 |
| oxide 0.1% (*0.08%) + | | | | | | | | |
| Ferric oxide 40% | | | | | | | | |
| (*26.95%) + Cuprous | | | | | | | | |
| oxide 0.1% (*0.088%) + | | | | | | | | |
| Magnesium hydroxide | | | | | | | | |
| 11% (*4.58) + Boric acid | | | | | | | | |
| 0.1% (0.017%) + | | | | | | | | |
| Manganese oxide 0.1% | | | | | | | | |
| (*0.063%) SC with p.s | | | | | | | | |
| range of 0.1 micron to | | | | | | | | |
| 100 microns and with | | | | | | | | |
| average p.s distribution <30 | | | | | | | | |
| micons @ 7500 g/acre | | | | | | | | |
| T5: Untreated | — | — | — | — | — | 59.5 | 3490 | 0 |

It is evident from the table 7 above that the treatments T1 and T3 with water dispersible granular composition and liquid suspension compositions with particle size range as per the embodiment of the present invention showed significantly enhanced yield and an increased plant height as compared to compositions having higher particle size range i.e. treatments T2 and T4.

It can be observed that treatments T1 and T3 with the compositions having average particle size diameter distribution of less than 1 micron as per the embodiment of the present invention showed an yield increase of 24.64% and 27.94% respectively over untreated control. Whereas, treatments T2 and T4 with compositions having particles in the size range of 0.1 100 microns and average particle size diameter distribution of less than 30 microns showed yield increase of only 10.17% and 12.09% respectively, over untreated control.

### Experiment 8

To study the effect of compositions of “Sulphur, Potassium, Magnesium, Zinc and Iron along with a biostimulant” in commercially cultivated paddy, where the compositions is in the form of water disintegrable granules, with particle size range as per the embodiment of the present invention in combination with varying dosage of RDF (120-60-60 N-P2O5-K2O/ha):

### Field Experiment Methodology:

The trial was laid out during Kharif season in Randomized Block Design (RBD) with three treatments, replicated four times. The paddy crop in the trial field was raised following good agricultural practices.

Details of experiment

| a) Trial Location | Umargaon, Gujarat |
|---|---|
| b) Crop & Variety | Paddy |
| c) Experiment season | Kharif 2023 |
| d) Trial Design | Randomized Block Design |
| e) Replications | 4 |
| f) Treatment | 3 |
| g) Plot size | 6 m × 5 m = 30 sq. m |
| h) Date of sowing | 20 Jun. 2023 |
| i) Date of Application | 5 Jul. 2023 |
| j) Method of application | Soil application |
| k) Date of Harvesting | 6 Oct. 2023 |
| l) Soil pH | 6.5-7 |

The observations on yield were recorded at the time of harvesting and mean data is presented in Table 8 to enumerate the efficacy of the compositions which include Sulphur, Potassium, Magnesium, Zinc and Iron, prepared as per the embodiment of the present invention.

| | Yield per | KG | KG |
|---|---|---|---|
| Treatment Details | acre (kg) | (CO₂) | (CH4) |
| T1 - Sulphur 16% + Potassium silicate 20% + | 2142 | 95 | 172 |
| Rock Phosphate 15% + Zinc Oxide 6.5% + Iron | | | |
| Oxide 8% + Magnesium Hydroxide 12% + | | | |
| Biochar 9% GR with p.s range of 0.1 to 50 | | | |
| microns @ 30 kg/acre basal, followed by a first | | | |
| and second top dressing as per an embodiment of | | | |
| the present invention with 25% RDF | | | |
| T2 - Sulphur 16% + Potassium silicate 20% + | 2024 | 130 | 190 |
| Rock Phosphate 15% + Zinc Oxide 6.5% + Iron | | | |
| Oxide 8% + Magnesium Hydroxide 12% GR with | | | |
| p.s range of 0.1 to 50 microns @ 30 kg/acre | | | |
| applied basal followed by a first top dressing and | | | |
| second top dressing as per an embodiment of the | | | |
| present invention with 25% RDF | | | |
| T3 - 100% RDF (100-60-60) NPK | 1563 | 567 | 199 |

It pertinent to note from the Table 8 above that the treatments T1 and T2 with the composition in the form of water disintegrable granules as per the embodiment of the present invention when applied with 25% RDF (conventional NPK fertilizers) resulted in a significant increase in yield as well as reduction in CO₂ and CH₄ emissions, as compared to the treatment T3 with 100% RDF alone, thereby rendering the composition of the invention environment friendly. Moreover, treatment T1 with a composition comprising biochar (biostimulant) shows relatively higher reduction in CO₂ and CH₄ emissions when compared with treatment 2 as well as treatment 3.

It can be observed that treatments T1 and T2 with 25% RDF with the compositions as per the embodiment of the present invention showed better yield as compared to treatment T3 with only RDF (100%), and at the same time exhibited a significant reduction in the green house gas emissions. For instance, treatment T1 with the compositions as per the embodiment of the present invention showed a yield increase of 37.04% and surprising reduction of 83.25% in CO₂ emission and 13.57% reduction in CH₄ emission as compared to treatment T3 which included only RDF.

The inventors of the present invention have further observed that apart from the Magnesium, Potassium, Zinc and iron salts listed in the Tables 1 to 8 above, other Magnesium, Potassium, Zinc and Iron salts, as per the present application also exhibited a similar effect in terms of effect, when applied as per the embodiment of the present invention.

It has been observed that the composition of the present invention, demonstrates enhanced, efficacious and superior behaviour in the fields. It was noted by the present inventors that the application of the composition of the present invention renders a greater and balanced uptake of not only magnesium, even in the presence of potassium, or the uptake of iron in the presence of zinc, but also facilitates the uptake of all the macronutrients or micronutrients contained in the composition. Further, it was also observed that the application of the present composition, particularly in acidic soils, allows for greater assimilation of all nutrients. This results in a more balanced uptake of all nutrients, leading to a healthier plant, and higher nutrient harvest. Through the composition of the present invention, the number of applications or the amount of nutrients, fertilizers or pesticides are minimized. The composition is highly safe to the user and to the environment. It was observed that the composition of the present invention is not only synergistic but also improves the crop yield as well as enhances the crop physiological characteristics etc. such as increased greenness and improved foliage. Thus, it has been observed that the compositions of the present invention, demonstrates enhanced, efficacious and superior behavior in the fields at reduced dosage of application. The composition of the invention also promotes soil health.

It was also observed that the present composition provided better uptake of magnesium, zinc, iron and other micronutrients trapped into the soil, along with the macronutrients, when the composition is in the form of water dispersible granules or liquid suspension or water disintegrable granules and comprises particles in the size range of 0.1 to 50 microns.

Further, the various advantageous properties associated with the compositions according to the invention, include but are not limited to improved stability, improved toxicological and/or ecotoxicological behaviour, improved crop characteristics including crop yields, crop qualities, improved rooting, dense foliage and characteristics and other advantages familiar to a person skilled in the art.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred

1. A crop nutrition and fortification composition comprising:
i. elemental sulphur; wherein the elemental sulphur content is in the range of 5% to 90% by the weight of the total composition;
ii. one or more of water insoluble or water soluble magnesium salts or derivatives or mixtures thereof; wherein the elemental magnesium content is in the range of 0.1% to 40% by the weight of the total composition;
iii. one or more of water insoluble or water soluble potassium fertilizers or salts or derivatives or mixtures thereof; wherein the elemental potassium content is in the range 0.1% to 40% by the weight of the total composition;
iv. one or more of water insoluble or water soluble iron salts or derivatives or mixtures thereof;
wherein the elemental iron content is in the range of 0.1% to 45% by the weight of the total composition;
v. one or more of water insoluble or water soluble zinc salts or derivatives or mixtures thereof; wherein the elemental zinc content is in the range of 0.1% to 45% by the weight of the total composition; and,
vi. one or more excipients in the range of 0.1% to 60% by the weight of the total composition, wherein the composition comprises of particles in the size range of 0.1-50 microns and wherein the total content of the water soluble salts or derivatives or mixtures in the composition does not exceed 80% by the weight of the total composition.

2. The composition as claimed in claim 1, comprising the magnesium fertilizers or salts or derivatives or mixtures thereof in the range of 1% to 75% w/w of the total composition; the potassium salts or derivatives or mixtures thereof present in the range of 1% to 55% w/w of the total composition; the iron salts or derivatives or mixtures thereof in a range of 0.1% to 60% w/w of the total composition; and the zinc salts or derivatives or mixtures thereof, present in the range of 0.1% to 55% w/w of the total composition.

3. The composition as claimed in claim 1, wherein the composition is in the form of a solid or a liquid or a gel.

4. The composition as claimed in claim 3, wherein the solid composition is in the form of water dispersible granules, wettable powders, broadcast granules, extruded granules, water disintegrable granules or spheronized granules.

5. The composition as claimed in claim 4, wherein the solid composition is in the form of water dispersible granules or water disintegrable granules, wherein the water dispersible granules are in a size range of from 0.05 mm to 4 mm and comprise particles in a size range of 0.1 micron to 30 microns and the water disintegrable granules or spheronized granules are in a size range of from 0.05 mm to 6 mm and comprise particles in a size range of 0.1 micron to 50 microns.

6. (canceled)

7. The composition as claimed in claim 6 5 wherein the water dispersible granules comprise of particles having an average diameter distribution (D50) of less than 10 microns.

8. The composition as claimed in claim 6 5, wherein the composition in the form of water dispersible granules comprises of particles having an average diameter distribution (D50) of less than 1 micron.

9. (canceled)

10. The composition as claimed in claim 3, wherein the liquid composition is in the form of a liquid suspension, wherein the liquid suspension composition comprises:
i. elemental sulphur; wherein the elemental sulphur content is in the range of 5% to 60% by the weight of the total composition;
ii. one or more of water insoluble or water soluble magnesium salts or derivatives or mixtures thereof; wherein the elemental magnesium content is in the range of 0.1% to 30% by the weight of the total composition;
iii. one or more of water insoluble or water soluble potassium fertilizers or salts or derivatives or mixtures thereof; wherein the elemental potassium content is in the range 0.1% to 30% by the weight of the total composition;
iv. one or more of water insoluble or water soluble iron salts or derivatives or mixtures thereof;
wherein the elemental iron content in the range of 0.1% to 30% by the weight of the total composition;
V. one or more of water insoluble or water soluble zinc salts or derivatives or mixtures thereof;
wherein the elemental zinc content in the range of 0.1% to 40% by the weight of the total composition;
vi. one or more excipients in the range of 0.1% to 60% by the weight of the total composition; and,
wherein the composition comprises of particles in the size range of 0.1-30 microns and wherein the total content of the water soluble salts or derivatives or mixtures in the composition does not exceed 50% by the weight of the total composition.

11. (canceled)

12. The composition as claimed in claim 10, wherein the composition comprises of particles having an average diameter distribution (D50) of less than 10 microns.

13. The composition as claimed in claim 10, wherein the composition comprises of particles having an average diameter distribution of less than 1 micron.

14. The composition as claimed in claim 1, wherein the water insoluble magnesium salts or derivatives comprise one or more of Magnesium oxide, Magnesium hydroxide (milk of magnesia), Magnesium molybdate, Magnesium phosphate, Calcium magnesium phosphate, Magnesium phosphate tribasic, Magnesium carbonate, Magnesium silicate, Magnesium trisilicate, Magnesium Aluminium Silicate, Calcium Magnesium Silicate, Magnesium ammonium phosphate, Magnesium humate, Magnesium fulvate; Magnesium oxalate, Magnesium tartrate, Magnesium sulphide or Periclase, Brucite; Sellaite; Kotoite; Pertsevite; Suanite; Magnesite; Szaibelyite; Kieserite; Dolomite; hydrated dolomite and Struvite.

15. The composition as claimed in claim 1, wherein the water soluble magnesium salts comprise one or more of magnesium sulphate, magnesium nitrate, magnesium lignosulphonate, magnesium gluconate, magnesium glycinate, magnesium lactate, magnesium aspartate, magnesium ascorbate, magnesium acetate and magnesium citrate.

16. The composition as claimed in claim 1 wherein the composition comprises water insoluble magnesium salts.

17. The composition as claimed in claim 1, wherein the potassium fertilizers include muriate of potash; potassium magnesium sulphate; potassium nitrate; potassium sodium nitrate; potassium hydroxide; potassium carbonate; potassium orthophosphate; potassium polyphosphate; potassium phosphate; potassium metaphosphate; potassium sulphate; sulphate potash magnesia; potassium chloride; rock potash; bittern potassium salt (KCl(+NaCl+MgSO4)); plant and wood ashes (K2CO3+KHCO3) and kelp ashes (KCl+K2SO4); potassium fulvate; potassium humate; potassium rock powder; Schoenite or Picromerite; Feldspar; Orthoclase; Slyvite; Carnallite; Kainite; Polyhalite or Ischelite or Polygalite; Leucite; Arrojadite; Gengenbachite; Haigerachite; Lepidolite Hazenite, Kosnarite, Langbeinite Leucophosphite, Lipuite, Manganoarrojadite, Mantienneite, Minyulite, Parwanite, Phosphofibrite, Sylvinite, Taranakite and Tinsleyite.

18. The composition as claimed in claim 1, wherein the water insoluble iron salts or derivatives comprise one or more of iron oxide, iron hydroxide, iron phosphate, iron fumarate, iron succinate, iron sulphide, iron sucrate, iron tartarate, carbonyl iron, iron silicate, iron carbonate; Iron(II) oxalate (anhydrous), Iron(II) oxalate (dihydrate), Roaldite, Wusite, Magnetite, Hematite, Goethite, Limonite, Siderite, Pyrite or Marcasite, Bernalite, Greenalite and mixtures thereof.

19. The composition as claimed in claim 1, wherein the water soluble iron salts comprise one or more of iron sulphate, iron citrate, iron silicate, iron ascorbate, iron sucrose, iron gluconate, iron dextran, iron lignosulphonate and iron chelates.

20. The composition as claimed in claim 1, wherein the water insoluble zinc salts or derivatives comprise one or more of zinc oxide, Zinc sulphide, zinc hydroxide, zinc carbonate, zinc molybdate, zinc phosphate, zinc borate, zinc silicate, zinc pyrophosphate, zinc humate, zinc fulvate, zinc citrate, zinc oxalate, zinc monomethionine, zinc carnosine, zinc chromate, zinc nitride, zinc nitrilotriacetic acid (NTA), zinc phosphide, zinc selenide, zinc telluride, zinc aspartate, Danbaite, Ashoverite, Periclase, Sphalerite, Wurtzite, Hydrozincite, Brianyoungite, Hemimorphite, Smithsonite, Bechererite, Aurichalcite, Hopeite, Hodgkinsonite, Fraipontite, Junitoite, Clinohedrite, Christelite, Gunningite, Cianciulliite, Ecandrewsite, Baileychlore, Boyleite and Bianchite.

21. The composition as claimed in claim 1, wherein the composition comprises water soluble zinc salts selected from one or more of zinc sulphate, zinc sulphate monohydrate, zinc sulphate heptahydrate, zinc chelate, zinc oxysulfate, zinc chloride, eugenol chelated zinc, zinc lignosulphonate, zinc glycine, zinc carbohydrate, zinc sucrate, zinc acetate, zinc gluconate, zinc polyflavonoid, zinc glucoheptonate and zinc phenolate.

22. The composition as claimed in claim 1, wherein the composition comprises water insoluble iron salts and water insoluble zinc salts.

23. The composition as claimed in claim 1; wherein the excipients comprises one or more of anionic, and non-ionic surfactants.

24. The composition as claimed in claim 1; wherein the excipients are selected from one or more of emulsifiers, wetting agents and dispersing agents.

25.-26. (canceled)

27. The composition as claimed in claim 1, wherein the composition further comprises one or more of fillers or carriers or diluents, spreading agents, colorants, anticaking agents, disintegrating agents, binders, buffers or pH adjusters or neutralizing agents, pigments, stabilizers, antifoaming agents or defoamers, penetrants, ultraviolet absorbents, structuring agents, humectants, sticking agents, anti-freezing agent or freeze point depressants, chelating or complexing or sequestering agents preservatives or bactericides or anti-fungal agents or biocides or anti-microbial agents and antioxidants.

28. The composition as claimed in claim 10, wherein the liquid suspension composition further comprises structuring agents selected from one or more of thickeners, suspending agents, suspension aid agents, viscosity modifiers or rheology modifiers, tackifiers and anti-settling agents.

29.-33. (canceled)

34. The composition as claimed in claim 1, wherein the composition optionally further comprises one or more of phosphorous fertilizers or salts or derivatives or mixtures thereof; wherein the elemental phosphorous content is in the range of 0.1% to 30% by the weight of the total composition.

35. (canceled)

36. The composition as claimed in claim 1, wherein the composition optionally further comprises active ingredients selected from one or more of micronutrients; biostimulants and pesticidal active ingredients or mixtures thereof, wherein the further active ingredient is present in a concentration range of 0.001% w/w to 30% w/w of the total composition.

37. The composition of claim 36, wherein the biostimulant comprises organic carbon.

38.-40. (canceled)

41. A crop nutrition composition and fortification composition as claimed in any of the preceding claims, wherein the composition is at least one of a fertilizer composition, a nutrient composition, a crop strengthener composition, a soil conditioner composition or a yield enhancer composition.

42. A method for improving plant health or yield; wherein the method comprises treating at least one of a plant, a plant propagation material, locus or plant parts thereof, a seed, seedling or surrounding soil with the crop nutrition and fortification composition as claimed in any of the preceding claims.
